(19) United States
(12) Patent Application Publication
(10) Pub. No.: US 2026/0359357 A1
(43) Pub. Date: Nov. 12, 2026

(54) SYSTEMS AND METHODS FOR REAL-TIME CONVERSION OF UNSTRUCTURED DATA WITH LEXICAL COMPLEXITY CONTROL

(71) Applicant: iSimcha, LLC, Durham, NC (US)

(72) Inventors: Brenda Jamerson, Durham, NC (US); David James Randall, Durham, NC (US); William Jacob DeCicco, Durham, NC (US); Barry Kurt Schuster, Durham, NC (US)

(73) Assignee: iSimcha, LLC, Durham, NC (US)

(21) Appl. No.: 19/671,768

(22) Filed: May 8, 2026

Related U.S. Application Data
(60) Provisional application No. 63/802,996, filed on May 9, 2025.

(51) Int. Cl. G06F 16/901; G06F 16/61; G06N 5/022

(52) U.S. Cl. CPC G06F 16/901; G06F 16/61; G06N 5/022

(57) ABSTRACT

A computer-implemented method for real-time conversion of unstructured data includes obtaining, at a graphical user interface, an unstructured digital artifact having a lexical complexity exceeding a maximum complexity threshold, automatically extracting, in real-time, a corpus of unstructured data fragments from the unstructured digital artifact causing the lexical complexity of the unstructured digital artifact to exceed the maximum complexity threshold, generating, in real-time, an interactive video object based on the plurality of lexical complexity mitigation prompts, wherein generating the interactive video object includes, and inserting, into the graphical user interface, an interactive explainability artifact that mitigates the lexical complexity of the unstructured digital artifact.

### CROSS-REFERENCE TO RELATED APPLICATIONS

This application claims the benefit of U.S. Provisional Application No. 63/802,996, filed May 9, 2025, which is incorporated herein in its entirety by this reference.

### TECHNICAL FIELD

This invention relates generally to the machine learning field, and more specifically, to new and useful systems and methods for real-time conversion of unstructured data with lexical complexity control.

### BACKGROUND

Artificial intelligence (AI) and machine learning (ML) technologies are increasingly receiving unstructured data as input. For artificial intelligence and machine learning technologies to function as intended, these technologies must be able to correctly extract the semantic meaning or intent of the unstructured data. For example, a machine learning model configured to perform document classification must be able to analyze unstructured data and determine, based on the extracted semantic meaning, an appropriate classification label for the unstructured data.

Artificial intelligence and machine learning technologies often struggle with extracting the semantic meaning or intent of unstructured data due to a lexical complexity of the unstructured data. Specifically, artificial intelligence and machine learning technologies struggle to extract the semantic meaning or intent of the unstructured data because such unstructured data often includes dense domain-specific terminology, long or nested sentence structures, and ambiguous contextual.

When artificial intelligence and machine learning technologies are unable to extract the semantic meaning or intent of the unstructured data, such technologies may undesirably generate incorrect predictions, inaccurate classifications, hallucinated outputs that are not supported by the unstructured data, and/or the like. Thus, there is a need for computer-implemented systems and methods that can dynamically control a lexical complexity of unstructured data in real-time to ensure accurate semantic interpretation by artificial intelligence and machine learning technologies.

The embodiments of the present application provide technical solutions that address, at least, the needs described above, as well as the deficiencies of the state of the art.

In some embodiments, a computer-implemented method for real-time conversion of unstructured data comprises: at an unstructured data conversion service implemented by a network of distributed computers: obtaining, at a graphical user interface, an unstructured digital artifact having a lexical complexity exceeding a maximum complexity threshold; automatically extracting, in real-time, a corpus of unstructured data fragments from the unstructured digital artifact causing the lexical complexity of the unstructured digital artifact to exceed the maximum complexity threshold; generating, in real-time, a plurality of lexical complexity mitigation prompts in response to extracting the corpus of unstructured data fragments, wherein the plurality of lexical complexity mitigation prompts include: a plurality of interrogative prompts, wherein each respective interrogative prompt of the plurality of interrogative prompts comprises a distinct interrogative and a distinct subset of unstructured data fragments from the corpus of unstructured data fragments that correspond to the distinct interrogative, and a plurality of lexical complexity control prompts, wherein each respective lexical complexity control prompt of the plurality of lexical complexity control prompts comprises a plurality of lexical transformation control instructions and a distinct unstructured data fragment from the corpus of unstructured data fragments; generating, in real-time, an interactive video object based on the plurality of lexical complexity mitigation prompts, wherein generating the interactive video object includes: generating, by a large language model executing the plurality of interrogative prompts, a respective structured interrogative finding for each distinct interrogative included in the plurality of interrogative prompts, generating, by the large language model executing the plurality of lexical complexity control prompts, a respective lexical complexity-controlled structured data fragment for each distinct unstructured data fragment included in the plurality of lexical complexity control prompts, dynamically creating, in real-time, an interactive video composition prompt comprising a plurality of video synthesis instructions and a plurality of video-integrated user interface element creation instructions based on (i) the respective structured interrogative finding generated for each distinct interrogative included in the plurality of interrogative prompts and (ii) the respective lexical complexity-controlled structured data fragment generated for each distinct unstructured data fragment included in the plurality of lexical complexity control prompts, generating, via the large language model executing the interactive video composition prompt, the interactive video object comprising a plurality of video segments and a plurality of interactive user interface control objects interleaved with the plurality of video segments; and inserting, into the graphical user interface, an interactive explainability artifact that mitigates the lexical complexity of the unstructured digital artifact and: (1) executes the interactive video object in response to user input, (2) displays the corpus of unstructured data fragments extracted from the unstructured digital artifact in association with the respective lexical complexity-controlled structured data fragment generated for each distinct unstructured data fragment included in the corpus of unstructured data fragments, and (3) displays the respective structured interrogative finding generated for each distinct interrogative included in the plurality of interrogative prompts.

In some embodiments, dynamically creating the interactive video composition prompt includes: prompting the large language model to generate a video scene specification using the respective structured interrogative finding generated for each distinct interrogative included in the plurality of interrogative prompts, wherein the video scene specification defines: a sequence for presenting each distinct interrogative included in the plurality of interrogative prompts, a starting scene description that defines one or more starting visual animation descriptions for introducing a starting interrogative in the sequence and transitioning to the respective structured interrogative finding generated for the starting interrogative; an intermediate scene description for each additional interrogative in the sequence that defines one or more intermediate visual animation descriptions for introducing a distinct additional interrogative and transitioning to the respective structured interrogative finding generated for the distinct additional interrogative, and a final scene description that defines one or more final visual animation descriptions for presenting a last interrogative in the sequence and transitioning to the respective structured interrogative finding generated for the last interrogative, and generating, via the large language model, the plurality of video synthesis instructions that request the large language model to generate the plurality of video segments of the interactive video object based on the video scene specification generated by the large language model.

In some embodiments, dynamically creating the interactive video composition prompt further includes: prompting the large language model to generate a plurality of post-scene interactive assessment descriptions using the respective lexical complexity-controlled structured data fragment generated for each distinct unstructured data fragment included in the plurality of lexical complexity control prompts, wherein the plurality of post-scene interactive assessment descriptions include: a first post-scene interactive assessment description that defines a first configuration of user interface elements for presenting the starting interrogative and receiving the user input for answering the starting interrogative, a distinct intermediate post-scene interactive assessment description for each additional interrogative in the sequence that defines a second configuration of user interface elements for presenting the distinct additional interrogative and receiving the user input for answering the distinct additional interrogative, and a final post-scene interactive assessment description that defines a third configuration of user interface elements for presenting the last interrogative in the sequence and receiving the user input for answering the last interrogative, and generating, via the large language model, the plurality of video-integrated user interface element creation instructions that request the large language model to generate the plurality of interactive user interface control objects based on the plurality of post-scene interactive assessment descriptions.

In some embodiments, generating the interactive video object includes: generating, via the large language model, a starting video segment based on the starting scene description, generating, via the large language model, a plurality of intermediate video segments based on the intermediate scene description generated for each additional interrogative in the sequence, generating, via the large language model, a final video segment based on the final scene description, and inserting the starting video segment at a start of the interactive video object, the final video segment at an end of the interactive video object and the plurality of intermediate video segments at a plurality of corresponding playback positions between the start of the interactive video object and the end of the interactive video object.

In some embodiments, generating the interactive video object further includes: generating, by the large language model, a first subset of the plurality of interactive user interface control objects based on the first post-scene interactive assessment description, inserting, by the large language mode, the first subset of the plurality of interactive user interface control objects at a playback position immediately following completion of the starting video segment, generating, by the large language model, a plurality of second subsets of the plurality of interactive user interface objects based on the distinct intermediate post-scene interactive assessment description generated for each additional interrogative in the sequence, inserting, by the large language model, each respective subset of the plurality of second subsets of the plurality of interactive user interface objects at a corresponding playback position following one of the plurality of intermediate video segments, generating, by the large language model, a third subset of the plurality of interactive user interface control objects based on the final post-scene interactive assessment description, and inserting, by the large language mode, the third subset of the plurality of interactive user interface control objects at a playback position immediately following completion of the final video segment.

In some embodiments, a first unstructured data fragment included in the corpus of unstructured data fragments corresponds to a first original section extracted from the unstructured digital artifact, and displaying the corpus of unstructured data fragments includes: displaying, in the graphical user interface, a first row comprising a first cell that includes the first original section extracted from the unstructured digital artifact and the respective lexical complexity-controlled structured data fragment generated for the first original section in a second cell of the first row, wherein the first original section in the first cell of the first row is not editable by the user input, and the respective lexical complexity-controlled structured data fragment generated for the first original section in the second cell of the first row is editable by the user input.

In some embodiments, a second unstructured data fragment included in the corpus of unstructured data fragments corresponds to a first original paragraph extracted from the unstructured digital artifact, and displaying the corpus of unstructured data fragments includes: displaying, in the graphical user interface, a second row comprising a first cell that includes the first original paragraph extracted from the unstructured digital artifact and the respective lexical complexity-controlled structured data fragment generated for the first original paragraph in a second cell of the second row, wherein the first original section in the first cell of the second row is not editable by the user input, and the respective lexical complexity-controlled structured data fragment generated for the first original paragraph in the second cell of the second row is editable by the user input.

In some embodiments, the first original paragraph extracted from the unstructured digital artifact includes a plurality of tokens and a plurality of non-interactive symbols, displaying the first original paragraph in the first cell of the second row includes displaying the plurality of tokens and the plurality of non-interactive symbols in the first cell of the second row, and displaying the respective lexical complexity-controlled structured data fragment generated for the first original paragraph in the second cell of the second row includes: displaying a second plurality of tokens that the large language model generated by applying the plurality of lexical transformation control instructions to the plurality of tokens, and displaying a plurality of interactive user interface objects, generated by the large language model, that replaces the plurality of non-interactive symbols and that are responsive to the user input.

In some embodiments, the computer-implemented method further comprises: receiving a second user input selecting the first cell of the second row, in response to receiving the second user input selecting the first cell of the second row: ceasing displaying the first original paragraph in a non-editable state while maintaining the first original section in the non-editable state, inserting, into the first cell of the second row, a first text input field comprising the first original paragraph in an editable state, inserting, into the first cell of the second row, a selectable button configured to convert the first original paragraph into a new respective lexical complexity-controlled structured data fragment for the first original paragraph, receiving, at the first text input field, a third user input adding one or more new tokens to the first original paragraph, after receiving the third user input, receiving a fourth user input selecting the selectable button inserted into the first cell of the second row, and in response to receiving the fourth user input: constructing a new lexical complexity control prompt comprising the plurality of lexical complexity transformation control instructions and the first original paragraph modified with the one or more new tokens; generating, by the large language model executing the new lexical complexity control prompt, the new respective lexical complexity-controlled structured data fragment for the first original paragraph; while generating the new respective lexical complexity-controlled structured data fragment, displaying, in the second cell of the second row, an animated visual indicator indicating that the large language model is currently generating the new respective lexical complexity-controlled structured data fragment for the first original paragraph; and after the large language model generates the new respective lexical complexity-controlled structured data fragment: ceasing displaying the animated visual indicator in the second cell of the second row, and replacing, at the second cell of the second row, the respective lexical complexity-controlled structured data fragment previously generated for the first original paragraph with the new respective lexical complexity-controlled structured data fragment derived for the first original paragraph.

In some embodiments, the respective lexical complexity-controlled structured data fragment generated for a first unstructured data fragment in the corpus of unstructured data fragments includes a plurality of attribute fields comprising: a first attribute field comprising tokens underlying the respective lexical complexity-controlled structured data fragment generated for the first unstructured data fragment, a first nested attribute field nested under the first attribute field indicating that a subset of the tokens corresponds to a first plurality of original tokens in the unstructured digital artifact, and a second nested attribute field nested under the first nested attribute field indicating that the first plurality of original tokens have a first type of textual formatting in the unstructured digital artifact, the interactive explainability artifact includes a selectable button that, when selected by the user input, generates a digital file comprising the respective lexical complexity-controlled structured data fragment generated for each distinct unstructured data fragment in the corpus of unstructured data fragments, and exporting the digital file includes: initializing the digital file in accordance with a target file format, detecting that a next lexical complexity-controlled structured data fragment to insert into the digital file corresponds to the respective lexical complexity-controlled structured data fragment generated for the first unstructured data fragment, and in response to detecting that the next lexical complexity-controlled structured data fragment to insert into the digital file corresponds to the respective lexical complexity-controlled structured data fragment generated for the first unstructured data fragment: adding the tokens underlying the respective lexical complexity-controlled structured data fragment to the digital file in accordance with a position of the respective lexical complexity-controlled structured data fragment in the graphical user interface, and applying the first type of textual formatting to the subset of tokens in the respective lexical complexity-controlled structured data fragment in response to (A) the first nested attribute field indicating that the subset of the tokens correspond to the first plurality of original tokens in the unstructured digital artifact and (B) the second nested attribute field indicating that the first plurality of original tokens have the first type of textual formatting in the unstructured digital artifact, applying a default textual formatting to a remainder of the tokens underlying the respective lexical complexity-controlled structured data fragment generated for the first unstructured data fragment based on detecting an absence of additional nested attributed fields indicating a textual formatting type for the remainder of the tokens, and after adding the tokens underlying the respective lexical complexity-controlled structured data fragment generated for the first unstructured data fragment, adding a plurality additional lexical complexity-controlled structured data fragments to the target digital file in accordance with respective positions of the plurality additional lexical complexity-controlled structured data fragments in the graphical user interface.

In some embodiments, generating the respective structured interrogative finding for a first distinct interrogative included in a first respective interrogative prompt of the plurality of interrogative prompts includes: generating, by the large language model, a first respective structured interrogative finding for the first distinct interrogative using the distinct subset of unstructured data fragments included in the first respective interrogative prompt, detecting a total number of words, a total number of sentences, and a total number of syllables included in the first respective structured interrogative finding generated for the first distinct interrogative, computing a text readability score of the first respective structured interrogative finding based on the total number of words, the total number of sentences, and the total number of syllables included in the first respective structured interrogative finding, detecting that the text readability score of the first respective structured interrogative finding does not satisfy a target readability threshold, and in response to detecting that the text readability score for the first respective structured interrogative finding does not satisfy the target readability threshold, iteratively generating, by the large language model: a plurality of first additional structured interrogative findings that have text readability scores that do not satisfy the target readability threshold, and a second additional structured interrogative finding that has a text readability score that satisfies the target readability threshold.

In some embodiments, the plurality of first additional structured interrogative findings and the second additional structured interrogative finding are generated using a plurality of distinct candidate interrogative prompts, each respective distinct candidate interrogative prompt of the plurality of distinct candidate interrogative prompts: is a copy of the first respective interrogative prompt, and is generated based on a total number of words, a total number of sentences, a total number of syllables included in a previous structured interrogative finding generated for the first distinct interrogative, and requests that the large language model generate a subsequent structured interrogative finding using fewer words, sentences, and syllables than the total number of words, sentences, and syllables included in the previous structured interrogative finding.

In some embodiments, requesting that the large language generate the subsequent structured interrogative finding using the fewer words, sentences, and the syllables than the total number of words, sentences, and syllables in the previous structured interrogative finding includes: detecting a current number of additional structured interrogative findings that have been generated by the large language model, responsive to detecting that the current number of additional structured interrogative findings previously generated by the large language model exceeds a first number, requesting that that the large language model generate the subsequent structured interrogative finding using a first amount of fewer words, sentences, and syllables than the total number of words, sentences, and syllables included in the previous structured interrogative finding, and responsive to detecting that the current number of additional structured interrogative findings previously generated by the large language model exceeds a second number, greater than the first number, requesting that that the large language model generate the subsequent structured interrogative finding using a second amount, lower than the first amount, of fewer words, sentences, and syllables than the total number of words, sentences, and syllables included in the previous structured interrogative finding.

In some embodiments, after detecting that the text readability score of the second additional structured interrogative finding satisfies the target readability threshold: constructing a plurality of content hallucination mitigation prompts that assess the second additional structured interrogative finding against the unstructured digital artifact, executing the plurality of content hallucination mitigation prompts by a second large language model, different from the large language model, in response to executing the plurality of content hallucination mitigation prompts, detecting, by the plurality of content hallucination mitigation prompts, a plurality of tokens in the second additional structured interrogative finding that are not supported by the unstructured digital artifact, removing the plurality of tokens from the second additional structured interrogative finding that are not supported by the unstructured digital artifact, generating, by the second language model, a third additional structured interrogative finding that restores grammatical correctness after removing the plurality of tokens that are not supported by the unstructured digital artifact, and setting the third additional structured interrogative finding as the respective structured interrogative finding for the first distinct interrogative included in the first respective interrogative prompt.

In some embodiments, generating the respective lexical complexity-controlled structured data fragment for a first unstructured data fragment included in a first lexical complexity control prompt of the plurality of lexical complexity control prompts includes: generating, by the large language model, the respective lexical complexity-controlled structured data fragment for the first unstructured data fragment in accordance with the plurality of lexical transformation control instructions included in the first lexical complexity control prompt, computing one or more token overlap metrics between the first unstructured data fragment and the respective lexical complexity-controlled structured data fragment generated for the first unstructured data fragment, detecting, based on the one or more token overlap metrics, that tokens underlying the respective lexical complexity-controlled structured data fragment generated for the first unstructured data fragment and tokens underlying the first unstructured data fragment do not overlap by a threshold amount, and in response to detecting that the tokens of the respective lexical complexity-controlled structured data fragment and the tokens of the first unstructured data fragment do not overlap by the threshold amount, iteratively regenerating, by the large language model, the respective lexical complexity-controlled structured data fragment using adjusted lexical transformation control instructions that iteratively increase token overlap until the tokens of the respective lexical complexity-controlled structured data fragment and the tokens of the first unstructured data fragment overlap by the threshold amount.

In some embodiments, the respective lexical complexity-controlled structured data fragment generated for a first distinct unstructured data fragment fails to satisfy pre-defined hallucination criteria and pre-defined readability criteria. In some embodiments, the computer-implemented method further comprises: based on the large language model generating the respective lexical complexity-controlled structured data fragment that does not satisfy the pre-defined hallucination criteria and the pre-defined readability criteria, routing the respective lexical complexity-controlled structured data fragment generated for the first distinct unstructured data fragment to a review queue, and displaying the corpus of unstructured data fragments in the interactive explainability artifact includes: displaying the first distinct unstructured data fragment in a first cell of a respective row and the respective lexical complexity-controlled structured data fragment generated for the first distinct unstructured data fragment in a second cell of the respective row, while the review queue includes the respective lexical complexity-controlled structured data fragment generated for the first distinct unstructured data fragment, displaying an hallucination and readability alert badge in the second cell of the respective row to indicate that the respective lexical complexity-controlled structured data fragment generated for the first distinct unstructured data fragment does not satisfy the pre-defined hallucination criteria and the pre-defined readability criteria, while displaying the hallucination and readability alert badge, receiving, at the review queue, a second user input accepting the respective lexical complexity-controlled structured data fragment generated for the first distinct unstructured data fragment, and in response to receiving the second user input, removing the hallucination and readability alert badge from the second cell of the respective row.

In some embodiments, the interactive explainability artifact includes a selectable button that, when selected by the user input, generates a digital file comprising at least the respective lexical complexity-controlled structured data fragment generated for each distinct unstructured data fragment in the corpus of unstructured data fragments, while the hallucination and readability alert badge is displayed in the second cell of the respective row, the selectable button is in a deactivated state to prevent the digital file from being generated, and after removing the hallucination and readability alert badge from the second cell of the respective row, the selectable button transitions from the deactivated state to an activated state that allows the user input to generate the digital file.

In some embodiments, displaying the respective structured interrogative finding generated for each distinct interrogative included in the plurality of interrogative prompts includes: displaying a first editable text container comprising: a header area that displays a first distinct interrogative with a first amount of visual prominence, and a content area that displays a first respective structured interrogative finding generated for the first distinct interrogative with a second amount of visual prominence, less than the first amount of visual prominence, displaying one or more additional editable text containers comprising one or more additional respective structured interrogative findings for one or more additional distinct interrogatives, the first editable text container and the one or more additional editable text containers are positioned above the corpus of unstructured data fragments displayed in association with the respective lexical complexity-controlled structured data fragment generated for each distinct unstructured data fragment of the corpus of unstructured data fragments, and the interactive explainability artifact further includes a selectable button that, when selected by the user input, exports a digital file comprising textual representations of the first editable text container and the one or more additional editable text containers, wherein the textual representations of the first editable text container and the one or more additional editable text containers are ordered according to a presentation order of the first editable text container and the one or more additional editable text containers in the graphical user interface.

In some embodiments, the computer-implemented method comprises after exporting the digital file: receiving, via the graphical user interface, a second user input adding one or more new tokens to the first respective structured interrogative finding displayed in the content area of the first editable text container, after receiving the second user input, receiving, via the graphical user interface, a third user input selecting the selectable button displayed in association with the first editable text container and the one or more additional editable text containers, and in response to receiving the third user input selecting the selectable button, updating the digital file to include a new textual representation of the first editable text container in place of a prior textual representation of the first editable text container, wherein the new textual representation of the first editable text container includes the one or more new tokens added to the first respective structured interrogative finding.

In some embodiments, generating the plurality of interrogative prompts includes: selecting a first distinct interrogative from a corpus of distinct interrogatives; computing, by an embedding model, an embedding vector corresponding to the first distinct interrogative; computing, by the embedding model, a corpus of vector embeddings corresponding to the corpus of unstructured data fragments; executing a first vector similarity search based on the embedding vector corresponding to the first distinct interrogative and the corpus of vector embeddings corresponding to the corpus of unstructured data fragments, wherein the first vector similarity search: detects that a first subset of vector embeddings included in the corpus of vector embeddings are within a threshold vector distance of the embedding vector corresponding to the first distinct interrogative, and returns a first subset of unstructured data fragments associated with the first subset of vector embeddings; and generating a first interrogative prompt of the plurality of interrogative prompts, wherein the distinct interrogative of the first interrogative prompt corresponds to the first distinct interrogative and the distinct subset of unstructured data fragments included in the first interrogative prompt corresponds to the first subset of vector embeddings detected with the threshold vector distance of the embedding vector associated with the first distinct interrogative; selecting a second distinct interrogative from the corpus of distinct interrogatives; computing, by the embedding model, an embedding vector corresponding to the second distinct interrogative; computing, by the embedding model, the corpus of vector embeddings corresponding to the corpus of unstructured data fragments; executing a second vector similarity search based on the embedding vector corresponding to the second distinct interrogative and the corpus of vector embeddings corresponding to the corpus of unstructured data fragments, wherein the second vector similarity search: detects that a second subset of vector embeddings included in the corpus of vector embeddings are within the threshold vector distance of the embedding vector corresponding to the second distinct interrogative, and returns a second subset of unstructured data fragments associated with the second subset of vector embeddings; and generating a second interrogative prompt of the plurality of interrogative prompts, wherein the distinct interrogative of the second interrogative prompt corresponds to the second distinct interrogative and the distinct subset of unstructured data fragments included in the second interrogative prompt corresponds to the second subset of vector embeddings detected with the threshold vector distance of the embedding vector associated with the second distinct interrogative.

### BRIEF DESCRIPTION OF THE FIGURES

FIG. 1 illustrates a schematic representation of a system 100 in accordance with one or more embodiments of the present application;

FIG. 2 illustrates an example method 200 in accordance with one or more embodiments of the present application;

FIG. 3 illustrates an example graphical user interface for uploading a target digital file in accordance with one or more embodiments of the present application;

FIG. 4 illustrates an example schematic for real-time conversion of a target digital file in accordance with one or more embodiments of the present application; and

FIG. 5 illustrates an example of an interactive video object (e.g., explainability video) in accordance with one or more embodiments of the present application.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. System for Real-Time Conversion of Unstructured Data with Lexical Complexity Control

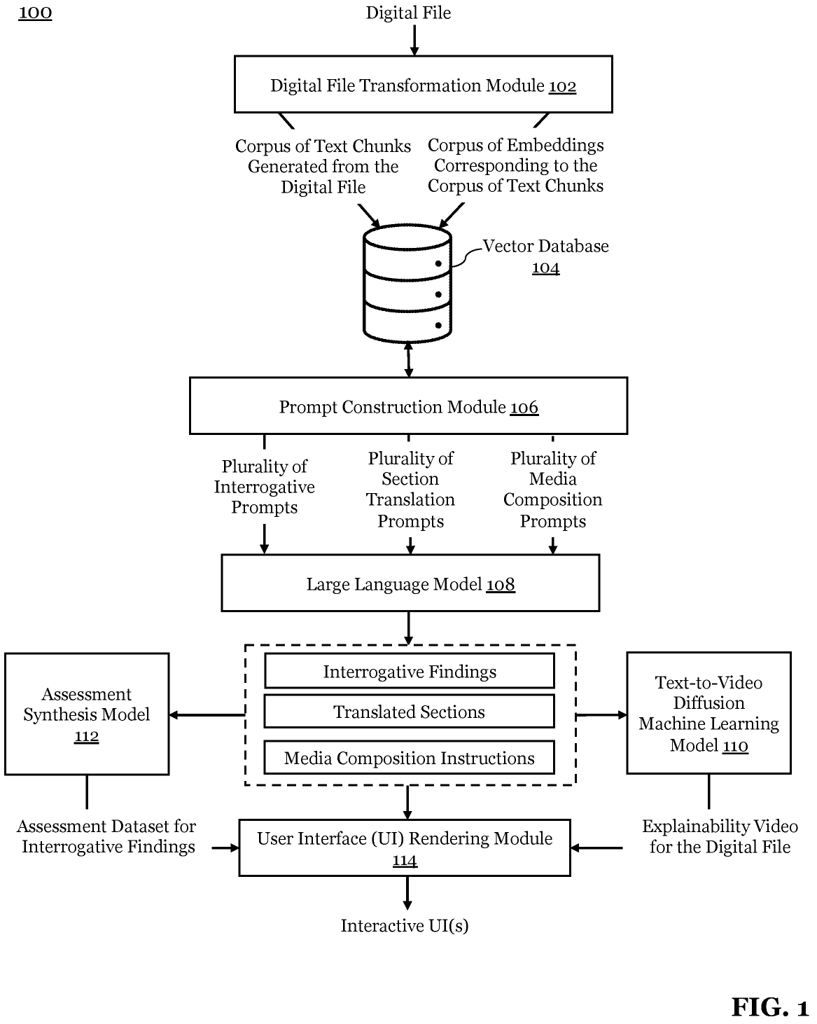

As shown in FIG. 1, a system 100 for real-time conversion of unstructured data with lexical complexity control may include a digital file transformation module 102, a vector database 104, a prompt construction module 106, a large language model 108, a text-to-video diffusion model 110, an assessment synthesis model 112, and a user interface (UI) rendering module 114.

The system 100 may sometimes be referred to herein as an unstructured data conversion service, a lexical complexity control service, or the like. The unstructured data conversion service, in one or more embodiments, may be implemented by a network of distributed computers.

The system 100 may enable real-time conversion of unstructured data into a plurality of distinct transformed digital artifacts having a lexical complexity less than that of the unstructured data. It shall be noted that “real-time” or “near real-time” as generally used herein may refer to generating an output or performing an action within strict time constraints. For example, in one or more embodiments, real-time may be understood to be instantaneous, on the order of milliseconds, or on the order of minutes. Of course, depending on the particular temporal nature of the system in which an embodiment is implemented, other appropriate timescales may be considered acceptable for real-time or near real-time processing.

### 1.1 Digital File Transformation Module

The digital file transformation module 102, sometimes referred to herein as a “digital file preprocessing module,” may be operably configured to monitor an application programming interface (API) endpoint, a cloud storage location, or a computer database for new digital artifacts provided by one or more users of system 100.

The digital file transformation module 102 may be operably configured to detect, in real-time or near real-time, digital artifact upload events occurring at the API endpoint, the cloud storage location, or the computer database. A digital artifact upload event, in some embodiments, may indicate that a new digital artifact has been electronically delivered or transmitted to the API endpoint, the cloud storage location, and/or the computer database that system 100 is actively monitoring. The digital file transformation module 102 may detect such digital artifact upload events using any suitable programmatic mechanism (e.g., cloud listener functions, etc.).

Accordingly, in one or more embodiments, digital file transformation module 102 may receive a new digital artifact in response to system 100 detecting a digital artifact upload event. The new digital artifact received by digital file transformation module 102 may include unstructured data, semi-structured data, and/or structured data. It shall be further recognized that, in one or more embodiments, the new digital artifact may include a plurality of distinct sections and a plurality of distinct paragraphs within each section of the plurality of distinct sections.

In one or more embodiments, after receiving the new digital artifact, digital file transformation module 102 may perform one or more computer-based operations including, but not limited to, converting the new digital artifact to a text-based representation, executing a text cleaning operation to remove or normalize one or more portions of the text-based representation, and/or correcting one or more grammatical errors (e.g., spelling errors) in the text-based representation.

Additionally, or alternatively, in one or more embodiments, digital file transformation module 102 may function to generate, from the text-based representation corresponding to the new digital artifact, a corpus of text chunks and a corpus of embeddings corresponding to the corpus of text chunks. The corpus of text chunks, in such an embodiment, may be generated by segmenting the text-based representation of the new digital artifact into a plurality of distinct sections and/or a plurality of distinct paragraphs. The corpus of embeddings, in such an embodiment, may be generated by an embedding model and numerically represent the corpus of text chunks as multi-dimensional vectors.

### 1.2 Vector Database

The vector database 104, sometimes referred to herein as a “vector store” may be operably configured to store the corpus of text chunks in association with the corpus of embeddings that numerically represent the corpus of text chunks.

In one or more embodiments, the system 100 may provide a text chunk (e.g., a section, a paragraph, etc.) extracted from the new digital artifact to an embedding model and, in response, the embedding model may output an embedding comprising a multi-dimensional vector that numerically represents the text chunk. Accordingly, in response to generating the embedding, vector database 104 may store the embedding in association with the text chunk to create a persistent mapping between the embedding and the text chunk. The system 100 may repeat the foregoing process for each text chunk included in the corpus of text chunks.

In one or more embodiments, vector database 104 may be implemented using any suitable vector storage and retrieval system that is operably configured to store and index embeddings as multi-dimensional vectors. For example, vector database 104 may comprise or be implemented using a vector database system such as Pinecone, Milvus, Weaviate, or Chroma; a vector indexing library such as FAISS (Facebook AI Similarity Search); and/or a search engine or database system with vector search capabilities such as Elasticsearch or OpenSearch. It shall be appreciated that vector database 104 is not limited to the foregoing examples and may include any system capable of storing vector representations and performing similarity-based retrieval operations.

Vector database 104, in one or more embodiments, may be operably configured to store a mapping between each embedding and its corresponding text chunk to support downstream operations performed by system 100 and/or method 200.

### 1.3 Prompt Construction Module

The prompt construction module 106, sometimes referred to herein as a “prompt generation module,” may be operably configured to generate a plurality of lexical complexity mitigation prompts. The prompt construction module 106 may be operably configured to generate the plurality of lexical complexity mitigation prompts based, at least in part, on text chunks retrieved from vector database 104.

It shall be recognized that, in one or more embodiments, the plurality of lexical complexity mitigation prompts generated by prompt construction module 106 may include a plurality of interrogative prompts, a plurality of section translation prompts, and a plurality of media composition prompts.

Each interrogative prompt of the plurality of interrogative prompts may include a distinct interrogative (e.g., a distinct question or the like) and a select set of text chunks (of the corpus of text chunks) stored in vector database 104 that correspond to and/or are semantically related to the distinct interrogative. In one or more embodiments, the selected set of text chunks may be determined based on a similarity search performed over embeddings associated with the text chunks, such that the selected set of text chunks provides contextual information relevant to the distinct interrogative.

For instance, in a non-limiting example, system 100 may function to obtain a distinct interrogative from a corpus of distinct interrogatives and perform a similarity search over vector database 104 to identify a selected set of text chunks that are semantically related to the distinct interrogative. The system 100 may then generate an interrogative prompt by combining the distinct interrogative with the selected set of text chunks. Accordingly, the interrogative prompt may be configured to cause large language model 108 to generate an interrogative finding (e.g., a response or the like) grounded in the selected set of text chunks and having a reduced lexical complexity relative to the selected set of text chunks.

Each section translation prompt of the plurality of section translation prompts may include a distinct section (of the new digital artifact) and a transformation instruction specifying a target lexical complexity level. As used herein, a “section” may refer to a logically grouped portion of the new digital artifact, such as a chapter, subsection, heading-based division, or any contiguous set of paragraphs that collectively corresponds to a unified topic or concept. In one or more embodiments, the transformation instruction may direct large language model 108 to generate a translated section that reduces lexical complexity relative to the distinct section while preserving a semantic meaning and informational content of the distinct section.

For instance, in a non-limiting example, system 100 may function to extract a respective section from the text-based representation of the new digital artifact (e.g., new digital file or the like) and, in response, generate a section translation prompt that includes the respective section and one or more instructions to rewrite the respective section at a predetermined reading level. The section translation prompt may be configured to cause large language model 108 to generate a translated section having simplified vocabulary, shortened sentence structures, and reduced syntactic complexity relative to the respective section.

Stated another way, in one or more embodiments, the new digital artifact may be converted into a text-based representation, cleaned, and optionally corrected for grammatical errors while preserving domain-specific terminology using one or more named entity recognition techniques. The text-based representation may then be segmented into a plurality of sections or text chunks to ensure compatibility with processing constraints of large language model 108. Each section or text chunk may be provided to large language model 108 with one or more transformation instructions specifying a target tone, a target sentence structure, one or more vocabulary constraints, a target format, and/or a target lexical complexity level. The large language model 108 may generate, in response thereto, a plurality of translated sections corresponding to the plurality of sections or text chunks, wherein each translated section exhibits reduced lexical complexity relative to its corresponding section or text chunk while preserving semantic meaning. The plurality of translated sections may then be recombined to form a transformed version of the new digital artifact.

Each media composition prompt of the plurality of media composition prompts may include the text-based representation of the new digital artifact and a set of media composition instructions specifying how to generate multimedia content using the new digital artifact. In one or more embodiments, inclusion of the text-based representation of the new digital artifact may enable large language model 108 to maintain global contextual coherence across multiple portions of the new digital artifact when generating the media composition instructions. The media composition instructions may include parameters defining a sequence of scenes, visual elements, narration content, timing, transitions, pacing, and/or audio features for constructing an explainability video for the new digital artifact.

For instance, in a non-limiting example, system 100 may function to generate a media composition prompt that includes the entire text-based representation of the new digital artifact and one or more instruction to produce a structured set of media composition instructions specifying a target audio sequence and a target video sequence to represent the text-based representation of the new digital artifact. The structured set of media composition instructions may define how portions of the text-based representation are to be mapped to corresponding narration, visual elements, timing, and transitions, such that the resulting multimedia output conveys the content of the text-based representation in a temporally coordinated and contextually coherent manner.

Stated another way, in one or more embodiments, each media composition prompt may be configured to cause large language model 108 to generate a structured set of media composition instructions. The structured set of media composition instructions may specify a target audio sequence and a target video sequence for presenting the text-based representation of the new digital artifact. In one or more embodiments, the structured set of media composition instructions may further specify one or more teach-back segments configured to prompt a user to restate, summarize, or otherwise demonstrate understanding of one or more portions of the text-based representation of the new digital artifact, thereby enabling generation of multimedia content that facilitates both presentation and comprehension of the new digital artifact.

### 1.4 Large Language Model

The large language model 108, sometimes referred to herein as a “language model,” may be operably configured to receive the plurality of lexical complexity mitigation prompts generated by prompt construction module 106 and, in response, generate a plurality of outputs including interrogative findings, translated sections, and media composition instructions. Large language model 108, in one or more embodiments, may correspond to a transformer-based generative model such as a Generative Pre-trained Transformer (GPT) model (e.g., GPT-3, GPT-4, GPT-4.1, GPT-5, etc.), a Bidirectional Encoder Representations from Transformers (BERT)-derived model, a Text-to-Text Transfer Transformer (T5) model, a PaLM (Pathways Language Model), a LLaMA (Large Language Model Meta AI) model, a Claude model, a Mistral model, or any other suitable large-scale neural language model configured for natural language understanding and generation.

In one or more embodiments, large language model 108 may receive the plurality of interrogative prompts and, in response, generate a distinct interrogative finding for each interrogative prompt of the plurality of interrogative prompts. For instance, in a non-limiting example, system 100 may function to provide a subject interrogative prompt to large language model 108 and, in response, large language model 108 may generate a corresponding interrogative finding that answers the distinct interrogative included in the subject interrogative prompt. The interrogative finding generated for the subject interrogative prompt may include one or more of an answer, a summary, an explanation, a paraphrased response, a definition, an extracted key concept, a list of salient points, a contextual clarification, an example-based explanation, or an inference derived from the selected set of text chunks associated with the subject interrogative prompt.

In one or more embodiments, large language model 108 may function to receive the plurality of section translation prompts and, in response, generate a translated section for each section translation prompt of the plurality of section translation prompts. For instance, in a non-limiting example, system 100 may provide a subject section translation prompt to large language model 108 and, in response, large language model 108 may generate a corresponding translated section that rewrites the distinct section included in the subject section translation prompt in accordance with one or more transformation instruction specified in the subject section translation prompt. The translated section generated based on the subject section translation prompt may include simplified vocabulary, modified sentence structures, reduced syntactic complexity, clarified phrasing, reorganized content, and/or expanded explanatory language relative to the distinct section included in the subject section translation prompt.

In one or more embodiments, large language model 108 may receive the plurality of media composition prompts and, in response, generate a structured set of media composition instructions for each media composition prompt of the plurality of media composition prompts. For instance, in a non-limiting example, system 100 may function to provide a subject media composition prompt to large language model 108 and, in response, large language model 108 may generate a structured set of media composition instructions that specifies a target audio sequence and a target video sequence for presenting the text-based representation of the new digital artifact. The structured set of media composition instructions generated based on or using the subject media composition prompt may control how the text-based representation (of the new digital artifact) is to be processed to generate a corresponding audio-visual file. The structured set of media composition instructions may be usable by a text-to-video diffusion model (e.g., the text-to-video diffusion machine learning model 110, a language model, and/or the like) to generate synchronized audio and video content. The structured set of media composition instructions may include instructions for one or more of (i) generating narration derived from the text-based representation of the new digital artifact, (ii) generating visual depictions corresponding to concepts expressed in the text-based representation of the new digital artifact, and/or (iii) coordinating timing and transitions between audio and video elements, such that the generated audio-visual file conveys the content of the text-based representation of the new digital artifact in a synchronized and contextually coherent manner.

### 1.5 Text-to-Video Diffusion Machine Learning Model

The text-to-video diffusion machine learning model 110, sometimes referred to herein as a “text-to-video model,” may be operably configured to receive one or more artifacts (e.g., the interrogative findings, the translated sections, and the media compositions instructions, etc.) generated by large language model 108 and, in response, generate an explainability video for the new digital artifact. The explainability video for the new digital artifact may include a sequence of video frames and corresponding audio content that collectively present the interrogative findings and/or the translated sections in a visually and audibly interpretable format.

In one or more embodiments, the text-to-video diffusion machine learning model 110 may generate the explainability video for the new digital artifact using the structured set of media composition instructions received from large language model 108. The structured set of media composition instructions, in one or more embodiments, may include a sequence of scenes corresponding to portions of the text-based representation of the new digital artifact; a mapping between text segments (e.g., sections, paragraphs, or sentences) and corresponding video scenes; narration scripts derived from the interrogative findings and/or translated sections; voice synthesis parameters including voice type, tone, pitch, cadence, accent, and speaking rate; lexical simplification constraints for the narration scripts to align with a target lexical complexity level; timing parameters including scene durations, narration timing, pause intervals, and synchronization offsets between audio and video; transition definitions including cuts, fades, wipes, zooms, and animated transitions between scenes; visual element specifications including text overlays, diagrams, icons, illustrations, charts, graphs, and symbolic representations; layout parameters specifying spatial arrangement of the visual elements within a frame; animation parameters including motion trajectories, object transformations, emphasis animations, and temporal sequencing of visual elements; background settings including colors, gradients, textures, and thematic visual styles; camera parameters including virtual camera position, angle, zoom level, pan, and focus effects; highlighting instructions for emphasizing key terms, phrases, or concepts within a scene; captioning instructions including subtitle generation, formatting, timing, and synchronization with narration; insertion of interrogative findings at predetermined points within the video timeline; one or more target teach-back segments operably configured to prompt a user to restate, summarize, or answer questions related to presented content; instructions for pausing playback or presenting overlays to capture user input during interactive segments; personalization parameters based on user profile data including preferred language, reading level, or domain familiarity; error-handling instructions for resolving inconsistencies between narration and visual content; content filtering or redaction rules for excluding sensitive or irrelevant information; multi-modal alignment instructions coordinating text, audio, and visual modalities; instructions for generating thumbnails, preview frames, or summary clips associated with the explainability video; and/or export parameters specifying output format, resolution, encoding settings, and delivery mechanisms for the explainability video. In one or more embodiments, the structured set of media composition instructions may control how text-to-video diffusion machine learning model 110 generates the explainability video for the new digital artifact.

The explainability video for the new digital artifact, in one or more embodiments, may be configured to operate in a passive mode in which content is presented for user consumption without requiring input. Additionally, or alternatively, the explainability video for the new digital artifact may be configured to operate in an active mode in which playback includes one or more interactive segments (e.g., teach-back segments) that prompt user participation, thereby enabling selective or combined passive viewing and active engagement.

It shall be recognized that, in some embodiments, the text-to-video diffusion machine learning model 110 may include or be implemented using one or more diffusion-based generative video models including, but not limited to, Sora, Sora 2, Imagen Video, Video Diffusion Models (VDM), Stable Video Diffusion, and other diffusion-based architectures configured to generate temporally consistent sequences of video frames from noise conditioned on textual and structured inputs.

### 1.6 Assessment Synthesis Model

The assessment synthesis model 112, sometimes referred to herein as an “assessment model,” may be operably configured to generate one or more user assessments corresponding to the teach-back segments included in the explainability video generated for the new digital artifact. The one or more user assessments may include comprehension questions, prompts requiring summarization or explanation, application-based tasks, and/or evaluative queries derived from the interrogative findings and/or the translated sections.

The assessment synthesis model 112 may generate the one or more user assessments using one or more artifacts generated by large language model 108. For example, in some embodiments, assessment synthesis model 112 may function to generate, in real-time or near real-time, the one or more user assessments using the interrogative findings, the translated sections, and/or the media composition instructions outputted by large language model 108.

Accordingly, assessment synthesis model 112 may enable dynamic generation of contextually grounded and lexically aligned user assessments that reinforce comprehension of the new digital artifact and facilitate active user engagement during presentation of the generated explainability video.

It shall be recognized that, in one or more embodiments, the one or more user assessments may be further provided as input to the text-to-video diffusion machine learning model 110 to control generation of the explainability video for the new digital artifact (e.g., new digital file or the like).

It shall be further recognized that, in one or more embodiments, the one or more user assessments may be combined with the explainability video after text-to-video diffusion machine learning model 110 generates the explainability video. Accordingly, combining the explainability video with the one or more user assessments after text-to-video diffusion machine learning model 110 generates the explainability video produces a composite multimedia item that synchronizes presentation of content with corresponding user assessments.

### 1.7 UI Rendering Module

The user interface (UI) rendering module 114, sometimes referred to herein as a “UI module,” may be operably configured to present one or more outputs generated by system 100 to a user in a visually and interactively accessible format. The UI rendering module 114 may receive, as input, one or more of the translated sections, interrogative findings, explainability video, and/or user assessments and, in response, may render such outputs within one or more graphical user interfaces.

In one or more embodiments, UI rendering module 114 may function to display the explainability video generated by text-to-video diffusion machine learning model 110 within a media playback interface. The media playback interface may include one or more controls such as play, pause, seek, playback speed adjustment, caption toggling, and/or mode selection between passive and active viewing modes as described above.

In one or more embodiments, the UI rendering module 114 may further present one or more user assessments generated by assessment synthesis model 112 in conjunction with the generated explainability video. For example, UI rendering module 114 may display one or more (e.g., interactive) user assessment during teach-back segments embedded within the explainability video and may receive corresponding user inputs including text-based responses, selections, and/or audio inputs.

In one or more embodiments, UI rendering module 114 may be operably configured to present feedback corresponding to the one or more user assessments in real-time or near real-time. The feedback may include correctness indicators, explanatory guidance, hints, or references to relevant portions of the translated sections or interrogative findings, thereby facilitating iterative learning and comprehension improvement.

Additionally, or alternatively, in one or more embodiments, UI rendering module 114 may further function to present the interrogative findings in association with the translated sections.

### 2. Method for Real-Time Conversion of Unstructured Data with Lexical Complexity Control

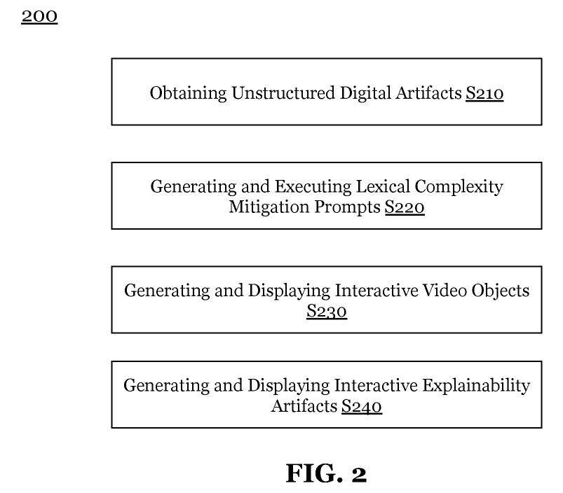

As shown in FIG. 2, a method 200 for real-time conversion of unstructured data with lexical complexity control includes obtaining unstructured digital artifacts (S210), generating and executing lexical complexity mitigation prompts (S220), generating interactive video objects (S230), and generating interactive explainability artifacts (S240).

### 2.1 Obtaining an Unstructured Digital Artifact

S210, which includes obtaining unstructured digital artifacts, may function to receive or obtain one or more unstructured digital artifacts that have a lexical complexity exceeding a maximum complexity threshold. A lexical complexity of an unstructured digital artifact, as generally used herein, may measure a linguistic difficulty of the unstructured digital artifact based on one or more tokens, sentences, paragraphs, and/or sections underlying the unstructured digital artifact. If the lexical complexity of the unstructured digital artifact exceeds the maximum complexity threshold, automated decisioning systems, machine learning models, and/or users may be unable to interpret the semantic meaning or intent of the unstructured digital artifact.

In some embodiments, S210 may compute a text readability score to determine the lexical complexity of the unstructured digital artifact. S210 may compute the text readability score based on one or more linguistic features of the unstructured digital artifact. For example, in some embodiments, S210 may compute the text readability score based on (e.g., as a function of) a total number of words, a total number of sentences, and/or a total number of syllables associated with the unstructured digital artifact. If the text readability score exceeds a target readability threshold (e.g., 30, 50, 60, 70, 80, 90, 95, etc.), S210 may detect that a lexical complexity of the unstructured digital artifact exceeds a maximum complexity threshold. It shall be noted that, in some portions of the disclosure, the term “maximum complexity threshold” may interchangeably be referred to as a “target readability threshold” and/or the like.

Non-limiting examples of the text readability score computed by S210 may include, but should not be limited to, a Flesch Reading Ease score, a Flesch-Kincaid Grade Level score, a Simple Measure of Gobbledygook (SMOG) index, a Gunning Fog Index, a Coleman-Liau Index, an Automated Readability Index, a Dale-Chall readability score, a composite readability score derived from two or more readability metrics, and/or any other metric configured to quantify a linguistic difficulty of an unstructured digital artifact.

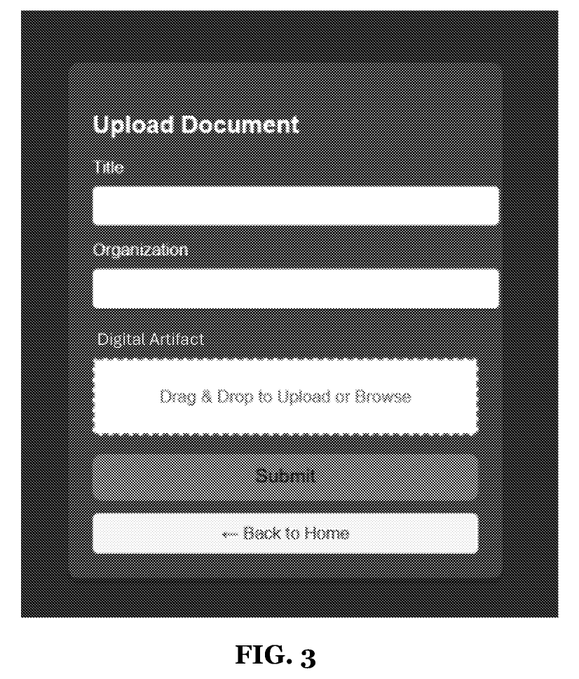

In some embodiments, S210 may obtain one or more unstructured digital artifacts (e.g., digital files) at a graphical user interface. The graphical user interface, as illustrated in FIG. 3, may include one or more input fields configured to receive metadata associated with a respective unstructured digital artifact (e.g., document title, organization, etc.), and one or more file upload user interface elements configured to receive a respective unstructured digital artifact. It shall be noted that the above example is not intended to be limiting and that S210 may additionally, or alternatively, obtain an unstructured digital artifact using one or more command line interfaces (CLIs), and/or one or more application programming interfaces (APIs) without departing from the scope of the disclosure.

### Converting the Unstructured Digital Artifact to a Markdown-Formatted File

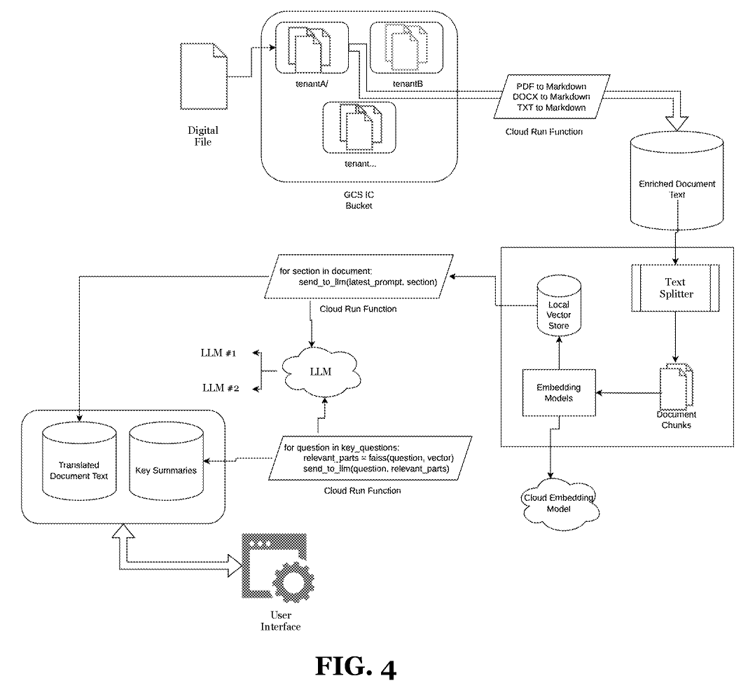

In response to obtaining an unstructured digital artifact, S210 may automatically convert the unstructured digital artifact to a markdown-formatted file (as generally illustrated in FIG. 4). The markdown-formatted file, as generally used herein, may include markdown syntax that preserves a structural arrangement and formatting of text in the unstructured digital artifact. For example, the markdown syntax may include heading indicators (e.g., ‘#’, ‘##’, etc.) to denote section titles in the unstructured digital artifact, line breaks to separate paragraphs of text in the unstructured digital artifact, and formatting indicators (e.g., ‘*’, ‘-’, or ‘-’) to represent lists or emphasized text within the unstructured digital artifact.

For instance, in a non-limiting example, the unstructured digital artifact may include a plurality of sections (e.g., Section 1, Section 2, … Section N). Section 1 may include a section title (e.g., Title 1) and one or more paragraphs of text (e.g., paragraphs A, B, …, M). Section 2 may include a section title (e.g., Title 2) and one or more paragraphs of text (e.g., paragraphs N, O, …, Z). The remaining sections in the unstructured digital artifact may analogously include a corresponding section title and one or more paragraphs of text associated with each respective section.

In the markdown-formatted file, each respective section title (e.g., Title 1, Title 2, … Title N) may be represented using a corresponding heading indicator (e.g., ‘# Title 1’, ‘# Title 2,’ …, ‘# Title N’). The one or more paragraphs of text associated with each respective section (e.g., paragraphs A, B, …, M; paragraphs N, O, …, Z; etc.) may be positioned in the markdown-formatted file subsequent to (i.e., directly beneath) the corresponding heading indicator, such that the one or more paragraphs of text are contextually associated with the respective section title based on their relative position within the markdown-formatted file. For instance, a first section title (e.g., ‘# Title 1’) may be followed by a first set of paragraphs (e.g., paragraphs A, B, …, M), and a second section title (e.g., ‘# Title 2’) may be followed by a second set of paragraphs (e.g., paragraphs N, O, …, Z), such that each respective set of paragraphs is associated with the most recent preceding heading indicator.

In some embodiments, S210 may generate the markdown-formatted file based on one or more event listeners (e.g., cloud run functions). The one or more event listeners of S210 may continuously monitor for ingestion events corresponding to receipt of an unstructured digital artifact. Non-limiting examples of ingestion events may include, but should not be limited to, a file upload event corresponding to receipt of the unstructured digital artifact at a graphical user interface, a file submission event corresponding to receipt of the unstructured digital artifact via an application programming interface (API), a command invocation corresponding to receipt of the unstructured digital artifact via a command line interface (CLI), and/or a storage event corresponding to persistence of the unstructured digital artifact in a data store (e.g., database). In response to detecting any of the above-described ingestion events, the one or more event listeners of S210 may automatically trigger generation of the markdown-formatted file for the unstructured digital artifact.

### Extracting a Corpus of Unstructured Data Fragments

Additionally, S210 may automatically extract a corpus of unstructured data fragments (e.g., chunks or the like) from the unstructured digital artifact. Each respective unstructured data fragment included in the corpus of unstructured data fragments may comprise a set of paragraphs associated with a respective section of the unstructured data fragment. For instance, in a non-limiting example, the unstructured digital artifact may comprise a plurality of sections (e.g., section A, section B, …, section N). In such an example, S210 may segment the unstructured digital artifact based on the plurality of sections, such that a first unstructured data fragment corresponds to section A and includes the one or more paragraphs associated with section A, a second unstructured data fragment corresponds to section B and includes the one or more paragraphs associated with section B, and so on for the remaining sections.

In some embodiments, S210 may generate the corpus of unstructured data fragments by splitting the markdown-formatted file based on heading indicators (e.g., section boundaries) identified in the markdown-formatted file. For example, the markdown-formatted file may include a first heading indicator (e.g., ‘# Title A’) followed by a first set of paragraphs, a second heading indicator (e.g., ‘# Title B’) followed by a second set of paragraphs, and so on. In such an example, S210 may split the markdown-formatted file at positions corresponding to the heading indicators, such that a first unstructured data fragment includes text positioned between the first heading indicator and the second heading indicator, a second unstructured data fragment includes text positioned between the second heading indicator and a subsequent heading indicator, and so on for the remaining heading indicators.

In some embodiments, S210 may determine a number of paragraphs to include in each respective unstructured data fragment based on a maximum token threshold. For example, S210 may iteratively aggregate one or more paragraphs associated with a respective section until a total number of tokens associated with the aggregated paragraphs satisfies (e.g., is less than or equal to) the maximum token threshold. In such embodiments, a respective unstructured data fragment may include all paragraphs associated with a section when the total number of tokens for the section is within the maximum token threshold, or may only include a subset of paragraphs (e.g., a single paragraph or a limited number of paragraphs) when the total number of tokens exceeds the maximum token threshold.

Additionally, or alternatively, S210 may implement a sliding-window chunker to generate the corpus of unstructured data fragments. The sliding-window chunker may traverse the markdown-formatted file (or the unstructured digital artifact) using a sliding window that generates each respective unstructured data fragment based on a current window position and overlapping window region that includes a portion of text from an adjacent window position. For example, the sliding-window chunker may generate a first unstructured data fragment corresponding to a first window position that includes text associated with a first section, and a second unstructured data fragment corresponding to a subsequent window position that includes text associated with the first section and a portion of text associated with a second section. In some embodiments, the portion of text associated with the second section may comprise a predetermined overlap (e.g., approximately 5%, 10%, 15%, 20%, etc. of the second section), such that adjacent unstructured data fragments share overlapping content and preserve contextual continuity between adjacent portions of the unstructured digital artifact.

### Named Entity Protection

In some embodiments, S210 may implement named entity protection in conjunction with the generation of the corpus of unstructured data fragments. For example, before S210 generates the corpus of unstructured data fragments, S210 may assess the unstructured digital artifact (or the markdown-formatted file) against a named entity protection corpus. The named entity protection corpus, as generally used herein, may include a collection of domain-specific entities that are to be protected during generation of the corpus of unstructured data fragments. If S210 detects that the unstructured digital artifact (or the markdown-formatted file) includes one or more domain-specific entities from the named entity protection corpus, S210 may replace tokens (e.g., words or phrases) corresponding to the one or more domain-specific entities with corresponding placeholder tokens (e.g., a placeholder symbol, reverse token strings, and/or the like).

During generation or extraction of the corpus of unstructured data fragments, S210 may detect the placeholder tokens as indivisible units that cannot be separated across multiple unstructured data fragments. For instance, if S210 detects a placeholder symbol while generating a respective unstructured data fragment, S210 may determine if inclusion of the domain-specific entity corresponding to the placeholder symbol would cause the respective unstructured data fragment to exceed a maximum token threshold.

If inclusion of the domain-specific entity corresponding to the placeholder symbol would cause the respective unstructured data fragment to exceed the maximum token threshold, S210 may generate the respective unstructured data fragment without including the placeholder symbol, such that the placeholder symbol is instead fully included in a subsequent unstructured data fragment corresponding to a subsequent window position. Alternatively, in some embodiments, if inclusion of the domain-specific entity corresponding to the placeholder symbol would cause the respective unstructured data fragment to exceed the maximum token threshold, S210 may still include the placeholder symbol in the respective unstructured data fragment in its entirety.

After generating (e.g., extracting) the corpus of unstructured data fragments, S210 may replace the placeholder tokens with the corresponding domain-specific entities. In such embodiments, S210 may search the corpus of unstructured data fragments for occurrences of the placeholder tokens and replace each occurrence of a placeholder token with a corresponding domain-specific entity based on a mapping between the placeholder tokens and the domain-specific entities.

The mapping between the placeholder tokens and the domain-specific entities, in a non-limiting example, may include an association between a first placeholder token (e.g., ‘[ENTITY_1]’) and a first domain-specific entity, an association between a second placeholder token (e.g., ‘[ENTITY_2]’) and a second domain-specific entity, and so on, such that S210 replaces occurrences of the placeholder tokens within the corpus of unstructured data fragments with the corresponding domain-specific entities. It shall be noted that, in some embodiments, the mapping between the placeholder tokens and the domain-specific entities may be dynamically generated during replacement of the one or more domain-specific entities with the placeholder tokens.

### 2.2 Generating a Plurality of Lexical Complexity Mitigation Prompts

S220, which includes generating lexical complexity mitigation prompts, may function to generate a plurality of lexical complexity mitigation based on the corpus of unstructured data fragments (extracted by S210). The corpus of unstructured data fragments extracted by S210, as discussed above, may include one or more paragraphs or sections of the unstructured digital artifact that are causing the lexical complexity of the unstructured digital artifact to exceed a maximum complexity threshold. The plurality of lexical complexity mitigation prompts, as generally used herein, may be used by method 200 to generate an interactive explainability artifact (e.g., user interface or the like) that reduces and/or mitigates the lexical complexity of the unstructured digital artifact.

### Computing Vector Embeddings for the Corpus of Unstructured Data Fragments

In some embodiments, S220 may input the corpus of unstructured data fragments into an embedding model. In response to S220 inputting the corpus of unstructured data fragments into the embedding model, the embedding model may compute (e.g., generate) a corpus of vector embeddings corresponding to the corpus of unstructured data fragments. Each respective vector embedding included in the corpus of vector embeddings may correspond to a distinct unstructured data fragment and include an n-dimensional array of numerical values that map the distinct unstructured data fragment to an n-dimensional vector space. In some embodiments, the n-dimensional array of numerical values may include 128 dimensions, 256 dimensions, 512 dimensions, 768 dimensions, 1024 dimensions, or any other suitable number of dimensions.

In a non-limiting example, the corpus of vector embeddings may include 10, 100, 1,000, 10,000, 100,000, 1,000,000, 10,000,000, 100,000,000, 100,000,000,000, or more vector embeddings. A first vector embedding in the corpus of vector embeddings may map a first unstructured data fragment to an n-dimensional vector space. Similarly, a second vector embedding in the corpus of vector embeddings may map a second unstructured data fragment to the n-dimensional vector space, and so on, such that each remaining vector embedding in the corpus of vector embedding corresponds to a distinct unstructured data fragment included in the corpus of unstructured data fragments.

In some embodiments, the embedding model implemented by S220 may include, but should not be limited to, a transformer-based embedding model, a recurrent neural network (RNN)-based embedding model, a long short-term memory (LSTM)-based embedding model, a convolutional neural network (CNN)-based embedding model, a bidirectional encoder representation from transformers (BERT)-based embedding model, a generative pre-trained transformer (GPT)-based embedding model, a sentence-transformer-based embedding model, a cloud-based embedding model, and/or any other suitable embedding model.

### Generating Interrogative Prompts

Additionally, in some embodiments, S220 may generate a plurality of interrogative prompts based on a target corpus of interrogatives. The target corpus of interrogatives may include a plurality of distinct interrogatives created by a user or automatically created based on a domain-specific protocol associated with the unstructured digital artifact. A domain-specific protocol, as generally used herein, may refer to a predefined set of requirements, rules, and/or guidelines associated with a domain of the unstructured digital artifact. Non-limiting examples of a domain-specific protocol associated with the unstructured digital artifact may include, but should not be limited to, industry standards, compliance frameworks, organizational policies, and/or best practice guidelines associated with a domain of the unstructured digital artifact.

It shall be noted that, in some embodiments, a distinct interrogative in the target corpus of interrogatives may comprise a question about the content or data (e.g., words, paragraphs, sections, tokens, etc.) included in the unstructured digital artifact. Additionally, or alternatively, a distinct interrogative (e.g., question), in some embodiments, may begin with one or more interrogative terms (e.g., “what,” “when,” “where,” “why,” “how,” “does,” “is,” “are,” and/or the like), followed by one or more words, phrases, and/or tokens corresponding to content/data of the unstructured digital artifact, and terminate with a question mark. Non-limiting examples of the plurality of distinct interrogatives may include “What is the purpose of X?”, “What is the description of X?”, “What are the risks of X?”, “What are the benefits?”, “What are the alternatives to X?” and/or the like. It shall be noted that the character ‘X’ in the above non-limiting examples may represent a subject, object, or concept.

In some embodiments, each interrogative prompt generated by S220 may correspond to a distinct interrogative included in the target corpus of interrogatives. For instance, S220 may generate a first interrogative prompt for a first interrogative included in the target corpus of interrogatives, a second interrogative prompt for a second interrogative included in the target corpus of interrogatives, and so on, such that each respective interrogative prompt corresponds to a distinct interrogative included in the target corpus of interrogatives.

In a non-limiting example, S220 may generate the first interrogative prompt by executing a vector similarity search based on the first interrogative associated with the first interrogative prompt. In such embodiments, S220 may input the first interrogative to an embedding model (described above). In turn, the embedding model may generate an embedding vector corresponding to the first interrogative. It shall be noted that the embedding vector of the first interrogative may have one or more characteristics similar to the corpus of vector embeddings described above.

After computing the embedding vector of the first interrogative, S220 may execute a vector similarity search based on the embedding vector of the first interrogative and the corpus of vector embeddings corresponding to the corpus of unstructured data fragments (also described above). The vector similarity search may compute a plurality of vector distances between the embedding vector of the first interrogative and each embedding vector in the corpus of vector embeddings. For instance, in a non-limiting example, S220 may compute a first cosine or Euclidean vector distance between the embedding vector of the first interrogative and a first embedding vector in the corpus of vector embeddings, a second cosine or Euclidean vector distance between the embedding vector of the first interrogative and a second embedding vector in the corpus of vector embeddings, and so on for the remaining embedding vectors included in the corpus of vector embeddings.

Based on computing the plurality of vector distances, S220 may detect a subset of vector embeddings that are within a threshold vector distance (e.g., a predefined cosine similarity threshold, a Euclidean distance threshold, and/or a top-k nearest neighbor criterion) of the embedding vector corresponding to the first interrogative. For instance, in a non-limiting example, S220 may detect that a first, second, and third vector distance associated with the first, second, and third embedding vectors satisfy the threshold vector distance with respect to the embedding vector corresponding to the first interrogative, respectively. Conversely, in some embodiments, S220 may detect that a fourth, fifth, and sixth vector distance associated with the fourth, fifth, and sixth embedding vectors do not satisfy the threshold vector distance with respect to the embedding vector corresponding to the first interrogative, respectively. It shall be noted that the above example is not intended to be limiting and that additional, different, or fewer embedding vectors may satisfy the threshold vector distance without departing from the scope of the disclosure.

In response to detecting that the subset of vector embeddings are within the threshold vector distance, the vector similarity search may return a subset of unstructured data fragments corresponding to the subset of vector embeddings. For instance, with reference to the above example, in response to detecting that the first, second and third embedding vectors satisfy the threshold vector distance, the vector similarity search may return a first, second, and third unstructured data fragment corresponding to the first, second, and third embedding vectors. It shall be noted that if S220 detected that additional, different, or fewer embeddings were within the threshold vector distance, the vector similarity search may correspondingly return additional, different, or fewer unstructured data fragments.

Lastly, in some embodiments, S220 may generate the first interrogative prompt as comprising the first interrogative and the subset of unstructured data fragments returned by the vector similarity search. Specifically, with reference to the above example, the first interrogative prompt may comprise the first interrogative and the first, second, and third unstructured data fragments corresponding to the first, second, and third embedding vectors. In such embodiments, the subset of unstructured data fragments may provide contextual information for the first interrogative.

It shall be noted that S220 may generate additional interrogative prompts (e.g., a second interrogative prompt, a third interrogative prompt, a fourth interrogative prompt, etc.) in analogous ways described above with respect to the first interrogative prompt, but performed based on corresponding distinct interrogatives associated with the additional interrogative prompts. For instance, S220 may input a second interrogative to the embedding model to generate an embedding vector corresponding to the second interrogative, execute a vector similarity search based on the embedding vector of the second interrogative and the corpus of vector embeddings, compute a plurality of vector distances between the embedding vector of the second interrogative and the corpus of vector embeddings, detect a subset of vector embeddings satisfying a threshold vector distance with respect to the embedding vector of the second interrogative, retrieve a corresponding subset of unstructured data fragments, and generate the second interrogative prompt as comprising the second interrogative and the corresponding subset of unstructured data fragments.

### Executing Interrogative Prompts

After generating the plurality of interrogative prompts, S220 may transmit the plurality of interrogative prompts to a large language model. Non-limiting examples of the large language model implemented by S220 may include, but should not be limited to, GPT, GPT-2, GPT-3, GPT-4, GPT-4.5, GPT-5 (and all subsequent iterations), bidirectional encoder representation form transformers (BERT), LLaMA, Claude 1, Claude 2, Claude 3, Claude 3.5, Claude 4, or any other suitable large language model.

In response to transmitting the plurality of interrogative prompts to the large language model, the large language model may generate a respective structured interrogative finding for each distinct interrogative included in the plurality of interrogative prompts. A respective structured interrogative finding, sometimes referred to herein as a “key summary,” may include a text, video, audio, and/or image answer to the distinct interrogative included within a respective interrogative prompt. The large language model, in some embodiments, may generate the answer to the distinct interrogative using the corpus of unstructured data fragments included in the respective interrogative prompt (such that the answer is grounded in content of the unstructured digital artifact).

For instance, in a non-limiting example, the large language model of S220 may generate a first respective structured interrogative finding that answers a first distinct interrogative included in a first interrogative prompt. The large language may generate the first respective structured interrogative finding based on a first corpus of unstructured data fragments included in the first interrogative prompt. The first respective structured interrogative finding may answer the first distinct interrogative using one or more modalities, including text, video, audio, and/or image data.

Additionally, in some embodiments, the large language model of S220 may generate a second respective structured interrogative finding that answers a second distinct interrogative included in a second interrogative prompt. The large language may generate the second respective structured interrogative finding based on a second corpus of unstructured data fragments included in the second interrogative prompt. The second respective structured interrogative finding may answer the second distinct interrogative using one or more modalities, including text, video, audio, and/or image. It shall be noted that the above examples are not intended to be limiting and that the large language model of S220 may generate additional, different, or fewer structured interrogative findings without departing from the scope of the disclosure.

### Validating Each Structured Interrogative Finding

In some embodiments, S220 may validate each structured interrogative finding generated by the large language model. As discussed above, in some embodiments, S220 may generate a first structured interrogative finding for a first distinct interrogative, a second structured interrogative finding for a second distinct interrogative, and so on for a plurality of distinct interrogatives included in the plurality of interrogative prompts. Therefore, in some embodiments, S220 may function to validate, in parallel, the first structured interrogative finding, the second structured interrogative finding, and so on for the plurality of structured interrogative findings generated by the large language model.

In some embodiments, validating the first structured interrogative finding (generated above) may include detecting one or more linguistic features of the first structured interrogative finding. The one or more linguistic features may include, but should not be limited to, a total number of words, a total number of sentences, and/or a total number of syllables included in the first structured interrogative finding. Based on the total number of words, the total number of sentences, and/or the total number of syllables included in the first structured interrogative finding, S220 may compute a text readability score of the first structured interrogative finding.

The text readability score of the first structured interrogative finding may comprise a value ranging from 0-100 indicating a readability level of the first structured interrogative finding. S220 may assess the text readability score against a target readability threshold (e.g., 30, 50, 60, 70, 80, 90, 95, etc.). If the text readability score satisfies (e.g., exceeds) the target readability threshold, S220 may detect that the sentences and/or paragraphs of the first structured interrogative finding passes a target reading level of a user. Conversely, if the text readability score does not satisfy (e.g., does not exceed) the target readability threshold, S220 may detect that the sentences and/or paragraphs of the structured interrogative finding does not pass the target reading level of the user.

In response to detecting that the text readability score for the first structured interrogative finding does not satisfy the target readability threshold, S220 may iteratively generate a plurality of additional structured interrogative findings. S220, in some embodiments, may iteratively generate the plurality of additional structured interrogative findings using a plurality of distinct candidate interrogative prompts. Iteratively generating the plurality of additional structured interrogative findings may include generating a first additional structured interrogative finding. After generating the first additional structured interrogative finding, S220 may compute a text readability score of the first additional structure interrogative finding.

If the text readability score of the first additional structured interrogative finding does not satisfy the target readability threshold, S220 may then iteratively generate a second additional structured interrogative finding and compute a text readability score of the second additional structured interrogative finding. If the text readability score of the second additional structured interrogative finding does not satisfy the text readability score, S220 may continue iteratively generating one or more additional structured interrogative findings (e.g., having text readability scores that do not satisfy the target readability threshold) until S220 detects a structured interrogative finding satisfying the target readability threshold is generated (sometimes referred to as a “second additional structured interrogative finding”).

In some embodiments, each distinct candidate interrogative prompt of the plurality of distinct candidate interrogative prompts may be or include a copy of the first respective interrogative prompt. A respective candidate interrogative prompt including a copy of the first respective interrogative prompt may comprise the first interrogative associated with the first interrogative prompt and the subset of unstructured data fragments associated with the first interrogative prompt. For instance, the plurality of distinct candidate interrogative prompts may include a first candidate interrogative prompt that generates the first additional structured interrogative finding and a second candidate interrogative prompt that generates the second additional structured interrogative finding (among others). In such embodiments, the first candidate interrogative prompt may include the first interrogative and the subset of unstructured data fragments associated with the first interrogative prompt. Likewise, the second candidate interrogative prompt may include the first interrogative and the subset of unstructured data fragments associated with the first interrogative prompt.

It shall be noted that a remainder of the plurality of distinct candidate interrogative prompts may include content (e.g., data) analogous to the first and second candidate interrogative prompts. Additionally, in some embodiments, each of the plurality of distinct candidate interrogative prompts may be generated based on one or more linguistic features (e.g., a total number of words, a total number of sentences, and/or a total number of syllables) included in a previous structured interrogative finding. Each of the plurality of distinct candidate interrogative prompts may further request that the large language model generate a subsequent structured interrogative finding using fewer words, sentences, and syllables than the total number of words, sentences, and syllables included in the previous structured interrogative finding.

For instance, in a non-limiting example, S220 may generate the first candidate interrogative prompt based on the first respective interrogative finding generated prior to (e.g., directly before) the first candidate interrogative prompt. Based on the first respective interrogative finding being previously generated (e.g., the previous structured interrogative finding), S220 may detect a total number of words, a total number of sentences, and/or a total number of syllables included in the previous structured interrogative finding. In turn, S220 may encode the first candidate interrogative prompt with instructions that request the large language model to generate a subsequent structured interrogative finding (e.g., the first additional structured interrogative finding) using fewer words, sentences, and syllables than the total number of words, the total number of sentences, and/or the total number of syllables included in the previous structured interrogative finding.

In yet another non-limiting example, S220 may generate the second candidate interrogative prompt based on the first additional structured interrogative finding generated prior to (e.g., directly before) the second candidate interrogative prompt. Based on the first additional structured interrogative finding being previously generated (e.g., the previous structured interrogative finding), S220 may detect a total number of words, a total number of sentences, and/or a total number of syllables included in the previous structured interrogative finding. In turn, S220 may encode the second candidate interrogative prompt with instructions that request the large language model to generate a subsequent structured interrogative finding (e.g., the second additional structured interrogative finding) using fewer words, sentences, and syllables than the total number of words, the total number of sentences, and/or the total number of syllables included in the previous structured interrogative finding.

In some embodiments, the encoding of a respective candidate interrogative prompt may be based on a current number of additional structured interrogative findings that have been generated by the large language model. For instance, when encoding the second candidate interrogative prompt, S220 may detect a current (total) number of additional structured interrogative findings that have been generated before the second additional structured interrogative finding (e.g., 1, 5, 10, 15, 20, 40, 80, etc. additional structured interrogative findings). S220, in some embodiments, may detect that the current number of additional structured interrogative findings exceeds a first number, and in response, encode the second candidate interrogative prompt with instructions that request the large language model to generate a subsequent interrogative finding using a first amount of fewer words, sentences, and syllables than the total number of words included in the previous structured interrogative finding (e.g., 10, 15, 20, etc. less words, sentences, and syllables).

Conversely, in some embodiments, S220 may detect that the current number of additional structured interrogative findings exceeds a second number greater than the first number, and in response, encode the second candidate interrogative prompt with instructions that request the large language model to generate the subsequent structured interrogative finding using a second amount of fewer words, sentences, and syllables than the total number of words, sentences, and syllables included in the previous structured interrogative finding (e.g., 20, 30, 40, etc. fewer words, sentences, and syllables), the second amount being greater than the first amount of reduction.

It shall be noted that, in some embodiments, the amount of reduction in the number of words, sentences, and syllables requested by a respective candidate interrogative prompt may scale based on the current number of additional structured interrogative findings generated by the large language model. For instance, S220 may progressively increase the amount of reduction in linguistic features as the number of additional structured interrogative findings increases, such that earlier candidate interrogative prompts request a first amount of reduction and later candidate interrogative prompts request a greater amount of reduction than the first amount. In a non-limiting example, S220 may encode a first candidate interrogative prompt to request a reduction of 5-10 words, sentences, and syllables, a second candidate interrogative prompt to request a reduction of 11-20 words, sentences, and syllables, and a third candidate interrogative prompt to request a reduction of 21-40 words, sentences, and syllables, and so on, such that the reduction scales with the number of additional structured interrogative findings generated.

In some embodiments, the amount of reduction may be computed based on a difference between a current text readability score of a structured interrogative finding and the target readability threshold. For instance, if the target readability threshold is 70 and a current text readability score is 40, S220 may compute a reduction amount corresponding to a difference of 30, and encode a candidate interrogative prompt requesting a reduction of 25-40 words, sentences, and syllables. Conversely, if the current text readability score is 65, S220 may compute a reduction amount corresponding to a difference of 5 and encode a candidate interrogative prompt requesting a reduction of 5-10 words, sentences, and syllables.

In another non-limiting example, S220 may compute the amount of reduction based on a rate of change of text readability scores across previously generated structured interrogative findings. For instance, if a first structured interrogative finding has a readability score of 40, a second structured interrogative finding has a readability score of 42, and a third structured interrogative finding has a readability score of 43, S220 may detect a slow rate of improvement and increase the requested reduction amount (e.g., from 10 words to 30 words). Conversely, if readability scores improve more rapidly (e.g., 40 to 55 to 68), S220 may reduce the requested reduction amount (e.g., from 30 words to 10 words).

In yet another non-limiting example, S220 may compute the amount of reduction based on a weighted contribution of linguistic features. For instance, if syllable count contributes more significantly to the readability score than sentence count, S220 may encode a candidate interrogative prompt requesting a reduction of 20 syllables, 10 words, and 2 sentences, rather than uniformly reducing all features.

In still another non-limiting example, S220 may compute the amount of reduction based on a distribution of linguistic features across the plurality of additional structured interrogative findings. For instance, if a threshold amount of structured interrogative findings include between 200-250 words and the target range is 100-150 words, S220 may encode candidate interrogative prompts requesting reductions that shift the distribution toward the target range (e.g., reductions of 50-100 words).

In a further non-limiting example, S220 may compute the amount of reduction based on a convergence criterion. For instance, if a plurality of additional structured interrogative findings repeatedly fail to achieve a readability score above 60, S220 may increase the reduction amount (e.g., from 20 words to 50 words) to accelerate convergence toward the target readability threshold.

### Constructing a Plurality of Content Hallucination Prompts

After S220 detects a structured interrogative finding that satisfies the target readability threshold, S220 may construct a plurality of content hallucination mitigation prompts that assess the structured interrogative finding against the unstructured digital artifact. The plurality of content hallucination mitigation prompts, as generally used herein, may refer to a set of large language model prompts that are configured to assess the structured interrogative finding against the unstructured digital artifact to detect tokens that are not supported by the unstructured digital artifact. It shall be noted that, in some portions of the disclosure, the structured interrogative finding detected as satisfying the target readability threshold may be referred to as a “second additional structured interrogative finding” or the like.

In some embodiments, each respective content hallucination mitigation prompt of the plurality of content hallucination mitigation prompts may request that the large language model output structured data identifying a plurality of tokens, phrases, and/or sentences as supported or unsupported by the unstructured digital artifact. For instance, a respective content hallucination mitigation prompt may request classification of tokens as “supported” or “unsupported,” along with an indication of corresponding source content in the unstructured digital artifact that supports the token (if applicable).

In a non-limiting example, a first content hallucination mitigation prompt may assess whether factual statements included in the structured interrogative finding are supported by corresponding content in the unstructured digital artifact, and output structured labels identifying supported and unsupported statements. A second content hallucination mitigation prompt may assess whether numerical values (e.g., dates, quantities, and/or measurements) included in the structured interrogative finding correspond to values included in the unstructured digital artifact, and output structured labels identifying mismatched or unsupported tokens or values. It shall be noted that the plurality of content hallucination mitigation prompts described above are provided for illustrative purposes and are not intended to be limiting, and that additional, different, or fewer content hallucination mitigation prompts may be constructed to assess other aspects of support between the structured interrogative finding and the unstructured digital artifact without departing from the scope of the disclosure.

In some embodiments, S220 may execute the plurality of content hallucination mitigation prompts using a second large language model that is different from the large language model used to generate the structured interrogative finding. The second large language model, as generally used herein, may be configured to evaluate outputs generated by the large language model and to detect tokens that are not supported by the unstructured digital artifact. In such embodiments, the second large language model may be the same type of model as the large language model, a differently configured instance of the same model, and/or an entirely different model architecture.

For instance, in a non-limiting example, the second large language model may output structured data indicating that a first plurality of tokens in the structured interrogative finding (e.g., a factual statement) is not supported by corresponding content in the unstructured digital artifact, a second plurality of tokens in the structured interrogative finding (e.g., a numerical value) is not supported by the unstructured digital artifact, and a third plurality of tokens in the structured interrogative finding (e.g., a named entity) is supported by the unstructured digital artifact. In some embodiments, the structured output may include identifiers (e.g., token indices, positional markers, and/or the like) corresponding to the supported and unsupported tokens of the structured interrogative finding.

Based on the structured output, S220 may detect a plurality of tokens that are included in the structured interrogative finding, but that are not supported by the unstructured digital artifact. Specifically, in the above non-limiting example, the plurality of tokens detected as not being supported by the unstructured digital artifact may include the first plurality of tokens (e.g., corresponding to the factual statement) and the second plurality of tokens (e.g., corresponding to the numerical value), while the third plurality of tokens is detected as being supported by the unstructured digital artifact.

In response to detecting that the first plurality of tokens (e.g., corresponding to the factual statement) and the second plurality of tokens (e.g., corresponding to the numerical value) are not supported by the unstructured digital artifact, S220 may remove the first plurality of tokens and the second plurality of tokens from the structured interrogative finding (e.g., the second additional structured interrogative finding), while retaining the third plurality of tokens that are supported by the unstructured digital artifact, such that a modified structured interrogative finding includes only tokens supported by the unstructured digital artifact.

S220, in some embodiments, may use the modified structured interrogative finding to generate, by the second large language model, an additional structured interrogative finding that restores grammatical correctness after removal of the plurality of tokens that are not supported by the unstructured digital artifact. In some portions of the disclosure, the additional structured interrogative finding may be referred to as a “third additional structured interrogative finding” or the like. In such embodiments, the additional structured interrogative finding may restore sentence structure, grammatical coherence, and/or readability while preserving content supported by the unstructured digital artifact.

Lastly, in some embodiments, S220 may set the additional structured interrogative finding as the respective structured interrogative finding corresponding to the first distinct interrogative included in the first respective interrogative prompt. It shall be noted that, in some embodiments, S220 may validate and set additional structured interrogative findings corresponding to other distinct interrogatives included in the plurality of interrogative prompts in a manner analogous to that described above with respect to the first distinct interrogative.

### Generating Lexical Complexity Control Prompts

S220 may additionally, or alternatively, generate a plurality of lexical complexity control prompts (sometimes referred to as “section translation prompts”). A respective lexical complexity control prompt, as generally used herein, may refer to a large language model prompt configured to convert or translate a respective unstructured data fragment to a lexical complexity-controlled structured data fragment.

In some embodiments, each respective lexical complexity control prompt of the plurality of lexical complexity control prompts may comprise a plurality of lexical transformation control instructions. The plurality of lexical transformation control instructions may define or specify criteria or parameters for a large language model to follow when converting (translating) a respective unstructured data fragment to a lexical complexity-controlled structured data fragment. For instance, in a non-limiting example, the plurality of lexical transformation control instructions may include a tone instruction, a sentence length instruction, a word choice instruction, a format instruction, a reading level instruction, a translation instruction and/or the like.

The tone instruction may specify a desired tone for the lexical complexity-controlled structured data fragment (e.g., simplified, formal, informal, or technical) to control how the lexical complexity-controlled structured data fragment is expressed. The sentence length instruction may specify a maximum or target sentence length of the lexical complexity-controlled structured data fragment to control complexity and readability of sentences included in the lexical complexity-controlled structured data fragment. The word choice instruction may specify substitution of complex tokens in the lexical complexity-controlled structured data fragment with simpler tokens or preferred terminology to reduce lexical complexity while preserving meaning of the lexical complexity-controlled structured data fragment.

The translation instruction may specify a target language for the lexical complexity-controlled structured data fragment. For instance, in a non-limiting example, the translation instruction may instruct the large language model to convert the respective unstructured data fragment from a first language (e.g., English) into a second language (e.g., Spanish, French, Mandarin, Arabic, Hindi, Portuguese, and/or the like) while preserving semantic meaning, contextual intent, readability characteristics, and/or lexical complexity constraints associated with the respective unstructured data fragment.

Moreover, the format instruction may specify a desired structural format of the lexical complexity-controlled structured data fragment (e.g., shorter paragraphs, bullet points, or standardized layouts) to improve clarity and organization of the lexical complexity-controlled structured data fragment. The reading level instruction may specify a target readability level of the lexical complexity-controlled structured data fragment (e.g., a grade-level threshold) to ensure the lexical complexity-controlled structured data fragment satisfies one or more readability requirements.

Additionally, in some embodiments, each respective lexical complexity control prompt of the plurality of lexical complexity control prompts may comprise a distinct unstructured data fragment included in the corpus of unstructured data fragments (extracted by S210). For instance, in a non-limiting example, the plurality of lexical complexity control prompt may include a first lexical complexity control prompt, a second lexical complexity control prompt and so on up to an Nth lexical complexity control prompt (e.g., a 100^{th} lexical complexity control prompt, a 10,000^{th} lexical complexity control prompt, a 100,000^{th} lexical complexity control prompt, a 1,000,000,000,000^{th} lexical complexity control prompt and/or the like).

The first lexical complexity control prompt may include the plurality of the plurality of lexical transformation control instructions and a first unstructured data fragment included in the corpus of unstructured data fragments. Likewise, the second lexical complexity control prompt may include the plurality of lexical transformation control instructions and a second unstructured data fragment included in the corpus of unstructured data fragments, and so on, for a remainder of the plurality of lexical complexity control prompts (e.g., up to the Nth lexical complexity control prompt comprising the plurality of lexical transformation control instructions and an Nth unstructured data fragment included in the corpus of unstructured data fragments).

### Executing the Lexical Complexity Control Prompts

After generating the plurality of lexical complexity control prompts, S220 may execute the plurality of lexical complexity control prompts. S220 may input the plurality of lexical complexity control prompts into a large language model. In response to inputting the plurality of lexical complexity control prompts into the large language model, the large language model may generate a respective lexical complexity-controlled structured data fragment for each distinct unstructured data fragment included in the plurality of lexical complexity control prompts.

In some embodiments, a respective lexical complexity-controlled structured data fragment may have a lower lexical complexity than an unstructured data fragment from which the respective lexical complexity-controlled structured data fragment is generated. For instance, in a non-limiting example, the large language model may generate a respective lexical complexity-controlled structured data fragment for a first unstructured data fragment included in the corpus of unstructured data fragments, a respective lexical complexity-controlled structured data fragment for a second unstructured data fragment included in the corpus of unstructured data fragments, and so on up to a respective lexical complexity-controlled structured data fragment generated for an Nth unstructured data fragmented included in the corpus of unstructured data fragments (e.g., a 100^{th} unstructured data fragmented, a 10,000^{th} unstructured data fragmented, a 100,000^{th} unstructured data fragmented, a 1,000,000,000,000^{th} unstructured data fragmented and/or the like).

The large language model may generate the respective lexical complexity-controlled structured data fragment for the first unstructured data fragment by applying the plurality of lexical transformation control instructions to the first unstructured data fragment. Applying the plurality of lexical transformation control instructions may include converting or translating textual content of the first unstructured data fragment (e.g., tokens, words, sentences, paragraphs, etc.) to second textual content in the respective lexical complexity-controlled structured data fragment. The second textual content of the respective lexical complexity-controlled structured data fragment may include tokens, words, sentences, paragraphs, and/or the like that are modified relative to the textual content of the first unstructured data fragment to satisfy the sentence length instruction, the tone instruction, the word choice instruction, the format instruction, the and/or the reading level instruction.

In a non-limiting example, the textual content of the first unstructured data fragment may include tokens, words, sentences, paragraphs, and/or the like having a first lexical complexity level. In such embodiments, the second textual content of the respective lexical complexity-controlled structured data fragment may include tokens, words, sentences, paragraphs, and/or the like having a second lexical complexity level that is lower than the first lexical complexity level of the textual content of the first unstructured data fragment. For instance, in a non-limiting example, the second textual content may exhibit an improvement in readability level (e.g., from a postgraduate or technical reading level of the textual content of the first unstructured data fragment to a primary school reading level such as 5th grade for the second textual content).

Additionally, or alternatively, the second textual content may exhibit a reduction in sentence length (e.g., from an average of 30-40 words per sentence in the textual content of the first unstructured data fragment to 10-15 words per sentence in the second textual content), a simplification of word choice (e.g., substitution of multi-syllabic or domain-specific tokens included in the textual content of the first unstructured data fragment with more single-syllable or domain-agnostic tokens in the second textual content), and/or a modification of formatting (e.g., conversion of long paragraphs in the textual content of the first unstructured data fragment into shorter paragraphs or bullet points in the second textual content of the respective lexical complexity-controlled structured data fragment).

It shall be noted that the respective lexical complexity-controlled structured data fragment generated for the second unstructured data fragment, and so on up to the respective lexical complexity-controlled structured data fragment generated for the Nth unstructured data fragment, may be generated in a manner analogous to that described above with respect to the first unstructured data fragment, including applying the plurality of lexical transformation control instructions to convert or translate textual content of each respective unstructured data fragment to corresponding textual content having reduced lexical complexity.

### Validating Lexical Complexity-Controlled Data Fragments

In some embodiments, after generating a respective lexical complexity-controlled structured data fragment for each distinct unstructured data fragment, S220 may validate each generated respective lexical complexity-controlled structured data fragment. As discussed above, S220 may generate a plurality of respective lexical complexity-controlled structured data fragments, including a first respective lexical complexity-controlled structured data fragment corresponding to a first unstructured data fragment, a second respective lexical complexity-controlled structured data fragment corresponding to a second unstructured data fragment, and so on up to an Nth respective lexical complexity-controlled structured data fragment corresponding to an Nth unstructured data fragment included in the corpus of unstructured data fragments.

Thus, in some embodiments, S220 may function to validate (e.g., in parallel) the first respective lexical complexity-controlled structured data fragment, the second respective lexical complexity-controlled structured data fragment, and so on up to the Nth respective lexical complexity-controlled structured data fragment. Validating the first respective lexical complexity-controlled structured data fragment may include computing one or more token overlap metrics between the first respective lexical complexity-controlled structured data fragment and the first unstructured data fragment (corresponding to the first respective lexical complexity-controlled structured data fragment, as discussed above).

The one or more token overlap metrics, as generally used herein, may refer to a quantitative measure of similarity between tokens included in the first respective lexical complexity-controlled structured data fragment and tokens included in the first unstructured data fragment. In a non-limiting example, the one or more token overlap metrics may include a first token overlap metric that measures a proportion of tokens in the lexical complexity-controlled structured data fragment that correspond to tokens in the first unstructured data fragment (e.g., based on matching tokens or sequences of tokens). In yet another non-limiting example, the one or more token overlap metrics may include a second token overlap metric that measures a degree to which sequences of tokens included in the first unstructured data fragment are preserved in the lexical complexity-controlled structured data fragment (e.g., based on overlapping token groupings, contiguous token sequences, and/or subsequences).

It shall be noted that the above described token overlap metrics are provided for illustrative purposes and are not intended to be limiting, and that additional, different, or fewer token overlap metrics may be used to quantify similarity between tokens included in the respective lexical complexity-controlled structured data fragment and tokens included in the corresponding unstructured data fragment without departing from the scope of the disclosure.

After computing the one or more token overlap metrics, S220 may assess the one or more token overlap metrics against a target overlap threshold. The target overlap threshold, sometimes referred to as pre-defined hallucination criteria, may refer to a minimum degree of token overlap required between tokens underlying the respective lexical complexity-controlled structured data fragment and tokens underlying the first unstructured data fragment to ensure that the respective lexical complexity-controlled structured data fragment sufficiently preserves content of the first unstructured data fragment. In a non-limiting example, the target overlap threshold may correspond to a token overlap ratio of at least 0.6, 0.7, 0.8, 0.9, or any other suitable proportion of overlapping tokens or token sequences between the respective lexical complexity-controlled structured data fragment and the first unstructured data fragment.

In some embodiments, S220 may detect, based on the one or more token overlap metrics, that tokens underlying the respective lexical complexity-controlled structured data fragment generated for the first unstructured data fragment and tokens underlying the first unstructured data fragment overlap by the threshold amount. In response to detecting that the tokens underlying the respective lexical complexity-controlled structured data fragment and the tokens underlying the first unstructured data fragment overlap by the threshold amount, S220 may validate the respective lexical complexity-controlled structured data fragment as sufficiently preserving content of the first unstructured data fragment.

Conversely, in some embodiments, S220 may detect, based on the one or more token overlap metrics, that tokens underlying the respective lexical complexity-controlled structured data fragment generated for the first unstructured data fragment and tokens underlying the first unstructured data fragment do not overlap by the threshold amount (e.g., the minimum degree of token overlap). In response to detecting that the tokens underlying the respective lexical complexity-controlled structured data fragment and the tokens underlying the first unstructured data fragment do not overlap by the threshold amount, S220 may iteratively regenerate, by the large language model, the respective lexical complexity-controlled structured data fragment using adjusted lexical transformation control instructions that iteratively increase token overlap until the tokens underlying the respective lexical complexity-controlled structured data fragment and the tokens underlying the first unstructured data fragment overlap by the threshold amount.

In some embodiments, adjusting the plurality of lexical transformation control instructions may include iteratively modifying one or more lexical transformation control instructions across successive regeneration iterations to increase token overlap between the respective lexical complexity-controlled structured data fragment and the first unstructured data fragment. For instance, in a non-limiting example, during a first iteration, S220 may apply a first set of lexical transformation control instructions including a token preservation constraint of 50%, a maximum sentence length of 12-15 words, and a target readability level (e.g., predefined readability criteria) corresponding to a primary school reading level. It shall be noted that a token preservation constraint, as generally used herein, may refer to a parameter that specifies a proportion or subset of tokens included in the first unstructured data fragment to be retained, preserved, or reused in the respective lexical complexity-controlled structured data fragment.

Based on computing the one or more token overlap metrics, S220 may detect that the resulting lexical complexity-controlled structured data fragment does not overlap with the first unstructured data fragment by the threshold amount. In response, during a second iteration, S220 may adjust the plurality of lexical transformation control instructions to increase token overlap, including increasing the token preservation constraint to 70%, increasing allowable sentence length to 18-22 words, and changing the readability constraint (e.g., from a 5th grade level to a 7th grade level). Based on recomputing the one or more token overlap metrics, S220 may again detect that the token overlap remains below the threshold amount.

In response, during a third iteration, S220 may further adjust the plurality of lexical transformation control instructions, including increasing the token preservation constraint to 85-90%, increasing allowable sentence length to 25-30 words, and preserving a greater number of original token sequences (e.g., maintaining contiguous sequences of at least 3-5 tokens from the first unstructured data fragment). S220 may continue iteratively adjusting the plurality of lexical transformation control instructions in this manner until the tokens underlying the respective lexical complexity-controlled structured data fragment and the tokens underlying the first unstructured data fragment overlap by the threshold amount.

In some embodiments, S220 may validate the respective lexical complexity-controlled structured data fragment based on a plurality of validation criteria, including the one or more token overlap metrics (corresponding to pre-defined hallucination criteria) and one or more readability metrics (corresponding to pre-defined readability criteria). The one or more readability metrics, as generally used herein, may refer to quantitative measures indicating a readability level of textual content included in the respective lexical complexity-controlled structured data fragment.

S220 may assess the one or more token overlap metrics against a target overlap threshold and may assess the one or more readability metrics against a target readability threshold. In some embodiments, S220 may detect that the respective lexical complexity-controlled structured data fragment satisfies the plurality of validation criteria in response to detecting that (i) tokens underlying the respective lexical complexity-controlled structured data fragment overlap with tokens underlying the corresponding unstructured data fragment by the threshold amount, and (ii) the respective lexical complexity-controlled structured data fragment satisfies the target readability threshold.

Conversely, in some embodiments, S220 may detect that the respective lexical complexity-controlled structured data fragment fails to satisfy the plurality of validation criteria in response to detecting that (i) the tokens underlying the respective lexical complexity-controlled structured data fragment do not overlap with tokens underlying the corresponding unstructured data fragment by the threshold amount, (ii) the respective lexical complexity-controlled structured data fragment does not satisfy the target readability threshold, or (iii) any combination thereof.

In some embodiments, S220 may iteratively regenerate the respective lexical complexity-controlled structured data fragment based on both the one or more token overlap metrics and the one or more readability metrics corresponding to pre-defined hallucination criteria and pre-defined readability criteria. For instance, in a non-limiting example, during a first iteration, S220 may generate a respective lexical complexity-controlled structured data fragment using a first set of lexical transformation control instructions including a token preservation constraint of 50%, a maximum sentence length of 10-15 words, and a target readability level corresponding to a pre-defined readability criteria (e.g., a primary school reading level such as 5th grade). Based on computing the one or more token overlap metrics and the one or more readability metrics, S220 may detect that the respective lexical complexity-controlled structured data fragment satisfies the pre-defined readability criteria but does not satisfy the pre-defined hallucination criteria (e.g., does not overlap with the first unstructured data fragment by the threshold amount).

In response, during a second iteration, S220 may adjust the plurality of lexical transformation control instructions to increase token overlap, including increasing the token preservation constraint to 70%, increasing allowable sentence length to 18-22 words, and preserving a greater number of original tokens. Based on recomputing the one or more token overlap metrics and the one or more readability metrics, S220 may detect that the respective lexical complexity-controlled structured data fragment satisfies the pre-defined hallucination criteria but does not satisfy the pre-defined readability criteria (e.g., corresponding to an increase from a 5th grade reading level to an 8th grade reading level).

In response, during a third iteration, S220 may adjust the plurality of lexical transformation control instructions to balance token overlap and readability, including maintaining a token preservation constraint within a target range (e.g., 75-85%), reducing allowable sentence length (e.g., from 22 words to 15-18 words per sentence), and selectively simplifying tokens that do not contribute significantly to token overlap. Based on recomputing the one or more token overlap metrics and the one or more readability metrics, S220 may detect that the respective lexical complexity-controlled structured data fragment satisfies both the pre-defined hallucination criteria and the pre-defined readability criteria.

S220 may continue iteratively regenerating and adjusting the plurality of lexical transformation control instructions in this manner until the respective lexical complexity-controlled structured data fragment satisfies both the pre-defined hallucination criteria and the pre-defined readability criteria. It shall be noted that remaining respective lexical complexity-controlled structured data fragments generated for the second unstructured data fragment, and so on up to the respective lexical complexity-controlled structured data fragment generated for the Nth unstructured data fragment, may be validated in a manner analogous to that described above with respect to the first unstructured data fragment.

### 2.3 Generating Interactive Video Objects

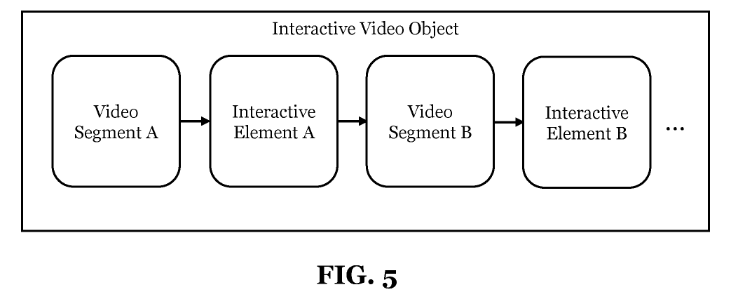

S230, which includes generating interactive video objects, may function to generate one or more interactive video objects based on the plurality of lexical complexity mitigation prompts (generated by S220). An interactive video object, as generally used herein and illustrated in FIG. 5, may refer to a digital media object that includes video content and one or more interactive elements configured to enable user interaction with the video content. The one or more interactive elements, in some embodiments, may be embedded within, overlaid on, or inserted between one or more video segments of the video content, as will be described in more detail herein.

In some embodiments, generating an interactive video object may include performing one or more operations of S220. Specifically, in some embodiments, S230 may perform the operations of S220 relating to generating one or more structured interrogative findings and/or one or more lexical complexity-controlled structured data fragments. In turn, S230 may use the one or more structured interrogative findings and/or the one or more lexical complexity-controlled structured data fragments to dynamically create/compose an interactive video composition prompt (sometimes referred to as “media composition prompts”). It shall be noted that S230 may create the interactive video composition in real-time (e.g., within one or more milliseconds or seconds) or near real-time (e.g., within a short processing interval such as one or more seconds or minutes.

### Video Scene Specification

In some embodiments, dynamically creating the interactive video composition prompt may include prompting a large language model to generate a video scene specification for the interactive video object. S230, in some embodiments, may request (e.g., prompt) the large language model to generate the video scene specification using one or more distinct interrogatives and/or the one or more structured interrogative findings generated for the one or more distinct interrogatives (as described in S220). In response to prompting the large language model, the large language model may use the one or more distinct interrogatives and/or the one or more distinct unstructured interrogative findings to generate the video scene specification for the interactive video object.

In some embodiments, the video scene specification may define a sequence for presenting each distinct interrogative in the interactive video object. The sequence, in some embodiments, may define an ordered progression for presenting a first distinct interrogative, a second distinct interrogative, and so on up to the Nth distinct interrogative (e.g., a 10^{th}, 100^{th}, 1000^{th}, 50,000^{th}, 100,000^{th}, 1,000,000,000^{th} interrogative). For instance, in a non-limiting example, the sequence may define that the first distinct interrogative is presented at a first playback position of the interactive video object, the second distinct interrogative is presented at a second playback position subsequent to the first playback position, and each additional distinct interrogative is presented at a corresponding subsequent playback position according to the ordered progression until the Nth distinct interrogative is presented at a final playback position of the interactive video object.

It shall be noted that the ordered progression is provided for illustrative purposes and is not intended to be limiting. In some embodiments, the sequence may define an ordering of the distinct interrogatives that does not strictly follow a first-to-Nth progression, such that one or more distinct interrogatives may be presented out of a strictly sequential order while still corresponding to respective playback positions within the interactive video object. For instance, in a non-limiting example, the sequence may define that the first distinct interrogative is presented at a first playback position, followed by a third distinct interrogative at a second playback position, followed by a second distinct interrogative at a third playback position, and so on.

Additionally, in some embodiments, the video scene specification may define one or more scene descriptions corresponding to the sequence of distinct interrogatives. The one or more scene descriptions may include, but should not be limited to, a starting scene description, one or more intermediate scene descriptions, and a final scene description. The starting scene description may define one or more starting visual animation descriptions for introducing a starting interrogative in the sequence (e.g., the first interrogative at the first playback position) and transitioning to the respective structured interrogative finding generated for the starting interrogative.

In some embodiments, the starting scene description may further define one or more visual explanation descriptions for visually presenting or explaining the respective structured interrogative finding (e.g., via graphical elements, highlighted text, diagrams, or animated illustrations corresponding to the respective structured interrogative finding). For instance, in a non-limiting example, the starting scene description may specify displaying an animated title card introducing the starting interrogative, followed by a visual transition (e.g., fade-in, slide-in, or zoom-in) to present the respective structured interrogative finding along with (i.e., using) one or more visual explanation elements.

In some embodiments, each respective intermediate scene description may define one or more intermediate visual animation descriptions for introducing a distinct additional interrogative (e.g., a second interrogative at a second playback position, a third interrogative at a third playback position, and so on) and transitioning to the respective structured interrogative finding generated for the distinct additional interrogative. Further, in some embodiments, each respective intermediate scene description may define one or more visual explanation descriptions for visually presenting or explaining the respective structured interrogative finding (e.g., via overlays, callouts, animations, or graphical augmentations aligned with the structured interrogative finding). For instance, in a non-limiting example, an intermediate scene description may specify presenting a prompt overlay introducing the distinct additional interrogative, followed by an animated transition (e.g., cut, dissolve, or motion graphic overlay) to present the corresponding structured interrogative finding along with or one or more visual explanation elements (i.e., video elements).

In some embodiments, the final scene description may define one or more final visual animation descriptions for presenting a last interrogative in the sequence (e.g., the Nth interrogative at a final playback position) and transitioning to the respective structured interrogative finding generated for the last interrogative. In some embodiments, the final scene description may further define one or more visual explanation descriptions for visually presenting or summarizing the respective structured interrogative finding (e.g., via a summary graphic, recap animation, or concluding visual representation). For instance, in a non-limiting example, the final scene description may specify presenting the last interrogative with a concluding animation (e.g., fade-out, summary overlay, or end card), followed by presentation of the respective structured interrogative finding along with or using one or more visual explanation elements and an optional closing transition.

In some embodiments, S230 may use the video scene specification to generate a plurality of video synthesis instructions. The plurality of video synthesis instructions may request the large language model to generate a plurality of video segments for the interactive video object. A respective video synthesis instruction, as generally used herein, may correspond to a respective scene description and request that a large language model generate a video segment in accordance with the respective scene description.

In some embodiments, generating a respective video synthesis instruction for a respective scene description may include deriving one or more parameter values for the respective video synthesis instruction from one or more visual animation descriptions, one or more transition descriptions, and/or one or more visual explanation descriptions included in the respective scene description. For instance, in a non-limiting example, if the respective scene description specifies introducing a starting interrogative using an animated title card with a fade-in transition, the large language model may generate a respective video synthesis instruction that includes (i) a visual composition parameter specifying placement and styling of the title card (e.g., centered position, font size, color, and entry animation), and (ii) a temporal transition parameter specifying a fade-in duration (e.g., 0.5-1.5 seconds), among other parameters described in system 100.

In another non-limiting example, if the respective scene description specifies presenting a structured interrogative finding using highlighted text and an animated diagram, the large language model may generate a respective video synthesis instruction that includes a semantic-to-visual mapping parameter mapping one or more tokens or phrases included in the structured interrogative finding to corresponding highlighted text elements and diagram components, optionally including one or more synchronization parameters aligning appearance of the highlighted text elements and the diagram components with corresponding playback times within the video segment.

It shall be noted that other video synthesis instructions corresponding to one or more additional scene descriptions may be similarly generated based on the respective scene descriptions, such that parameter values included in the respective video synthesis instructions are derived from the corresponding visual animation descriptions, transition descriptions, and/or visual explanation descriptions. It shall also be noted that the interactive video composition prompt may include the plurality of video synthesis instructions and/or the video scene specification.

### Post-Scene Interactive Assessment Descriptions

In some embodiments, dynamically creating the interactive video composition prompt may further include prompting a large language model to generate a plurality of post-scene interactive assessment descriptions for the interactive video object. S230, in some embodiments, may request (e.g., prompt) the large language model to generate the plurality of post-scene interactive assessment descriptions using the one or more lexical complexity-controlled structured data fragments generated for the one or more distinct unstructured data fragments (as described in S220). In response to prompting the large language model, the large language model may use the one or more lexical complexity-controlled structured data fragments to generate the plurality of post-scene interactive assessment descriptions.

In some embodiments, a respective post-scene interactive assessment description, as generally used herein, may correspond to a respective scene description. For instance, the large language model may generate a first respective post-scene interactive assessment description for a starting scene description, one or more intermediate post-scene interactive assessment descriptions for one or more intermediate scene descriptions, respectively, and a final post-scene interactive assessment description for a final scene description.

In some embodiments, the first respective post-scene interactive assessment description may define a configuration of user interface elements (sometimes referred to herein as a “first configuration”). The first configuration of user interface elements may include one or more user interface element descriptions to present the starting interrogative and to receive user input corresponding to the starting interrogative. A user interface element description for presenting the starting interrogative may include one or more textual tokens describing how a text display user interface element is to present the starting interrogative as a question. For instance, in a non-limiting example, the one or more textual tokens may specify displaying the starting interrogative as “What is the main purpose of X?” along with an associated progress indicator such as “Question 1 of N.”

Additionally, one or more user interface element descriptions may include textual tokens describing how one or more selectable response user interface elements are to be presented to receive user input. For instance, in a non-limiting example, the one or more user interface element descriptions may describe displaying a plurality of selectable response options (e.g., buttons) including a first option, a second option, a third option, and so on up to an Nth option, where each selectable response option corresponds to a candidate answer to the starting interrogative.

It shall be noted that, in some embodiments, at least one of the plurality of selectable response options corresponds to a correct answer derived from the structured interrogative finding associated with the starting interrogative, and one or more additional selectable response options correspond to alternative (e.g., incorrect) answers generated based on variations of the structured interrogative finding.

In some embodiments, one or more user interface element descriptions may further include textual tokens describing how one or more response feedback user interface elements are to be presented based on the received user input. For instance, in a non-limiting example, the one or more user interface element descriptions may describe displaying a first visual indicator (e.g., a checkmark or first highlighting characteristic) associated with a selected response corresponding to a correct answer, and displaying a second visual indicator (e.g., a cross indicator or second highlighting characteristic) associated with a selected response corresponding to an incorrect answer.

In some embodiments, one or more user interface element descriptions may further include textual tokens describing how one or more continuation user interface elements are to be presented to enable progression following receipt of the user input. For instance, in a non-limiting example, the one or more user interface element descriptions may describe displaying a continuation control element (e.g., a button) including text such as “Continue” or “Next Question,” where selection of the continuation control element advances to a subsequent interrogative or corresponding scene.

It shall be noted that generating a respective intermediate post-scene interactive assessment description for each additional interrogative in the sequence may be performed in a manner analogous to generating the first respective post-scene interactive assessment description, such that each respective intermediate post-scene interactive assessment description defines a second configuration of user interface elements for presenting a distinct additional interrogative and receiving user input for answering the distinct additional interrogative.

Likewise, it shall also be noted that generating the final post-scene interactive assessment description may be performed in a manner analogous to generating the first respective post-scene interactive assessment description, such that the final post-scene interactive assessment description defines a third configuration of user interface elements for presenting a last interrogative in the sequence and receiving user input for answering the last interrogative.

In some embodiments, S230 may use the plurality of post-scene interactive assessment descriptions to generate a plurality of video-integrated user interface element creation instructions. The plurality of video-integrated user interface element creation instructions may request the large language model to generate a plurality of interactive user interface control objects for the interactive video object. A respective video-integrated user interface element creation instruction, as generally used herein, may correspond to a respective post-scene interactive assessment description and request that the large language model generate one or more interactive user interface control objects in accordance with the respective post-scene interactive assessment description.

In some embodiments, generating a respective video-integrated user interface element creation instruction for a respective post-scene interactive assessment description may include deriving one or more parameter values for the respective instruction from one or more user interface element descriptions included in the respective post-scene interactive assessment description. For instance, in a non-limiting example, if the respective post-scene interactive assessment description specifies presenting an interrogative using a text display user interface element, the large language model may generate a respective instruction that includes (i) a text presentation parameter specifying the interrogative as textual display content, formatting attributes (e.g., font size, emphasis) of the textual display content, and/or display characteristics of the textual display content, and (ii) a contextual parameter specifying one or more indicators such as question numbering or progress indicators associated with the interrogative (among other parameters described in system 100).

In another non-limiting example, if the respective post-scene interactive assessment description specifies presenting one or more selectable response user interface elements, the large language model may generate a respective instruction that includes one or more response configuration parameters specifying a number of selectable response elements to display the selectable response user interface elements, candidate response content (e.g., answers) to include in the selectable response user interface elements, selection behavior of the selectable response user interface elements, and/or input handling characteristics of the selectable response user interface elements (e.g., one or more parameters identifying a correct response derived from a structured interrogative finding and one or more alternative responses).

It shall be noted that other video-integrated user interface element creation instructions corresponding to one or more additional post-scene interactive assessment descriptions may be similarly generated based on the respective post-scene interactive assessment descriptions, such that parameter values included in the respective instructions are derived from the corresponding user interface element descriptions. It shall also be noted that the interactive video composition prompt may include the plurality of post-scene interactive assessment descriptions and/or the plurality of video-integrated user interface element creation instructions.

### Generating the Interactive Video Object

After dynamically creating the interactive video composition prompt, S230 may input the interactive video composition prompt into a large language model. Non-limiting examples of the large language model implemented by S220 may include, but should not be limited to, GPT, GPT-2, GPT-3, GPT-4, GPT-4.5, GPT-5 (and all subsequent iterations), bidirectional encoder representation form transformers (BERT), LLaMA, Claude 1, Claude 2, Claude 3, Claude 3.5, Claude 4, a transformer-based language model, a multimodal language model, a text-to-video generation model, a text-to-video diffusion model, and/or or any other suitable large language model.

In response to inputting the interactive video composition prompt into the large language model, the large language model may generate the interactive video object. The interactive video object may comprise a plurality of video segments. The plurality of video segments may include, but should not be limited to, a starting video segment, one or more intermediate video segments, and a final video segment. A total number of video segments included in the plurality of video segments may include one or more video segments, two or more video segments, three or more video segments, ten or more video segments, one hundred or more video segments, one thousand or more video segments, one hundred thousand or more video segments, one million or more video segments, and/or any other suitable number of video segments.

In some embodiments, the large language model may generate the starting video segment based on (e.g., in accordance with) the starting scene description (described above) and/or one or more respective video synthesis instructions derived from the starting scene description (also described above). A starting video segment generated in accordance with the starting scene description and/or the respective video synthesis instruction(s) may comprise visual characteristics, temporal characteristics, and/or explanatory video elements of the starting video segment that directly reflect, match, correspond, or otherwise implement the one or more visual animation descriptions, transition descriptions, and/or visual explanation descriptions defined in the starting scene description (as instantiated by one or more parameter values included in the respective video synthesis instructions and/or system 100).

For instance, in a non-limiting example, the starting video segment may include a title card video sequence presenting the starting interrogative as a text element positioned and styled according to one or more visual composition parameters of the starting scene description or the respective video synthesis instruction(s), an animation video sequence introducing the text element into view based on an entry animation defined by the starting scene description or the respective video synthesis instruction(s), and a transition sequence (e.g., a fade-in over a defined duration interval) introducing a visual explanation video scene presenting the respective structured interrogative finding (e.g., according to the starting scene description or the respective video synthesis instruction(s)).

In some embodiments, the large language model may generate the one or more intermediate video segments based on the one or more intermediate scene descriptions and/or one or more respective video synthesis instructions derived from the one or more intermediate scene descriptions in a manner analogous to generating the starting video segment. Likewise, the large language model may generate the final video segment based on the final scene description and/or one or more respective video synthesis instructions derived from the final scene description in a manner analogous to generating the starting video segment.

In some embodiments, the plurality of video segments may be combined and/or inserted to form the interactive video object in accordance with the sequence defined by the video scene specification. For instance, in a non-limiting example, if the sequence defines that a first interrogative is presented at a first playback position, a third interrogative is presented at a second playback position, and a second interrogative is presented at a third playback position, the large language model may insert the corresponding video segments such that a first video segment corresponding to the first interrogative is inserted at the first playback position, a third video segment corresponding to the third interrogative is inserted at the second playback position, and a second video segment corresponding to the second interrogative is inserted at the third playback position.

Additionally, in some embodiments, the interactive video object generated by the large language model may include a plurality of interactive user interface control objects. The large language, in some embodiments, may generate the plurality of interactive user interface control objects based on the plurality of post-scene interactive assessment descriptions. For instance, in a non-limiting example, the large language model may generate a first subset of interactive user interface control objects based on a first post-scene interactive assessment description, one or more second subsets of interactive user interface control objects based on one or more intermediate post-scene interactive assessment descriptions, respectively, and a third subset of interactive user interface control objects based on a final post-scene interactive assessment description.

In some embodiments, the large language model may generate the first subset of interactive user interface control objects based on the first configuration of user interface elements defined by the first post-scene interactive assessment description and/or one or more respective video-integrated user interface element creation instructions derived from the first post-scene interactive assessment description. For instance, the first subset of interactive user interface control objects may be formed by generating one or more user interface elements that implement the first configuration of user interface elements, including (i) a text display user interface element for presenting the starting interrogative as a question, (ii) one or more selectable response user interface elements corresponding to candidate answers, (iii) one or more response feedback user interface elements configured to present feedback based on evaluation of the user input, and (iv) one or more continuation user interface elements configured to enable progression following receipt of the user input.

In some embodiments, the large language model may generate the one or more second subsets of interactive user interface control objects based on the one or more intermediate post-scene interactive assessment descriptions in a manner analogous to generating the first subset of interactive user interface control objects. Likewise, the large language model may generate the third subset of interactive user interface control objects based on the final post-scene interactive assessment description in a manner analogous to generating the first subset of interactive user interface control objects.

In some embodiments, the plurality of interactive user interface control objects may be interleaved with the plurality of video segments to form the interactive video object. Interleaving the plurality of interactive user interface control objects, as generally used herein, may refer to arranging the plurality of interactive user interface control objects and the plurality of video segments in an alternating sequence such that a video segment is followed by one or more interactive user interface control objects, which is then followed by a subsequent video segment.

For instance, in a non-limiting example, interleaving the plurality of interactive user interface control objects may include inserting a first subset of interactive user interface control objects at a playback position immediately following completion of a starting video segment, inserting each respective subset of one or more second subsets of interactive user interface control objects at corresponding playback positions immediately following completion of corresponding intermediate video segments, and inserting a third subset of interactive user interface control objects at a playback position immediately following completion of a final video segment, such that the interactive video object alternates between presentation of video segments and presentation of interactive user interface control objects. It shall be noted that, in some embodiments, S230 may insert the interactive video object into the explainability artifact described in S240 and execute (e.g., play) the interactive video object in response to user input.

Additionally, or alternatively, in some embodiments, the large language model may generate one or more video segments using one or more reusable multimedia assets retrieved from an asset library accessible to system 100 and/or the large language model. The asset library may include, but should not be limited to, pre-generated images, explanatory graphics, scene descriptions, animation loops, narration templates, visual overlays, transition sequences, character animations, background environments, semantic illustration assets, icon libraries, motion templates, audio assets, and/or other reusable multimedia assets. In some embodiments, the large language model may selectively retrieve one or more assets from the asset library based on semantic meaning associated with the structured interrogative findings, one or more scene descriptions, one or more lexical complexity levels, one or more contextual relationships, and/or one or more video synthesis instructions associated with the interactive video object.

For instance, in a non-limiting example, responsive to determining that a structured interrogative finding corresponds to a first semantic concept, the large language model may retrieve one or more pre-generated illustration assets, explanatory animation loops, narration templates, transition templates, and/or scene descriptions associated with the first semantic concept from the asset library and incorporate the retrieved assets into one or more corresponding video segments. Likewise, responsive to determining that another structured interrogative finding corresponds to a second semantic concept, the large language model may retrieve one or more semantically corresponding visual explanation assets, graphical overlays, narration templates, animation loops, explanatory scene descriptions, and/or multimedia composition templates associated with the second semantic concept from the asset library.

In some embodiments, the large language model may modify, customize, augment, and/or combine one or more retrieved assets from the asset library according to one or more scene descriptions, video synthesis instructions, lexical complexity constraints, contextual relationships, user preferences, and/or modality requirements associated with the interactive video object. For example, the large language model may modify one or more text overlays associated with a retrieved animation loop, regenerate narration associated with a retrieved scene description at a different lexical complexity level, alter visual emphasis characteristics associated with one or more retrieved explanatory graphics, combine multiple retrieved assets to generate a composite video segment corresponding to a structured interrogative finding, and/or generate one or more new video segments based on the retrieved assets.

In some embodiments, retrieval and reuse of assets from the asset library may reduce computational overhead associated with generating the interactive video object by reducing an amount of multimedia content required to be generated from scratch during execution of the large language model. Additionally, reuse of pre-generated assets may improve semantic consistency, visual consistency, modality consistency, explainability consistency, and/or generation latency associated with the plurality of video segments by enabling the large language model to repeatedly utilize validated explanatory assets corresponding to one or more semantic concepts.

### Adaptive Decisioning

In some embodiments, the interactive video object may display a respective subset of interactive user interface control objects based on adaptive decisioning performed by the large language model. For instance, following presentation of a respective video segment associated with a current structured interrogative finding and receipt of user input via one or more interactive user interface control objects, the large language model may process the user input by determining whether a selected response corresponds to a correct answer derived from the current structured interrogative finding and/or, for free-form user input, by comparing the user input to the current structured interrogative finding. Such processing may include determining, by the large language model, semantic similarity, identifying omitted concepts relative to the current structured interrogative finding, detecting one or more misunderstandings, and/or extracting one or more concepts expressed in the user input.

In some embodiments, based on the processing of the user input relative to the current structured interrogative finding, the large language model may dynamically generate a subsequent subset of interactive user interface control objects for presentation at a subsequent playback position. It shall be noted that, in some embodiments, the large language model may dynamically generate a subsequent subset of interactive user interface control objects within a threshold duration satisfying a real-time interaction constraint, such that the subsequent subset is presented without perceptible delay following receipt of the user input. For instance, the threshold duration may include durations under one millisecond, under ten milliseconds, under one hundred milliseconds, or any other duration suitable to maintain a continuous interactive experience.

In some embodiments, if user input selects a correct answer or response derived from the current structured interrogative finding and/or if the user input includes concepts corresponding to the current structured interrogative finding, the large language model may generate a first subsequent subset of interactive user interface control objects configured to advance to a next (subsequent) structured interrogative finding and/or a corresponding video segment. Conversely, if the user selects an incorrect response or answer that does not correspond to a correct answer and/or if the user input omits one or more concepts associated with the current structured interrogative finding or includes one or more detected misunderstandings, the large language model may generate a second subsequent subset of interactive user interface control objects configured to present additional interrogative-response content (e.g., question-answer data) associated with the current structured interrogative finding.

In some embodiments, the large language model may determine whether to generate the first subsequent subset of interactive user interface control objects or the second subsequent subset of interactive user interface control objects based not only on correctness of a selected response (e.g., correspondence of user input to the current structured interrogative finding), but also based on one or more additional user interaction parameters. In a first non-limiting example, the large language model may determine a response latency associated with the user input (e.g., how long it took the user to answer the question and provide an answer). If the response latency exceeds a threshold duration, the large language model may generate the second subsequent subset of interactive user interface control objects configured to present additional interrogative-response content associated with the current structured interrogative finding, including in cases where the selected response corresponds to a correct answer. Conversely, if the response latency is below the threshold duration, the large language model may generate the first subsequent subset of interactive user interface control objects configured to advance to the next structured interrogative finding, including in cases where the selected response corresponds to a correct answer.

Additionally, or alternatively, in some embodiments, the large language model may determine an interaction speed associated with the user input (e.g., a rate of progression of the user between playback positions). If the interaction speed exceeds a threshold, the large language model may generate a subsequent (new) sequence for presenting structured interrogative findings that modifies presentation of one or more interactive user interface control objects (i.e., question-answer content) associated with a current structured interrogative finding by selecting one or more alternative presentation modalities for the one or more interactive user interface control objects corresponding to the current structured interrogative finding.

For instance, the large language model may replace a first type of interactive user interface control object associated with the current structured interrogative finding with a second type of interactive user interface control object associated with a different modality (e.g., when the interaction speed exceeds the threshold). By way of example, a text-based question-and-answer user interface including selectable interactive user interface control objects may be replaced with an audio-based interactive user interface control object prompting a verbal response, an animated visual explanation user interface control object accompanied by a simplified follow-up interrogative, or a guided step-by-step interactive user interface control object configured to reinforce one or more concepts associated with the current structured interrogative finding. In some embodiments, the large language model may additionally generate one or more video segments corresponding to the alternative modality and insert the generated video segments at one or more subsequent playback positions.

Conversely, if the interaction speed does not exceed the threshold, the large language model may generate a subsequent sequence or maintain a current sequence of structured interrogative findings that retains the presentation modality of the current interactive user interface control objects (and/or video segments) and advances to a next structured interrogative finding without replacing the interactive user interface control objects or introducing additional modality-specific content for the current or subsequent structured interrogative findings.

In some embodiments, if the interaction speed exceeds the threshold and the user input corresponds to the current structured interrogative finding, the large language model may detect sufficient understanding of one or more concepts associated with the current structured interrogative finding and may generate a subsequent sequence that omits one or more interactive user interface control objects that would otherwise be presented. Conversely, if the interaction speed exceeds the threshold but the user input does not correspond to the current structured interrogative finding, the large language model may generate a subsequent sequence that includes one or more additional interactive user interface control objects configured to present additional interrogative-response content associated with the current structured interrogative finding.

In some embodiments, the large language model may process both selected responses and free-form user input corresponding to the current structured interrogative finding, such that even where a selected response corresponds to a correct answer, the large language model may generate additional interrogatives and/or video segments if the free-form user input omits one or more concepts associated with the current structured interrogative finding. Conversely, if both the selected response corresponds to a correct answer and the free-form user input includes concepts corresponding to the current structured interrogative finding, the large language model may generate a subsequent sequence that advances to a next structured interrogative finding without presenting additional content associated with the current structured interrogative finding.

In some embodiments, the large language model may further determine one or more terminal or escalation actions based on the processing of user input relative to a current structured interrogative finding. For instance, if the user input corresponds to the current structured interrogative finding and satisfies one or more thresholds (described above), the large language model may generate one or more continuation user interface control objects configured to permit progression to a completion state, including enabling progression to an electronic signature interface or other consent completion mechanism (e.g., for collecting an electronic signature or consent of a user). Conversely, if the user input does not correspond to the current structured interrogative finding and/or includes one or more detected misunderstandings associated with a higher-importance concept, the large language model may generate one or more additional subsets of interactive user interface control objects configured to prevent progression to the completion state and to present additional interrogative-response content associated with the current structured interrogative finding.

In some embodiments, if the processing of the user input indicates repeated non-correspondence across a threshold amount of structured interrogative findings, conflicting responses, or interaction patterns indicative of uncertainty, the large language model may generate one or more interactive user interface control objects configured to escalate the interaction to a human reviewer (e.g., a review queue). For instance, the large language model may generate a user interface control object configured to initiate a live communication session, schedule a follow-up interaction, or transmit one or more interaction logs and corresponding structured interrogative findings to the human reviewer. Conversely, if the user input corresponds to the structured interrogative findings for at least a threshold amount of structured interrogative findings and does not exhibit patterns indicative of misunderstanding or uncertainty, the large language model may generate one or more continuation user interface control objects configured to permit progression without escalation to human review.

In some embodiments, the large language model may generate a confidence score associated with user comprehension/understanding of a current structured interrogative finding based on the processing of user input. The confidence score may be determined based on one or more factors including, but not limited to, correspondence between the user input and the current structured interrogative finding, semantic similarity, identification of omitted concepts, detection of misunderstandings, response latency, interaction speed, and/or prior user input associated with one or more previously presented structured interrogative findings.

In some embodiments, the large language model may compare the confidence score to one or more thresholds to determine a subsequent action. For instance, if the confidence score exceeds a first threshold, the large language model may generate one or more continuation user interface control objects configured to advance to a next structured interrogative finding and/or permit progression toward a completion state. Conversely, if the confidence score falls below the first threshold but exceeds a second threshold, the large language model may generate one or more interactive user interface control objects configured to present additional interrogative-response content associated with the current structured interrogative finding. Further, if the confidence score falls below the second threshold, the large language model may generate one or more interactive user interface control objects configured to present additional explanatory content using one or more alternative modalities and/or to cause replay or skip of one or more portions of a corresponding video segment.

In some embodiments, if the confidence score falls below a third threshold and/or if one or more patterns of user input indicate uncertainty, inconsistency, or repeated non-correspondence across a threshold number of structured interrogative findings, the large language model may generate one or more interactive user interface control objects configured to escalate the interaction to a human reviewer (e.g., review queue). Conversely, if the confidence score exceeds one or more escalation thresholds, the large language model may generate one or more continuation user interface control objects configured to permit progression without escalation.

In some embodiments, the confidence score may be dynamically updated based on successive user inputs and may be maintained across multiple structured interrogative findings to determine a user-specific comprehension profile. The large language model may utilize the comprehension profile to dynamically generate subsequent sequences of interactive user interface control objects and/or video segments, including determining whether to omit one or more interactive user interface control objects, introduce additional interactive user interface control objects, modify presentation modality, or advance to a next structured interrogative finding.

### Video Generation Policy Controls

In some embodiments, the large language model may validate the interactive video object using one or more video generation policy controls. The one or more video generation policy controls, as generally used herein, may refer to a set of constraints configured to govern content included in the plurality of video segments and the plurality of interactive user interface control objects. Non-limiting examples of the video generation policy controls may include, but should not be limited to, a content neutrality policy control, a concept coverage policy control, a semantic consistency policy control, a visual compliance policy control, an interactive neutrality policy control, a dynamic sequencing compliancy policy control, and/or the like as discussed further below.

The content neutrality policy control may be configured to govern generation of interrogative-response content such that the interrogative-response content is informational in nature and avoids inclusion of persuasive, coercive, or outcome-influencing narration language or visual elements. In some embodiments, the content neutrality policy control may ensure that generated video segments and interactive user interface control objects present data in a balanced (e.g., a fair and unbiased) manner without encouraging a user toward a particular decision or response. For example, the content neutrality policy control may constrain narration or textual content to avoid phrases such as “this treatment will help you” or “you should participate,” may require inclusion of neutral phrasing of textual content such as “this study is being conducted to evaluate…,” and/or prevent use of visual elements in video segments that depict guaranteed positive outcomes or emotionally persuasive imagery.

The concept coverage policy control may be configured to govern generation of interrogative-response content such that the content includes one or more required concepts derived from the structured interrogative findings. In some embodiments, the concept coverage policy control may ensure that generated video segments and interactive user interface control objects present information corresponding to target concepts associated with the structured interrogative findings and/or the underlying source content. For example, the concept coverage policy control may require inclusion of content describing one or more risks associated with a subject matter, presentation of information relating to voluntariness or optional participation, inclusion of information describing uncertainty of outcomes or lack of guaranteed benefit, and/or presentation of alternative options or courses of action corresponding to the structured interrogative findings.

The semantic consistency policy control may be configured to govern generation of interrogative-response content such that the content corresponds to the underlying source content and the structured interrogative findings derived therefrom. In some embodiments, the semantic consistency policy control may ensure that generated video segments and interactive user interface control objects present information that is accurate, non-contradictory, and aligned with concepts extracted from the source content. For example, the semantic consistency policy control may constrain textual or narrative content to avoid introduction of concepts not present in the underlying source content, require that explanations of a concept remain consistent across multiple video segments and interactive user interface control objects, ensure that selectable response options correspond to candidate answers derived from the structured interrogative findings, and/or prevent generation of statements that conflict with previously presented interrogative-response content.

The visual compliance policy control may be configured to govern visual elements included in the plurality of video segments. In some embodiments, the visual compliance policy control may ensure that imagery, animations, and other visual components correspond to the interrogative-response content and comply with one or more constraints relating to representation of concepts included in the structured interrogative findings. For example, the visual compliance policy control may restrict use of imagery or videos implying guaranteed outcomes or treatment efficacy, require use of neutral explanatory graphics corresponding to presented concepts, constrain visual elements to avoid emotionally persuasive imagery, and/or ensure that visual depictions remain consistent with the underlying source content.

The interaction neutrality policy control may be configured to govern presentation of interrogatives, selectable responses, and feedback via the plurality of interactive user interface control objects. In some embodiments, the interaction neutrality policy control may ensure that user interface elements are presented in a neutral manner and do not include leading prompts, biased response options, or feedback that directs user input toward a particular outcome (answer or response options). For example, the interaction neutrality policy control may constrain interrogatives to avoid suggestive phrasing, require selectable response options to be presented in a balanced and non-leading format, prevent feedback that implies correctness is associated with a preferred decision, and/or ensure that user interface elements do not influence user responses beyond presentation of the interrogative-response content.

The dynamic sequencing compliance policy control may be configured to govern dynamically generated sequences of video segments and interactive user interface control objects. In some embodiments, the dynamic sequencing compliance policy control may ensure that sequences generated based on user input remain consistent with one or more constraints associated with the structured interrogative findings and the underlying source content. For example, the dynamic sequencing compliance policy control may constrain generation of subsequent sequences to include only interrogative-response content derived from the structured interrogative findings, prevent introduction of non-compliant content during adaptive sequencing, ensure that omitted or inserted video segments and interactive user interface control objects remain consistent with policy constraints, and/or maintain compliance of presentation across dynamically determined playback positions.

In some embodiments, validation of the interactive video object using the one or more video generation policy controls may include frame-level classification of visual content by the large language model. For instance, the large language model may process one or more frames or sequences of frames corresponding to the plurality of video segments to extract visual features and classify visual elements associated with the one or more frames into one or more predefined labels. In some embodiments, the classified visual elements may be evaluated relative to one or more of the video generation policy controls, including the visual compliance policy control and/or the content neutrality policy control.

For example, the large language model may assign one or more labels to visual elements within a frame based on characteristics of the visual elements. Such visual elements may include, but are not limited to, imagery depicting a progression of events (e.g., a sequence of frames showing a change from an initial state to a subsequent state), facial expressions (e.g., smiling, frowning, or neutral expressions of depicted individuals), color gradients (e.g., transitions from darker to brighter colors), animation effects (e.g., flashing, pulsing, or motion-based emphasis), scene composition (e.g., relative positioning or prominence of objects within a frame), and/or graphical overlays (e.g., text captions, icons, or highlighted regions superimposed on a frame).

In some embodiments, visual elements such as bright highlighting effects (e.g., glowing outlines or flashing borders around objects), upward-trending graphical indicators (e.g., arrows or lines moving upward), or emphasized focal regions (e.g., zoomed-in areas or regions visually distinguished by contrast or brightness) may be assigned labels corresponding to outcome-implying or positively biased imagery. Conversely, visual elements such as static diagrams (e.g., non-animated charts or illustrations), balanced layouts (e.g., frames in which multiple elements are presented with similar size and visual prominence), or neutral color schemes (e.g., muted or uniform colors without emphasis effects) may be assigned labels corresponding to neutral explanatory imagery.

In some embodiments, the large language model may further aggregate labels across multiple frames to determine a sequence-level classification for the sequence of frames. For example, the large language model may classify a sequence of frames as “neutral presentation” when all or at least a target number of labels (e.g., 5, 10, 20, etc.) correspond to neutral or explanatory content, or may classify the sequence as “biased presentation” when at least one or more frames are assigned labels corresponding to persuasive or outcome-implying content.

In some embodiments, validation of the interactive video object using the one or more video generation policy controls may further include transcript-level classification of textual content by the large language model. For instance, the large language model may generate and/or receive a transcript corresponding to audio content of one or more video segments and may process the transcript to extract textual features and classify portions of the transcript into one or more predefined labels. In some embodiments, the classified textual elements may be evaluated relative to one or more of the video generation policy controls, including the content neutrality policy control, the concept coverage policy control, and/or the semantic consistency policy control.

For example, the large language model may assign one or more labels to textual elements within the transcript based on characteristics of the textual elements. Such textual elements may include, but are not limited to, individual tokens (e.g., words or symbols), phrases (e.g., groups of words forming a clause or statement), sentences, and/or sequences of sentences. In some embodiments, textual elements may be classified based on linguistic features such as word choice, tone, syntactic structure, or semantic meaning.

In some embodiments, textual elements such as directive statements (e.g., phrases including “you should,” “you must,” or “this will help you”), emphasized statements (e.g., repeated or highlighted claims), or statements implying certainty of outcomes (e.g., “this guarantees a result”) may be assigned labels corresponding to persuasive or outcome-implying content. Conversely, textual elements such as descriptive statements (e.g., “this is being evaluated”), conditional statements (e.g., “may result in,” “could include”), or balanced explanatory language may be assigned labels corresponding to neutral or informational content.

In some embodiments, the large language model may further assign labels corresponding to presence or absence of one or more concepts within the transcript. For example, portions of the transcript may be assigned labels indicating presence of a concept derived from the structured interrogative findings (e.g., “risk-present,” “voluntariness-present,” or “uncertainty-present”), or may be assigned labels indicating absence of such concepts (e.g., “risk-absent” or “uncertainty-absent”) when corresponding textual elements are not detected.

In some embodiments, the large language model may determine whether the transcript satisfies one or more video generation policy controls based on the assigned labels. For example, the large language model may determine that the transcript satisfies the content neutrality policy control when all or at least a target number of textual elements are assigned labels corresponding to neutral or informational content and no textual elements are assigned labels corresponding to directive or outcome-implying content. Conversely, the large language model may determine that the transcript does not satisfy the content neutrality policy control when one or more textual elements are assigned labels corresponding to directive phrasing or outcome-implying content.

In another example, the large language model may determine that the transcript satisfies the concept coverage policy control when labels corresponding to presence of required concepts (e.g., “risk-present,” “uncertainty-present,” “voluntariness-present”) are assigned to one or more portions of the transcript. Conversely, the large language model may determine that the transcript does not satisfy the concept coverage policy control when one or more required concept labels are absent or when labels indicating absence of such concepts are assigned.

In a further example, the large language model may determine that the transcript satisfies the semantic consistency policy control when labels assigned to textual elements correspond to concepts derived from the underlying source content and no labels indicating introduction of unsupported or conflicting content are present. Conversely, the large language model may determine that the transcript does not satisfy the semantic consistency policy control when one or more textual elements are assigned labels indicating inconsistency, contradiction, or introduction of content not derived from the underlying source content.

Additionally, or alternatively, in some embodiments, the interactive video object may comprise a user-provided video object received from a user computing device or a pre-selected video object rather than a video object entirely generated by the large language model. For example, the user-provided video object may include a prerecorded explanatory video, a training video, an educational video, a multimedia presentation, and/or any other suitable video object associated with the underlying unstructured digital artifact and/or structured interrogative findings.

In some embodiments, the user-provided video object may be editable through a conversational graphical user interface associated with the large language model. For example, the conversational graphical user interface may include a chat interface configured to receive natural language modification requests (e.g., user inputs) associated with the user-provided video object. The natural language modification requests may request modification of narration content in the user-provided video object, replacement of video segments in the user-provided video object, insertion of additional explanatory content to the user-provided video object, modification of lexical complexity levels associated with one or more portions of the user-provided video object, adjustment of pacing or sequencing associated with video segments in the user-provided video object, regeneration of visual explanation segments in the user-provided video object, regeneration of audio content in the user-provided video object, and/or selective regeneration of portions of the user-provided video object.

In some embodiments, responsive to receiving one or more natural language modification requests through the chat interface, the large language model may automatically generate one or more updated video synthesis prompts, semantic encodings, contextual overlays, transcripts, interactive user interface control objects, and/or replacement video segments corresponding to the natural language modification requests. For instance, if an end user submits a chat message requesting that narration content of a particular video segment be converted to a lower lexical complexity level, the large language model may automatically regenerate narration content, textual explanations, contextual overlays, and/or associated interactive assessment objects according to the requested lexical complexity level. Likewise, if an end user submits a chat message requesting replacement of a visual explanation segment, the large language model may regenerate corresponding narration, contextual overlays, interactive assessment objects, and/or sequencing instructions associated with the replacement visual explanation segment.

In some embodiments, the large language model may process the user-provided video object and/or the natural language modification requests associated therewith to determine whether the user-provided video object satisfies one or more semantic consistency requirements, lexical complexity requirements, explainability requirements, concept coverage requirements, and/or video generation policy controls described herein. For instance, the large language model may generate a transcript associated with the user-provided video object, classify visual and textual elements included in the user-provided video object, compare semantic meaning associated with the user-provided video object to the underlying unstructured digital artifact and/or structured interrogative findings, and determine whether the user-provided video object sufficiently conveys one or more target concepts associated with the underlying unstructured digital artifact.

In some embodiments, responsive to determining that the user-provided video object and/or one or more natural language modification requests fail to satisfy one or more thresholds, policy controls, semantic consistency constraints, readability constraints, and/or concept coverage constraints, the large language model may generate one or more conversational responses through the chat interface including notifications, warnings, suggested modifications, replacement content recommendations, and/or automatically regenerate portions of the interactive video object. For example, the large language model may determine that a modified narration segment exceeds a target lexical complexity threshold, omits one or more required concepts, introduces semantically inconsistent content, and/or includes one or more phrases violating a content neutrality policy control. Responsive to the determination, the large language model may automatically generate one or more modified narration segments, contextual overlays, replacement visual explanation segments, and/or updated interactive assessment objects configured to satisfy the one or more thresholds or policy controls.

Additionally, or alternatively, in some embodiments, the large language model may selectively preserve one or more portions of the user-provided video object while generating one or more new video segments corresponding to updated structured interrogative findings, updated lexical complexity requests, detected misunderstandings, updated policy controls, regenerated explainability artifacts, and/or natural language modification requests received through the chat interface. For example, the large language model may preserve a first subset of video segments determined to satisfy semantic consistency and readability thresholds while replacing, augmenting, or regenerating a second subset of video segments determined to fail one or more semantic consistency thresholds, lexical complexity thresholds, or policy controls.

Accordingly, various embodiments of the present invention improve interactive generation and modification of multimodal explainability artifacts by enabling end users to dynamically edit, regenerate, validate, customize, supplement, and/or replace user-provided video objects through a conversational graphical user interface while maintaining semantic consistency, contextual grounding, readability compliance, and policy compliance associated with the interactive video object.

### 2.40 Generating Interactive Explainability Objects

S240, which includes generating interactive explainability artifacts, may function to display one or more interactive explainability artifacts or objects in a graphical user interface that reduce or mitigate the lexical complexity of the unstructured digital artifact. An interactive explainability artifact, as generally used herein, may supplement or replace one or more portions of an unstructured digital artifact with one or more outputs generated by S210-S230 so that the one or more portions are usable or interpretable by entities (e.g., automated decisioning systems, machine learning models, and/or users) in instances where the lexical complexity of the unstructured digital artifact would otherwise exceed the maximum complexity threshold of such entities.

It shall be noted that if an unstructured digital artifact exceeds the maximum complexity threshold of a respective entity, such entity may be unable to interpret the semantic meaning or intent of the unstructured digital artifact. The inability to interpret the semantic meaning or intent of the unstructured digital artifact may result in suboptimal entity performance including model misclassification, failure to extract relevant features, incorrect decisions or inferences, and/or the like.

For instance, in a first non-limiting example, an unstructured digital artifact may include one or more multi-clause sentences comprising nested conditional statements and domain-specific terminology that exceeds a maximum complexity threshold of a machine learning model. If the machine learning model processes such an unstructured digital artifact while it exceeds the maximum complexity threshold, the machine learning model may be unable to correctly tokenize or parse the sentence. In such instances, token boundaries may be improperly identified and dependencies between clauses may not be preserved during parsing. As a result, the machine learning model may assign disproportionate weight to irrelevant tokens or fail to encode critical dependencies between one or more clauses of the multi-clause sentence, which in turn, may cause the machine learning model to generate an incorrect output, perform a misclassification, or fail to generate an output.

In a second non-limiting example, an automated decisioning system and/or a user may process an unstructured digital artifact including compound statements with embedded dependencies, cross-referenced conditions, and domain-specific terminology that exceeds a maximum complexity threshold. If the automated decisioning system processes such an unstructured digital artifact while it exceeds the maximum complexity threshold, the automated decisioning system may be unable to correctly resolve conditional logic or associate condition triggers with corresponding automated decisioning outcomes. In such instances, dependencies between clauses or conditions may be incorrectly mapped or omitted, which can result in improper evaluation of automated decisioning rules or conditions, including failure to satisfy required decisioning conditions, triggering of incorrect decisioning conditions, or execution of an incorrect automated decision path.

In further instances, a user interacting with the same unstructured digital artifact may be unable to isolate individual conditions or understand relationships between clauses (e.g., words or sentences) due to the presence of dense terminology and multiple interdependent statements. This may result in the user overlooking relevant conditions, misinterpreting dependencies, or arriving at incorrect conclusions regarding the intent of the unstructured digital artifact.

In a third non-limiting example, a machine learning model configured to generate embeddings from textual input may receive an unstructured digital artifact including high lexical density, domain-specific terminology, and multiple semantically distinct concepts expressed within a single sentence or paragraph that exceeds a maximum complexity threshold. If the machine learning model processes such an unstructured digital artifact while it exceeds the maximum complexity threshold, the machine learning model may be unable to preserve semantic separation between distinct concepts during embedding generation. In such instances, the vector embedding process may compress multiple concepts into overlapping or indistinguishable vector representations, which can reduce vector discriminability within an embedding space. Reduced vector discriminability may result in improper similarity matching, incorrect clustering of unrelated inputs, and degraded performance of downstream tasks including classification, retrieval, or inference.

Conversely, presentation or use of one or more outputs generated by S210-S230 corresponding to the unstructured digital artifact may enable the machine learning model(s) to process segmented, concept-specific representations, which preserves semantic separation between concepts and improves embedding quality, thereby supporting accurate similarity matching, clustering, and downstream model performance.

### Displaying the Corpus of Unstructured Data Fragments

In some embodiments, the interactive explainability artifact may display or include the corpus of unstructured data fragments extracted by S210. The corpus of unstructured data fragments, in some embodiments, may be displayed in association with the plurality of lexical complexity-controlled structured data fragments generated for the corpus of unstructured data fragments (in S220). In a non-limiting example, the interactive explainability artifact may use a plurality of rows to display the corpus of unstructured data fragments in association with the plurality of lexical complexity-controlled structured data fragments.

A respective row of the interactive explainability artifact may include a plurality of cells. A first cell of a respective row may comprise an unstructured data fragment (e.g., original section or paragraph) extracted from the unstructured digital artifact. Conversely, a second cell of the respective row may include a respective lexical complexity-controlled structured data fragment generated for the unstructured data fragment. For instance, in a non-limiting example, the interactive explainability artifact may display a graphical user interface that includes a first row, a second row, and so on up to an nth row (e.g., tens, hundreds, thousands, or millions of rows).

The first row of the interactive explainability artifact may display a first unstructured data fragment (e.g., original section or paragraph) in a first cell of the first row and a respective lexical complexity-controlled structured data fragment generated for the first unstructured data fragment in a second cell of the first row. Conversely, the second row of the interactive explainability artifact may display a second unstructured data fragment (e.g., original section or paragraph) in a first cell of the second row and a respective lexical complexity-controlled structured data fragment generated for the second unstructured data fragment in a second cell of the second row. Each remaining row of the plurality of rows may analogously display a respective unstructured data fragment in a first cell and a corresponding lexical complexity-controlled structured data fragment in a second cell, such that each row provides a paired representation of original content and a corresponding lexical complexity-controlled representation derived therefrom. It shall be noted that, in some embodiments, a respective row of the interactive explainability artifact may further include a third cell configured to display user or automated grading data, ground truth comparison data, validation indicators, reviewer annotations, quality assessment metrics, and/or hallucination scoring data associated with the respective lexical complexity-controlled structured data fragment.

In some embodiments, a first cell of a respective row may not be editable by user input, and a second cell of a respective row may be editable by user input. For instance, in a non-limiting example, the first cells in the first and second rows may not be responsive to (e.g., actively prevent or block) user input for adding tokens to or removing tokens from the first and second unstructured data fragments, respectively. Conversely, the second cells in the first and second rows may be responsive to user input for adding tokens to or removing tokens from the first and second unstructured data fragments, respectively. Analogously, each remaining row in the interactive explainability artifact may restrict user input with respect to the unstructured data fragments displayed in the first cells and permit user input with respect to the lexical complexity-controlled structured data fragments displayed in the second cells.

In some embodiments, one or more unstructured data fragments in the one or more first cells of the interactive explainability artifact may include a plurality of tokens and a plurality of non-interactive symbols. The plurality of non-interactive symbols may include visual representations of selectable options, input fields, or placeholders that are not responsive to user input in the unstructured digital artifact (e.g., static checkbox indicators such as “☐ Yes” or “☐ No,” signature lines represented by underscores or blank lines, date entry placeholders, or instructional text such as “write your name here,” type today’s date, etc.). Display of the one or more unstructured data fragments in the one or more first cells may include rendering the plurality of tokens and the plurality of non-interactive symbols in a static format that preserves the original structure and layout of the unstructured digital artifact.

Conversely, one or more corresponding lexical complexity-controlled structured data fragments displayed in the one or more second cells may include a second plurality of tokens generated by the large language model (for the reasons discussed previously) and a plurality of interactive user interface objects that replace the plurality of non-interactive symbols. For instance, static checkbox indicators may be replaced with selectable checkbox interface elements, signature lines may be replaced with interactive signature capture fields, and instructional placeholders may be replaced with interactive user interface form controls configured to receive user input (e.g., text entry fields, date selectors, or selection controls).

As generally used herein, a signature capture field may include an input region configured to receive a user-provided signature in one or more formats (e.g., typed input, stylus-based input, touch-based drawing input, or uploaded image input) and to store/display a digital representation of the user-provided signature. Additionally, as generally used herein, a date selector may include an interactive user interface control configured to receive temporal input from a user, including selection of a date via one or more input mechanisms (e.g., calendar-based selection, dropdown menus for day/month/year, or direct text entry), and to standardize the received input into a structured date format.

Additionally, or alternatively, in some embodiments, the plurality of interactive user interface objects may be selectable from a library of executable widgets accessible by a user through the interactive explainability artifact. For instance, the user may browse, select, insert, configure, and/or arrange one or more executable widgets within one or more lexical complexity-controlled structured data fragments. The library of executable widgets may include, but should not be limited to, interactive checkbox widgets, signature widgets, initials widgets, dropdown-selection widgets, acknowledgment widgets, text-entry widgets, audio-recording widgets, video-confirmation widgets, date-selection widgets, and/or other executable interface objects.

In some embodiments, the executable widgets may comprise script-enabled interface components, dynamically rendered code objects, browser-executable interface elements, and/or embeddable interactive controls configured to receive, validate, process, standardize, store, transmit, and/or associate user responses with corresponding portions of the interactive explainability artifact. For example, responsive to user interaction with a signature widget selected from the library of executable widgets, the executable widget may capture a digital signature representation, associate the digital signature representation with a corresponding lexical complexity-controlled structured data fragment, generate structured response data corresponding to the digital signature representation, and/or transmit the structured response data to one or more downstream systems. Likewise, responsive to user interaction with a selectable checkbox widget selected from the library of executable widgets, the executable widget may generate structured selection data corresponding to one or more selected options and associate the structured selection data with a corresponding portion of the interactive explainability artifact.

### Interactive Editing and Regeneration of Lexical Complexity-Controlled Structured Data Fragments

In some embodiments, S240 may receive user input selecting a first cell of a respective row in the interactive explainability artifact. For instance, in a non-limiting example, S240 may receive user input selecting the first cell of the second row in the interactive explainability artifact. It shall be noted that S240 may additionally, or alternatively receive user input selecting the first cell of any other respective row in the interactive explainability artifact and that S240 may perform operations analogous to those described with the respect to the selection of the first cell in the second row.

In response to receiving the user input selecting the first cell of the second respective row, S240 may cease displaying the second unstructured data fragment in a non-editable state. In some embodiments, a state of the unstructured data fragments (e.g., original paragraphs or sections) displayed in the first cells of other rows may not change based on S240 receiving the user input at the first cell of the second row. For example, if a first unstructured data fragment displayed in the first cell of the first row is in a non-editable state prior to receiving the user input selecting the first cell of the second row, the first unstructured data fragment may remain in the non-editable state after receiving the user input selecting the first cell of the second row. Conversely, if a third unstructured data fragment displayed in the first cell of a third row is in an editable state prior to receiving the user input selecting the first cell of the second row, the third unstructured data fragment may remain in the editable state after receiving the user input selecting the first cell of the second row.

Additionally, in response to receiving the user input selecting the first cell of the second respective row, S240 may insert a text input field and a selectable button into the first cell of the second respective row. The text input field may comprise the second unstructured data fragment associated with the second row in an editable state. While the second unstructured data fragment is displayed in the editable state, the text input field may receive user input that adds, removes, or modifies tokens of the second unstructured data fragment. In response to receiving such user input, the second unstructured data fragment may be updated in real-time or near real-time in accordance with the user input received at the text input field.

The selectable button inserted into the first cell of the second row may be configured to initiate generation of a new lexical complexity-controlled structured data fragment based on the second unstructured data fragment displayed in the text input field. S240, in some embodiments, may receive user input selecting the selectable button after receiving the user input at the text input field that modifies the second unstructured data fragment.

In response to receiving the user input selecting the selectable button, S240 may construct a new lexical complexity control prompt in a manner analogous to construction of the lexical complexity control prompt described above (e.g., in S220 and/or S230). In some embodiments, the new lexical complexity control prompt may comprise the plurality of lexical transformation control instructions and the second unstructured data fragment as modified via the user input received at the text input field. The large language model may execute the new lexical complexity control prompt to generate a new lexical complexity-controlled structured data fragment corresponding to the modified second unstructured data fragment.

While the large language model is generating the new lexical complexity-controlled structured data fragment, S240 may display, in the second cell of the second row, an animated visual indicator indicating that the large language model is currently generating the new lexical complexity-controlled structured data fragment. As generally used herein, an animated visual indicator may include a graphical element that exhibits motion, change, or temporal variation to convey that a process is in progress (e.g., a rotating icon, a pulsing element, a progress bar, a loading spinner, a sequence of changing symbols, or a textual indicator that updates over time such as “generating…”).

After the large language model generates the new lexical complexity-controlled structured data fragment, S240 may cease displaying the animated visual indicator in the second cell of the second row and may replace, at the second cell of the second row, the previously displayed lexical complexity-controlled structured data fragment with the newly generated lexical complexity-controlled structured data fragment corresponding to the modified second unstructured data fragment.

Additionally, or alternatively, in some embodiments, S240 may permit user-defined mapping relationships between a plurality of unstructured data fragments and one or more lexical complexity-controlled structured data fragments. For instance, S240 may receive user input selecting a plurality of unstructured data fragments displayed in corresponding first cells of multiple rows and associating the selected plurality of unstructured data fragments with a single lexical complexity-controlled structured data fragment displayed in a second cell of a target row. In a non-limiting example, a first unstructured data fragment corresponding to Section A, a second unstructured data fragment corresponding to Section B, and a third unstructured data fragment corresponding to Section D may be mapped to a single lexical complexity-controlled structured data fragment corresponding to Output Section 1.

Responsive to detecting modification of a mapping relationship between one or more unstructured data fragments and one or more lexical complexity-controlled structured data fragments, S240 may dynamically construct a new lexical complexity control prompt based on the modified mapping relationship and provide the new lexical complexity control prompt to the large language model. The large language model may subsequently generate a regenerated lexical complexity-controlled structured data fragment corresponding to the modified grouping, ordering, insertion, deletion, splitting, and/or merging of unstructured data fragments. For instance, responsive to insertion of an additional unstructured data fragment between Section A and Section B, the large language model may regenerate a corresponding lexical complexity-controlled structured data fragment based on the updated contextual relationship between the inserted unstructured data fragment, Section A, and Section B.

In some embodiments, S240 may further update one or more visual associations displayed in the interactive explainability artifact to indicate mapping relationships between the plurality of unstructured data fragments and the plurality of lexical complexity-controlled structured data fragments. For instance, S240 may display one or more visual connectors, grouping indicators, shared identifiers, color associations, expandable mapping regions, and/or other graphical indicators configured to visually associate multiple unstructured data fragments with a corresponding lexical complexity-controlled structured data fragment.

### Exporting Lexical Complexity-Controlled Structured Data Fragments to a Digital File

In some embodiments, the interactive explainability artifact may include a selectable export button configured to generate a digital file comprising the lexical complexity-controlled structured data fragments displayed in the graphical user interface. In response to receiving user input selecting the selectable export button, S240 may export the plurality of lexical complexity-controlled structured data fragments to a target digital file in accordance with a target file format. The target file format may include, but should not be limited to, a DOCX file format, PDF file format, HTML file format, XML file format, JSON file format, plain text file format, and/or any other suitable digital file format.

In some embodiments, the plurality of lexical complexity-controlled structured data fragments may be exported in accordance with an order of corresponding rows in the graphical user interface. For instance, a lexical complexity-controlled structured data fragment corresponding to a first unstructured data fragment displayed in a first row of the interactive explainability artifact may be inserted into the digital file prior to a lexical complexity-controlled structured data fragment corresponding to a second unstructured data fragment displayed in a second row. Analogously, each remaining lexical complexity-controlled structured data fragment may be added to the digital file in accordance with a position of a corresponding row in the graphical user interface.

In some embodiments, a respective lexical complexity-controlled structured data fragment may include a plurality of attribute fields (e.g., metadata) that define how to format the tokens underlying the respective lexical complexity-controlled structured data fragment when exported to the digital file. The attribute fields included within a respective lexical complexity-controlled structured data fragment may include, but should not be limited to, a token attribute field comprising the tokens underlying the respective lexical complexity-controlled structured data fragment, a source mapping attribute field nested under the token attribute field indicating that a subset of the tokens corresponds to a portion of a respective unstructured data fragment, and/or a formatting attribute field nested under the source mapping attribute field indicating a formatting type associated with the portion of the respective unstructured data fragment.

For example, for a respective lexical complexity-controlled structured data fragment, the token attribute field may include a sequence of tokens generated by the large language model such as “Overview of Section 1.” The source mapping attribute field may indicate that one or more tokens in the generated sequence correspond to tokens in the respective unstructured data fragment (e.g., tokens “Section 1” in the generated sequence correspond to tokens “Section 1:” in the unstructured data fragment). The formatting attribute field may indicate that the corresponding tokens in the unstructured data fragment had a first type of textual formatting (e.g., heading formatting), such that the generated tokens are to be formatted using a corresponding heading format in the digital file.

In another example, for a respective lexical complexity-controlled structured data fragment, the token attribute field may include a sequence of tokens such as “Important Notice.” The source mapping attribute field may indicate that the generated tokens correspond to tokens in the respective unstructured data fragment that originally appeared as “• IMPORTANT NOTICE.” The formatting attribute field may indicate that the original tokens had a first type of textual formatting (e.g., bullet-point formatting and emphasis formatting), such that the generated tokens are to be formatted using a corresponding bullet-point format and emphasis format in the digital file.

In some embodiments, exporting the plurality of lexical complexity-controlled structured data fragments may include initializing a digital file in a target file format (e.g., DOCX, PDF, HTML, XML, JSON, etc.). After initializing the digital file, S240 may detect a next lexical complexity-controlled structured data fragment to insert into the digital file. The next lexical complexity-controlled structured data fragment may be detected based on an order of the rows in the interactive explainability artifact. For instance, in a non-limiting example, if a first lexical complexity-controlled structured data fragment is displayed in a first row and a second lexical complexity-controlled structured data fragment is displayed in a second row, the first lexical complexity-controlled structured data fragment may be detected as the next lexical complexity-controlled structured data fragment to insert into the digital file prior to the second lexical complexity-controlled structured data fragment.

After detecting that the next lexical complexity-controlled structured data fragment to insert into the digital file corresponds to the first lexical complexity-controlled structured data fragment, S240 may add the tokens underlying the first lexical complexity-controlled structured data fragment to the digital file. The tokens, in some embodiments, may be added based on or in accordance with a position of first lexical complexity-controlled structured data fragment in the graphical user interface. For example, if the first lexical complexity-controlled structured data fragment is displayed in a first row of the interactive explainability artifact, the tokens underlying the first lexical complexity-controlled structured data fragment may be added to the digital file prior to tokens underlying a second lexical complexity-controlled structured data fragment displayed in a second row.

In some embodiments, after adding the tokens underlying the first lexical complexity-controlled structured data fragment to the digital file, S240 may apply textual formatting to one or more tokens based on the attribute fields associated with the first lexical complexity-controlled structured data fragment. For instance, in a non-limiting example, S240 may determine a plurality of original tokens in the unstructured digital artifact that correspond to one or more tokens of the first lexical complexity-controlled structured data fragment based on the source mapping attribute field. S240 may further determine, based on the formatting attribute field, that the plurality of original tokens were associated with a first type of textual formatting in the unstructured digital artifact (e.g., heading formatting, bold formatting, italic formatting, bullet-point formatting, indentation formatting, font size, font style, or color formatting). In response to such determination, S240 may apply the first type of textual formatting to the corresponding tokens in the digital file.

It shall be noted that S240 may format remaining tokens underlying the first lexical complexity-controlled structured data fragment in similar ways. Alternatively, if S240 determines that the remaining tokens do not include corresponding formatting attribute fields indicating a type of textual formatting, S240 may apply a default textual formatting to the remaining tokens in the digital file.

Furthermore, after adding the first lexical complexity-controlled structured data fragment to the target digital file, S240 may add the additional lexical complexity-controlled structured data fragments displayed in the interactive explainability artifact in analogous ways as described above. Stated another way, S240 may add the tokens underlying each additional lexical complexity-controlled structured data fragment to the target digital file and may apply textual formatting to the tokens based on attribute fields associated with each additional lexical complexity-controlled structured data fragment in accordance with respective positions of the additional lexical complexity-controlled structured data fragments in the interactive explainability artifact.

### Activation and Deactivation of the Selectable Export Button

In some embodiments, the interactive explainability artifact may display the selectable export button in an activated state or a deactivated state. The selectable export button, in some embodiments, may be displayed in the activated state or the deactivated state based on the pre-defined hallucination criteria and/or the pre-defined readability criteria described in S220. For instance, in a non-limiting example, if a respective lexical complexity-controlled structured data fragment fails to satisfy the pre-defined hallucination criteria and/or the pre-defined readability criteria, S240 may display the selectable export button in the deactivated state. Additionally, in response to method 200 detecting that a respective lexical complexity-controlled structured data fragment fails to satisfy the pre-defined hallucination criteria and/or the pre-defined readability criteria, method 200 may route the respective lexical complexity-controlled structured data fragment to a review queue.

A review queue, as generally used herein, may include a data structure or user interface configured to store and present one or more lexical complexity-controlled structured data fragments that fail to satisfy the pre-defined hallucination criteria and/or the pre-defined readability criteria. The review queue may be accessible via the interactive explainability artifact and may be configured to receive user input for reviewing and accept the one or more lexical complexity-controlled structured data fragments.

In some embodiments, while a respective lexical complexity-controlled data fragment is included in the review queue, S240 may display a hallucination and readability alert badge in the interactive explainability artifact. For instance, in a non-limiting example, S240 may display the hallucination and readability alert badge in a second cell of a respective row corresponding to the respective lexical complexity-controlled structured data fragment to indicate that the respective lexical complexity-controlled structured data fragment fails to satisfy the pre-defined hallucination criteria and/or the pre-defined readability criteria.

S240, in some embodiments, may receive a user input at the review queue that accepts a respective lexical complexity-controlled structured data fragment. In response to receiving the user input at the review queue, S240 may remove the hallucination and readability badge from the second cell of the respective row. Additionally, after reading the hallucination and readability badge from the second cell of the respective row, S240 may transition the selectable export button from the deactivated state to the activated state (e.g., a state that allows user input to generate the digital file).

### Displaying Structured Interrogative Findings

Additionally, or alternatively, S240 may display, in the interactive explainability artifact, each structured interrogative finding generated by the large language model. Each structured interrogative finding, in some embodiments, may be displayed in a distinct editable text container. For instance, in a non-limiting example, S240 may display a first editable text container for a first distinct interrogative, a second editable text container for a second distinct interrogative, and so on up to an nth editable text container corresponding to an nth distinct interrogative.

The first editable text container for the first distinct interrogative may include a header area and a content area. The header area may display the first distinct interrogative with a first amount of visual prominence, and the content area may display a respective structured interrogative finding generated for the first distinct interrogative. The content area may display the respective structured interrogative finding with a second amount of visual prominence, less than the first amount of visual prominence. As generally used herein, visual prominence may refer to a relative degree of visual emphasis or salience of a user interface element within the graphical user interface. Visual prominence may be controlled based on one or more visual attributes including, but not limited to, font size, font weight (e.g., boldness), color, contrast, spacing, positioning, or the use of graphical elements (e.g., borders, shading, or highlighting).

In some embodiments, the first amount of visual prominence and the second amount of visual prominence may be defined relative to one another such that the header area is more visually prominent than the content area. For instance, in a non-limiting example, the first amount of visual prominence may include a larger font size and bold styling relative to the second amount of visual prominence, which may include a smaller font size and reduced visual emphasis.

The second to the nth editable text containers may be structured in a manner analogous to the first editable text container. For instance, each of the second to the nth editable text containers may include a respective header area displaying a respective distinct interrogative with the first amount of visual prominence and a respective content area displaying a respective structured interrogative finding generated for the respective distinct interrogative with the second amount of visual prominence. Additionally, or alternatively, in some embodiments, the first editable text container to the nth editable text containers may be concurrently displayed in the graphical user interface (e.g., interactive explainability artifact) at a position above the corpus of unstructured data fragments and the plurality of lexical complexity-controlled structured data fragments generated for the corpus of unstructured data fragments.

### Exporting the Structured Interrogative Findings

In some embodiments, the interactive explainability artifact may include a selectable export button configured to generate a digital file comprising textual representations of the first editable text container and the one or more additional editable text containers displayed in the graphical user interface (e.g., the second to the nth editable text containers). In response to receiving user input selecting the selectable export button, S240 may export the textual representations of the first editable text container and the one or more additional editable text containers to a target digital file in accordance with a target file format. The target file format may include, but should not be limited to, a DOCX file format, PDF file format, HTML file format, XML file format, JSON file format, plain text file format, and/or any other suitable digital file format.

In some embodiments, the textual representations of the first editable text container and the one or more additional editable text containers may be exported in accordance with a presentation order of the first editable text container and the one or more additional editable text containers in the graphical user interface. For instance, in a non-limiting example, a textual representation of the first editable text container displayed above a second editable text container may be inserted into the digital file prior to a textual representation of the second editable text container. Analogously, each remaining textual representation may be added to the digital file in accordance with a respective position of a corresponding editable text container in the graphical user interface.

In some embodiments, after exporting the digital file, S240 may receive, via the graphical user interface, user input modifying a respective structured interrogative finding displayed in a content area of a respective editable text container. For instance, in a non-limiting example, S240 may receive user input adding one or more new tokens to the first respective structured interrogative finding displayed in the content area of the first editable text container.

In some embodiments, after receiving the user input modifying the first respective structured interrogative finding, S240 may receive user input selecting the selectable export button displayed in association with the first editable text container and the one or more additional editable text containers. In response to receiving the user input selecting the selectable export button, S240 may update the digital file to include a new textual representation of the first editable text container in place of a prior textual representation of the first editable text container, such that the new textual representation includes the one or more new tokens added to the first respective structured interrogative finding.

It shall be noted that S240 may update textual representations of additional editable text containers in similar ways based on user input modifying respective structured interrogative findings, such that the digital file reflects updates performed within the interactive explainability artifact.

Embodiments of the system and/or method can include every combination and permutation of the various system components and the various method processes, wherein one or more instances of the method and/or processes described herein can be performed in real time, asynchronously (e.g., sequentially), concurrently (e.g., in parallel), or in any other suitable order by and/or using one or more instances of the systems, elements, and/or entities described herein.

The system and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that similar to a method with contingent steps, a system or computer readable storage medium can repeat the steps of a method as many times as are needed to ensure that all of the contingent steps have been performed.

Although omitted for conciseness, the preferred embodiments include every combination and permutation of the implementations of the systems and methods described herein in real-time or near real-time, asynchronously (e.g., sequentially), concurrently (e.g., in parallel), or in any other suitable order by and/or using one or more instances of the systems, elements, and/or entities described herein. Furthermore, each method step, process step, or the like described herein may be performed in real-time or near real-time. It shall be noted that “real-time” or “near real-time” as generally used herein may refer to generating an output or performing an action within strict time constraints. For example, in one or more embodiments, real-time may be understood to be instantaneous, on the order of milliseconds, or on the order of minutes. Of course, depending on the particular temporal nature of the system in which an embodiment is implemented, other appropriate timescales may be considered acceptable for real-time or near real-time processing.

It shall be noted that the techniques described herein (e.g., system 100 and/or method 200) address technical problems associated with text-to-text translation systems. Text-to-text translation systems, sometimes referred to as “language models,” “text-to-text conversion systems,” or the like, often struggle to translate or convert unstructured data having high lexical complexity. The unstructured data may be generated by a user interacting with one or more computing systems and/or may include multi-section documents, transcripts, free-form text, multimedia content, and/or other semantically dense data objects. A user or computing system may request conversion or translation of unstructured data from a high level of lexical complexity (e.g., PhD-level readability, 12^{th} grade reading level, etc.) to a low level of lexical complexity (e.g., elementary-school-level readability, 2^{nd} grade reading level, etc.).

The present invention is configured to translate unstructured data from a high level of lexical complexity to a low level of lexical complexity with low latency. This provides an improvement over conventional text-to-text translation systems. Conventional text-to-text translation systems are generally directed to translating unstructured data with low lexical complexity and are not well-equipped to translate unstructured data with high lexical complexity. Specifically, conventional text-to-text translation systems often take several hours or days to convert or translate unstructured data from a high level of lexical complexity to a low level of lexical complexity. For example, for a multi-section research paper comprising 12,000 or more words, conventional text-to-text translation systems require, on average, 24 hours to convert the multi-section research paper into a low level of lexical complexity. Unlike conventional text-to-text translation systems, the present invention may reduce translation latency from several hours or days to several seconds or milliseconds for the same unstructured data (e.g., the multi-section research paper comprising 12,000 or more words). It shall be noted that reducing translation latency from several hours or days to several seconds or milliseconds may reduce processor utilization, reduce memory utilization, reduce energy consumption, reduce battery consumption, reduce thermal output associated with prolonged processor execution, reduce hardware degradation and wear associated with prolonged computing operations, and/or the like.

Another technical challenge addressed by the present invention relates to the efficiency/accuracy with which text-to-text translation systems are able to translate or convert unstructured data with high lexical complexity. Conventional text-to-text translation systems often provide the entirety of the unstructured data as context to a large language model. The unstructured data may comprise tens or hundreds of sections, each section exceeding thousands or tens of thousands of pages. As a result, the large language model may be computationally burdened by the excessive quantity of semantically dense context provided as input. Not only are the large language models computationally burden by the excessive context input, but they also fail to accurately convert or translate the unstructured data due to context window limitations.

A context window, as generally referred to herein, may be defined as a maximum quantity of tokens, characters, words, or semantic units that a large language model is capable of processing during a given inference operation. When the quantity of contextual information (e.g., tokens, characters, words, semantic units, etc.) exceeds the context window of the large language model, portions of the unstructured data may be truncated, omitted, ignored, deprioritized, or otherwise excluded from consideration by the large language model, thereby resulting in inaccurate translations, semantic inconsistencies, hallucinated outputs, and/or loss of contextual continuity between sections of the unstructured data. Moreover, indiscriminate inclusion of the entirety of the unstructured data as contextual input may increase latency, memory consumption, bandwidth utilization, and computational resource expenditure associated with operation of the text-to-text translation system. Accordingly, there exists a need for improved systems and methods capable of selectively identifying, extracting, prioritizing, and providing semantically relevant contextual information to a large language model in a manner that improves translation accuracy while simultaneously reducing computational overhead associated with processing large-scale unstructured data.

Specifically, due to the excessive context input, the large language models may generate translation or conversion outputs that include hallucinations, inaccurate semantic or contextual relationships, and maintain a high level of lexical complexity (despite a request instructing the large language models to reduce the lexical complexity of the unstructured data). The present invention, for the reasons described herein, overcomes the above technical problems and provides techniques for reducing the context provided to the large language models and for detecting and mitigating flawed and incomplete outputs generated by large language models. Various embodiments of the present invention further address technical problems associated with graphical user interfaces presenting unstructured data having high lexical complexity.

Specifically, various embodiments of the present invention address challenges associated with presenting unstructured data having high lexical complexity by providing end users with interactive explainability artifacts configured to present semantic meaning associated with the unstructured data at a reduced lexical complexity level. Unlike conventional graphical user interfaces that only statically render the semantically dense unstructured data, the disclosed interactive explainability artifacts may provide contextual information using reduced lexical complexity outputs that more naturally convey semantic meaning and contextual intent associated with the unstructured data. Accordingly, in various embodiments, the interactive explainability artifacts may be automatically updated according to detected lexical complexity levels, contextual changes associated with the unstructured data, user modifications, regenerated outputs, and/or updated conversion requests in order to provide the most up-to-date semantic renderings associated with the unstructured data and facilitate reliable and efficient analysis by end users.

In various embodiments, end users may efficiently determine whether additional review of the unstructured data is necessary based on the interactive explainability artifact, whether semantic meaning associated with the unstructured data has already been sufficiently conveyed through the reduced lexical complexity output, whether regeneration of one or more portions of the interactive explainability artifact is necessary, and/or whether another unstructured data object (or modified data object) should instead be processed. In some embodiments, the graphical user interface may further enable end users to edit portions of the reduced lexical complexity output, regenerate portions of the reduced lexical complexity output according to updated lexical complexity requests, and export finalized outputs once review is completed.

Accordingly, various embodiments of the present invention reduce latency associated with semantic interpretation of unstructured data, reduce computational time associated with text-to-text translation systems, reduce hallucinated outputs generated by machine learning systems (language models), improve readability associated with generated transcription outputs, improve semantic consistency associated with generated outputs, and reduce operational load (e.g., computation resources) associated with processing lexically dense unstructured data, and/or the like. Moreover, various embodiments of the present invention reduce an amount of time required to generate and present interactive explainability artifacts associated with the unstructured data, thus improving low-latency accessibility of semantic meaning and contextual intent associated with the unstructured data.

In some embodiments, the reduced lexical complexity outputs and/or interactive explainability artifacts generated by the present invention further improve operation of downstream machine learning systems. Conventional machine learning systems trained using lexically dense unstructured data often experience reduced prediction accuracy due to semantically inconsistent terminology, hallucinated contextual relationships, ambiguous semantic meaning, and/or excessive contextual noise associated with the unstructured data. By generating semantically consistent reduced lexical complexity outputs, the present invention may generate training data that is more contextually grounded and semantically interpretable by downstream machine learning systems.

For example, machine learning systems trained using reduced lexical complexity outputs generated according to the disclosed techniques exhibit improved classification accuracy, improved semantic retrieval accuracy, improved contextual prediction accuracy, improved inference consistency, and/or reduced hallucination propagation relative to machine learning systems trained using the original lexically dense unstructured data. In some embodiments, reducing lexical complexity associated with training data reduce contextual ambiguity processed by downstream machine learning systems, thereby improving convergence efficiency during training operations and improving predictive accuracy associated with downstream inference operations. Accordingly, various embodiments of the present invention improve training efficiency and prediction accuracy associated with downstream machine learning systems by generating semantically consistent reduced lexical complexity outputs configured to preserve contextual meaning while reducing contextual ambiguity and excessive semantically dense contextual input.

Another technical challenge addressed by the present invention relates to limitations associated with conventional text-to-text translation systems being restricted to transformations within a same modality. Conventional language models and text-to-text conversion systems are generally configured to receive textual input and generate textual output, but are not configured to transform lexically dense unstructured data into alternative modalities configured to more intuitively convey semantic meaning and contextual intent associated with the unstructured data. As a result, conventional text-to-text translation systems often fail to provide semantically rich multimodal outputs capable of improving comprehension, accessibility, and contextual interpretation associated with the unstructured data.

Various embodiments of the present invention overcome these technical limitations by performing cross-modality transformations associated with unstructured data. In some embodiments, the present invention may transform unstructured textual data into interactive video objects, visual explainability artifacts, animated semantic walkthroughs, narrated contextual summaries, graphical semantic representations, and/or other multimodal explainability outputs. For example, the present invention may receive a multi-section research paper having a PhD-level readability and automatically generate a reduced lexical complexity interactive video configured to visually and audibly explain semantic meaning associated with the multi-section research paper at an elementary-school-level readability.

In various embodiments, the generated video outputs may include dynamically generated narration, semantic overlays, contextual anchors, animated semantic relationships, synchronized textual explanations, visual emphasis indicators, interactive teach-back prompts, and/or other multimodal interface objects configured to improve semantic understanding associated with the unstructured data. By transforming semantically dense textual data into multimodal explainability artifacts, the present invention improves accessibility of semantic meaning associated with the unstructured data while reducing cognitive load associated with interpreting lexically dense content.

Accordingly, various embodiments of the present invention improve operation of language models and graphical user interfaces by enabling low-latency transformation of unstructured data across different modalities, including text-to-text and text-to-video transformations. Moreover, the disclosed techniques reduce an amount of semantically dense textual information required to be manually reviewed by end users, improve semantic comprehension associated with the unstructured data, improve contextual retention associated with generated outputs, and improve accessibility of semantically dense unstructured data across different types of computing devices and end users.

Another technical challenge addressed by the present invention relates to inefficiencies associated with conventional language models failing to generate machine-readable semantic representations capable of controlling downstream computing operations. Conventional text-to-text translation systems generally generate static textual outputs that are not encoded into structured semantic signals usable for downstream decisioning, interface adaptation, workflow control, multimodal generation, and/or execution of external computing operations. As a result, conventional language models often fail to dynamically adapt generated outputs according to contextual complexity, user comprehension, semantic consistency, hallucination likelihood, and/or downstream operational requirements.

Various embodiments of the present invention overcome these technical limitations by encoding semantic meaning associated with unstructured data into a plurality of machine-readable semantic signals generated by the large language model. In some embodiments, the semantic signals may include lexical complexity signals, semantic consistency signals, hallucination detection signals, contextual continuity signals, comprehension confidence signals, modality transformation signals, interaction speed signals, response latency signals, semantic relevance signals, and/or contextual ambiguity signals. For example, the large language model may encode a first lexical complexity signal indicating that a first section of unstructured data exceeds a target readability threshold, a second hallucination detection signal indicating that a generated output includes semantically unsupported content, and/or a third comprehension confidence signal indicating that a user likely misunderstood one or more concepts associated with a generated explainability artifact.

In various embodiments, the encoded semantic signals may be utilized to dynamically control operation of one or more downstream computing systems and graphical user interfaces. For instance, responsive to detecting a lexical complexity signal exceeding a threshold readability level, the present invention may automatically regenerate a corresponding lexical complexity-controlled structured data fragment at a reduced readability level. Likewise, responsive to detecting a hallucination detection signal exceeding a hallucination threshold, the present invention may automatically route a corresponding generated output to a review queue, insert a hallucination alert badge into the interactive explainability artifact, deactivate a selectable export control, and/or generate a replacement lexical complexity-controlled structured data fragment using modified contextual inputs.

Additionally, in some embodiments, the encoded semantic signals may trigger one or more modality transformation operations associated with the unstructured data. For example, responsive to determining that a semantic complexity signal associated with a portion of the unstructured data exceeds a threshold complexity level, the present invention may automatically generate an interactive video object, narrated semantic walkthrough, contextual overlay, animated semantic relationship representation, graphical explainability artifact, and/or multimodal output corresponding to the portion of the unstructured data. Conversely, responsive to detecting comprehension confidence signals indicating sufficient user understanding associated with the generated output, the present invention may suppress generation of additional explanatory content and permit progression to a subsequent workflow state.

In various embodiments, the encoded semantic signals may further control execution of one or more downstream physical environment operations associated with completion of an interactive video object and/or corresponding explainability artifact (e.g., signed the explainability artifact or exported digital file). For instance, responsive to determining that one or more users successfully completed playback of an interactive video object and/or that corresponding comprehension confidence signals satisfy one or more threshold conditions (or signed the explainability artifact or the exported digital file), the present invention may automatically transmit one or more activation signals configured to control operation of one or more physical access control systems associated with a physical environment. In a non-limiting example, a plurality of users may initially be positioned within a first physical room separated from a second physical room by a physical barrier including an electronically controlled door, electronically controlled lock, electronically controlled gate, electronically controlled partition, electronically controlled enclosure, and/or any other suitable electronically actuated physical barrier.

In some embodiments, while the users are positioned within the first physical room, the electronically controlled physical barrier may remain in a locked state that physically prevents access to the second physical room. The users may interact with the interactive video object, the explainability artifact, or the exportable digital file presented via one or more computing devices located within the first physical room. During presentation of such object, file, or artifact, the present invention may continuously generate and update one or more comprehension confidence signals, interaction signals, semantic consistency signals, response latency signals, and/or teach-back evaluation signals associated with the users. For instance, the present invention may determine whether the users correctly responded to one or more interactive prompts associated with the interactive video object, whether the users replayed one or more explanatory segments beyond a threshold amount, whether the users demonstrated semantic understanding associated with one or more concepts presented in the interactive video object, whether one or more comprehension thresholds were satisfied, whether the explainability artifact or digital file was signed, and/or the like.

Responsive to determining that the one or more above threshold conditions are satisfied, the present invention may automatically transition the electronically controlled physical barrier from the locked state to an unlocked state. For example, the present invention may transmit one or more electronic control signals to an access control subsystem associated with the electronically controlled physical barrier via one or more application programming interfaces (APIs), network control interfaces, wireless communication protocols, and/or device control services, thereby causing disengagement of an electromechanical locking mechanism associated with the electronically controlled door or gate. In some embodiments, transitioning the electronically controlled physical barrier from the locked state to the unlocked state may further include transmitting one or more lighting activation signals configured to illuminate one or more lighting systems positioned within the second physical room, transmitting one or more device activation signals configured to power on, wake, unlock, and/or authenticate one or more computing devices positioned within the second physical room, and/or transmitting one or more execution signals configured to initiate one or more downstream study procedures involving one or more physical study objects positioned within the second physical room. For instance, the present invention may invoke one or more building management APIs to activate overhead lighting systems, invoke one or more device management APIs to transition one or more computers from a locked or sleep state to an active operational state, and/or invoke one or more study management system APIs configured to initiate execution of one or more study workflows associated with the physical study objects.

In some embodiments, activation of the one or more computing devices positioned within the second physical room may include automatically authenticating one or more user accounts, launching one or more study participation applications, displaying one or more user-specific interface states, enabling one or more restricted software-controlled functions, and/or establishing communication sessions with one or more remote computing systems associated with the study. Likewise, activation of the one or more lighting systems may include selectively illuminating particular regions of the second physical room corresponding to locations of one or more physical study objects, workstations, displays, instruments, and/or interactive devices associated with a downstream workflow.

Conversely, responsive to determining that the one or more threshold conditions are not satisfied, the present invention may maintain the electronically controlled physical barrier in the locked state. For example, responsive to detecting low comprehension confidence signals, contradictory interaction signals, semantic inconsistency signals, hallucination detection signals exceeding one or more thresholds, and/or repeated misunderstanding of concepts presented in the interactive video object, the present invention may prevent transmission of one or more unlock control signals to the access control subsystem associated with the electronically controlled physical barrier. In some embodiments, the present invention may further suppress transmission of one or more lighting activation signals, prevent activation of one or more computing devices positioned within the second physical room, maintain one or more study management systems in a disabled state, generate one or more additional explainability artifacts, replay one or more explanatory video segments, activate one or more additional interactive teach-back objects, transmit escalation notifications to one or more reviewer computing devices, and/or route the users to a human reviewer prior to permitting transition of the electronically controlled physical barrier to the unlocked state.

As a person skilled in the art will recognize from the previous detailed description and from the figures and claims, modifications and changes can be made to the preferred embodiments of the invention without departing from the scope of this invention defined in the following claims.

We claim:

1. A computer-implemented method for real-time conversion of unstructured data, the computer-implemented method comprising:
at an unstructured data conversion service implemented by a network of distributed computers:
obtaining, at a graphical user interface, an unstructured digital artifact having a lexical complexity exceeding a maximum complexity threshold;
automatically extracting, in real-time, a corpus of unstructured data fragments from the unstructured digital artifact causing the lexical complexity of the unstructured digital artifact to exceed the maximum complexity threshold;
generating, in real-time, a plurality of lexical complexity mitigation prompts in response to extracting the corpus of unstructured data fragments, wherein the plurality of lexical complexity mitigation prompts include:
a plurality of interrogative prompts, wherein each respective interrogative prompt of the plurality of interrogative prompts comprises a distinct interrogative and a distinct subset of unstructured data fragments from the corpus of unstructured data fragments that correspond to the distinct interrogative, and
a plurality of lexical complexity control prompts, wherein each respective lexical complexity control prompt of the plurality of lexical complexity control prompts comprises a plurality of lexical transformation control instructions and a distinct unstructured data fragment from the corpus of unstructured data fragments;
generating, in real-time, an interactive video object based on the plurality of lexical complexity mitigation prompts, wherein generating the interactive video object includes:
generating, by a large language model executing the plurality of interrogative prompts, a respective structured interrogative finding for each distinct interrogative included in the plurality of interrogative prompts,
generating, by the large language model executing the plurality of lexical complexity control prompts, a respective lexical complexity-controlled structured data fragment for each distinct unstructured data fragment included in the plurality of lexical complexity control prompts,
dynamically creating, in real-time, an interactive video composition prompt comprising a plurality of video synthesis instructions and a plurality of video-integrated user interface element creation instructions based on (i) the respective structured interrogative finding generated for each distinct interrogative included in the plurality of interrogative prompts and (ii) the respective lexical complexity-controlled structured data fragment generated for each distinct unstructured data fragment included in the plurality of lexical complexity control prompts,
generating, via the large language model executing the interactive video composition prompt, the interactive video object comprising a plurality of video segments and a plurality of interactive user interface control objects interleaved with the plurality of video segments; and
inserting, into the graphical user interface, an interactive explainability artifact that mitigates the lexical complexity of the unstructured digital artifact and:
(1) executes the interactive video object in response to user input,
(2) displays the corpus of unstructured data fragments extracted from the unstructured digital artifact in association with the respective lexical complexity-controlled structured data fragment generated for each distinct unstructured data fragment included in the corpus of unstructured data fragments, and
(3) displays the respective structured interrogative finding generated for each distinct interrogative included in the plurality of interrogative prompts.

2. The computer-implemented method according to claim 1, wherein dynamically creating the interactive video composition prompt includes:
prompting the large language model to generate a video scene specification using the respective structured interrogative finding generated for each distinct interrogative included in the plurality of interrogative prompts, wherein the video scene specification defines:
a sequence for presenting each distinct interrogative included in the plurality of interrogative prompts,
a starting scene description that defines one or more starting visual animation descriptions for introducing a starting interrogative in the sequence and transitioning to the respective structured interrogative finding generated for the starting interrogative,
an intermediate scene description for each additional interrogative in the sequence that defines one or more intermediate visual animation descriptions for introducing a distinct additional interrogative and transitioning to the respective structured interrogative finding generated for the distinct additional interrogative, and
a final scene description that defines one or more final visual animation descriptions for presenting a last interrogative in the sequence and transitioning to the respective structured interrogative finding generated for the last interrogative, and
generating, via the large language model, the plurality of video synthesis instructions that request the large language model to generate the plurality of video segments of the interactive video object based on the video scene specification generated by the large language model.

3. The computer-implemented method according to claim 2, wherein dynamically creating the interactive video composition prompt further includes:
prompting the large language model to generate a plurality of post-scene interactive assessment descriptions using the respective lexical complexity-controlled structured data fragment generated for each distinct unstructured data fragment included in the plurality of lexical complexity control prompts, wherein the plurality of post-scene interactive assessment descriptions include:
a first post-scene interactive assessment description that defines a first configuration of user interface elements for presenting the starting interrogative and receiving the user input for answering the starting interrogative,
a distinct intermediate post-scene interactive assessment description for each additional interrogative in the sequence that defines a second configuration of user interface elements for presenting the distinct additional interrogative and receiving the user input for answering the distinct additional interrogative, and
a final post-scene interactive assessment description that defines a third configuration of user interface elements for presenting the last interrogative in the sequence and receiving the user input for answering the last interrogative, and
generating, via the large language model, the plurality of video-integrated user interface element creation instructions that request the large language model to generate the plurality of interactive user interface control objects based on the plurality of post-scene interactive assessment descriptions.

4. The computer-implemented method according to claim 3, wherein generating the interactive video object includes:
generating, via the large language model, a starting video segment based on the starting scene description,
generating, via the large language model, a plurality of intermediate video segments based on the intermediate scene description generated for each additional interrogative in the sequence,
generating, via the large language model, a final video segment based on the final scene description, and
inserting the starting video segment at a start of the interactive video object, the final video segment at an end of the interactive video object and the plurality of intermediate video segments at a plurality of corresponding playback positions between the start of the interactive video object and the end of the interactive video object.

5. The computer-implemented method according to claim 4, wherein generating the interactive video object further includes:
generating, by the large language model, a first subset of the plurality of interactive user interface control objects based on the first post-scene interactive assessment description,
inserting, by the large language mode, the first subset of the plurality of interactive user interface control objects at a playback position immediately following completion of the starting video segment,
generating, by the large language model, a plurality of second subsets of the plurality of interactive user interface objects based on the distinct intermediate post-scene interactive assessment description generated for each additional interrogative in the sequence,
inserting, by the large language model, each respective subset of the plurality of second subsets of the plurality of interactive user interface objects at a corresponding playback position following one of the plurality of intermediate video segments,
generating, by the large language model, a third subset of the plurality of interactive user interface control objects based on the final post-scene interactive assessment description, and
inserting, by the large language mode, the third subset of the plurality of interactive user interface control objects at a playback position immediately following completion of the final video segment.

6. The computer-implemented method according to claim 1, wherein:
a first unstructured data fragment included in the corpus of unstructured data fragments corresponds to a first original section extracted from the unstructured digital artifact, and
displaying the corpus of unstructured data fragments includes:
displaying, in the graphical user interface, a first row comprising a first cell that includes the first original section extracted from the unstructured digital artifact and the respective lexical complexity-controlled structured data fragment generated for the first original section in a second cell of the first row,
wherein the first original section in the first cell of the first row is not editable by the user input, and the respective lexical complexity-controlled structured data fragment generated for the first original section in the second cell of the first row is editable by the user input.

7. The computer-implemented method according to claim 6, wherein:
a second unstructured data fragment included in the corpus of unstructured data fragments corresponds to a first original paragraph extracted from the unstructured digital artifact, and
displaying the corpus of unstructured data fragments includes:
displaying, in the graphical user interface, a second row comprising a first cell that includes the first original paragraph extracted from the unstructured digital artifact and the respective lexical complexity-controlled structured data fragment generated for the first original paragraph in a second cell of the second row,
wherein the first original section in the first cell of the second row is not editable by the user input, and the respective lexical complexity-controlled structured data fragment generated for the first original paragraph in the second cell of the second row is editable by the user input.

8. The computer-implemented method according to claim 7, wherein:
the first original paragraph extracted from the unstructured digital artifact includes a plurality of tokens and a plurality of non-interactive symbols,
displaying the first original paragraph in the first cell of the second row includes displaying the plurality of tokens and the plurality of non-interactive symbols in the first cell of the second row, and
displaying the respective lexical complexity-controlled structured data fragment generated for the first original paragraph in the second cell of the second row includes:
displaying a second plurality of tokens that the large language model generated by applying the plurality of lexical transformation control instructions to the plurality of tokens, and
displaying a plurality of interactive user interface objects, generated by the large language model, that replaces the plurality of non-interactive symbols and that are responsive to the user input.

9. The computer-implemented method according to claim 8, further comprising:
receiving a second user input selecting the first cell of the second row,
in response to receiving the second user input selecting the first cell of the second row:
ceasing displaying the first original paragraph in a non-editable state while maintaining the first original section in the non-editable state,
inserting, into the first cell of the second row, a first text input field comprising the first original paragraph in an editable state,
inserting, into the first cell of the second row, a selectable button configured to convert the first original paragraph into a new respective lexical complexity-controlled structured data fragment for the first original paragraph,
receiving, at the first text input field, a third user input adding one or more new tokens to the first original paragraph,
after receiving the third user input, receiving a fourth user input selecting the selectable button inserted into the first cell of the second row, and
in response to receiving the fourth user input:
constructing a new lexical complexity control prompt comprising the plurality of lexical complexity transformation control instructions and the first original paragraph modified with the one or more new tokens;
generating, by the large language model executing the new lexical complexity control prompt, the new respective lexical complexity-controlled structured data fragment for the first original paragraph;
while generating the new respective lexical complexity-controlled structured data fragment, displaying, in the second cell of the second row, an animated visual indicator indicating that the large language model is currently generating the new respective lexical complexity-controlled structured data fragment for the first original paragraph; and
after the large language model generates the new respective lexical complexity-controlled structured data fragment:
ceasing displaying the animated visual indicator in the second cell of the second row, and
replacing, at the second cell of the second row, the respective lexical complexity-controlled structured data fragment previously generated for the first original paragraph with the new respective lexical complexity-controlled structured data fragment derived for the first original paragraph.

10. The computer-implemented method according to claim 1, wherein:
the respective lexical complexity-controlled structured data fragment generated for a first unstructured data fragment in the corpus of unstructured data fragments includes a plurality of attribute fields comprising:
a first attribute field comprising tokens underlying the respective lexical complexity-controlled structured data fragment generated for the first unstructured data fragment,
a first nested attribute field nested under the first attribute field indicating that a subset of the tokens corresponds to a first plurality of original tokens in the unstructured digital artifact, and
a second nested attribute field nested under the first nested attribute field indicating that the first plurality of original tokens have a first type of textual formatting in the unstructured digital artifact,
the interactive explainability artifact includes a selectable button that, when selected by the user input, generates a digital file comprising the respective lexical complexity-controlled structured data fragment generated for each distinct unstructured data fragment in the corpus of unstructured data fragments, and
exporting the digital file includes:
initializing the digital file in accordance with a target file format,
detecting that a next lexical complexity-controlled structured data fragment to insert into the digital file corresponds to the respective lexical complexity-controlled structured data fragment generated for the first unstructured data fragment, and
in response to detecting that the next lexical complexity-controlled structured data fragment to insert into the digital file corresponds to the respective lexical complexity-controlled structured data fragment generated for the first unstructured data fragment:
adding the tokens underlying the respective lexical complexity-controlled structured data fragment to the digital file in accordance with a position of the respective lexical complexity-controlled structured data fragment in the graphical user interface, and
applying the first type of textual formatting to the subset of tokens in the respective lexical complexity-controlled structured data fragment in response to (A) the first nested attribute field indicating that the subset of the tokens correspond to the first plurality of original tokens in the unstructured digital artifact and (B) the second nested attribute field indicating that the first plurality of original tokens have the first type of textual formatting in the unstructured digital artifact,
applying a default textual formatting to a remainder of the tokens underlying the respective lexical complexity-controlled structured data fragment generated for the first unstructured data fragment based on detecting an absence of additional nested attributed fields indicating a textual formatting type for the remainder of the tokens, and
after adding the tokens underlying the respective lexical complexity-controlled structured data fragment generated for the first unstructured data fragment, adding a plurality additional lexical complexity-controlled structured data fragments to the target digital file in accordance with respective positions of the plurality additional lexical complexity-controlled structured data fragments in the graphical user interface.

11. The computer-implemented method according to claim 1, wherein generating the respective structured interrogative finding for a first distinct interrogative included in a first respective interrogative prompt of the plurality of interrogative prompts includes:
generating, by the large language model, a first respective structured interrogative finding for the first distinct interrogative using the distinct subset of unstructured data fragments included in the first respective interrogative prompt,
detecting a total number of words, a total number of sentences, and a total number of syllables included in the first respective structured interrogative finding generated for the first distinct interrogative,
computing a text readability score of the first respective structured interrogative finding based on the total number of words, the total number of sentences, and the total number of syllables included in the first respective structured interrogative finding,
detecting that the text readability score of the first respective structured interrogative finding does not satisfy a target readability threshold, and
in response to detecting that the text readability score for the first respective structured interrogative finding does not satisfy the target readability threshold, iteratively generating, by the large language model:
a plurality of first additional structured interrogative findings that have text readability scores that do not satisfy the target readability threshold, and
a second additional structured interrogative finding that has a text readability score that satisfies the target readability threshold.

12. The computer-implemented method according to claim 11, wherein:
the plurality of first additional structured interrogative findings and the second additional structured interrogative finding are generated using a plurality of distinct candidate interrogative prompts,
each respective distinct candidate interrogative prompt of the plurality of distinct candidate interrogative prompts:
is a copy of the first respective interrogative prompt, and
is generated based on a total number of words, a total number of sentences, a total number of syllables included in a previous structured interrogative finding generated for the first distinct interrogative, and
requests that the large language model generate a subsequent structured interrogative finding using fewer words, sentences, and syllables than the total number of words, sentences, and syllables included in the previous structured interrogative finding.

13. The computer-implemented method according to claim 12, wherein requesting that the large language generate the subsequent structured interrogative finding using the fewer words, sentences, and the syllables than the total number of words, sentences, and syllables in the previous structured interrogative finding includes:
detecting a current number of additional structured interrogative findings that have been generated by the large language model,
responsive to detecting that the current number of additional structured interrogative findings previously generated by the large language model exceeds a first number, requesting that that the large language model generate the subsequent structured interrogative finding using a first amount of fewer words, sentences, and syllables than the total number of words, sentences, and syllables included in the previous structured interrogative finding, and
responsive to detecting that the current number of additional structured interrogative findings previously generated by the large language model exceeds a second number, greater than the first number, requesting that that the large language model generate the subsequent structured interrogative finding using a second amount, lower than the first amount, of fewer words, sentences, and syllables than the total number of words, sentences, and syllables included in the previous structured interrogative finding.

14. The computer-implemented method according to claim 11, wherein after detecting that the text readability score of the second additional structured interrogative finding satisfies the target readability threshold:
constructing a plurality of content hallucination mitigation prompts that assess
the second additional structured interrogative finding against the unstructured digital artifact,
executing the plurality of content hallucination mitigation prompts by a second large language model,
in response to executing the plurality of content hallucination mitigation prompts, detecting, by the plurality of content hallucination mitigation prompts, a plurality of tokens in the second additional structured interrogative finding that are not supported by the unstructured digital artifact,
removing the plurality of tokens from the second additional structured interrogative finding that are not supported by the unstructured digital artifact,
generating, by the second language model, a third additional structured interrogative finding that restores grammatical correctness after removing the plurality of tokens that are not supported by the unstructured digital artifact, and
setting the third additional structured interrogative finding as the respective structured interrogative finding for the first distinct interrogative included in the first respective interrogative prompt.

15. The computer-implemented method according to claim 1, wherein generating the respective lexical complexity-controlled structured data fragment for a first unstructured data fragment included in a first lexical complexity control prompt of the plurality of lexical complexity control prompts includes:
generating, by the large language model, the respective lexical complexity-controlled structured data fragment for the first unstructured data fragment in accordance with the plurality of lexical transformation control instructions included in the first lexical complexity control prompt,
computing one or more token overlap metrics between the first unstructured data fragment and the respective lexical complexity-controlled structured data fragment generated for the first unstructured data fragment,
detecting, based on the one or more token overlap metrics, that tokens underlying the respective lexical complexity-controlled structured data fragment generated for the first unstructured data fragment and tokens underlying the first unstructured data fragment do not overlap by a threshold amount, and
in response to detecting that the tokens of the respective lexical complexity-controlled structured data fragment and the tokens of the first unstructured data fragment do not overlap by the threshold amount, iteratively regenerating, by the large language model, the respective lexical complexity-controlled structured data fragment using adjusted lexical transformation control instructions that iteratively increase token overlap until the tokens of the respective lexical complexity-controlled structured data fragment and the tokens of the first unstructured data fragment overlap by the threshold amount.

16. The computer-implemented method according to claim 1, wherein:
the respective lexical complexity-controlled structured data fragment generated for a first distinct unstructured data fragment fails to satisfy pre-defined hallucination criteria and pre-defined readability criteria,
the computer-implemented method further comprising:
based on the large language model generating the respective lexical complexity-controlled structured data fragment that does not satisfy the pre-defined hallucination criteria and the pre-defined readability criteria, routing the respective lexical complexity-controlled structured data fragment generated for the first distinct unstructured data fragment to a review queue, and
displaying the corpus of unstructured data fragments in the interactive explainability artifact includes:
displaying the first distinct unstructured data fragment in a first cell of a respective row and the respective lexical complexity-controlled structured data fragment generated for the first distinct unstructured data fragment in a second cell of the respective row,
while the review queue includes the respective lexical complexity-controlled structured data fragment generated for the first distinct unstructured data fragment, displaying an hallucination and readability alert badge in the second cell of the respective row to indicate that the respective lexical complexity-controlled structured data fragment generated for the first distinct unstructured data fragment does not satisfy the pre-defined hallucination criteria and the pre-defined readability criteria,
while displaying the hallucination and readability alert badge, receiving, at the review queue, a second user input accepting the respective lexical complexity-controlled structured data fragment generated for the first distinct unstructured data fragment, and
in response to receiving the second user input, removing the hallucination and readability alert badge from the second cell of the respective row.

17. The computer-implemented method according to claim 16, wherein:
the interactive explainability artifact includes a selectable button that, when selected by the user input, generates a digital file comprising at least the respective lexical complexity-controlled structured data fragment generated for each distinct unstructured data fragment in the corpus of unstructured data fragments,
while the hallucination and readability alert badge is displayed in the second cell of the respective row, the selectable button is in a deactivated state to prevent the digital file from being generated, and
after removing the hallucination and readability alert badge from the second cell of the respective row, the selectable button transitions from the deactivated state to an activated state that allows the user input to generate the digital file.

18. The computer-implemented method according to claim 1, wherein:
displaying the respective structured interrogative finding generated for each distinct interrogative included in the plurality of interrogative prompts includes:
displaying a first editable text container comprising:
a header area that displays a first distinct interrogative with a first amount of visual prominence, and
a content area that displays a first respective structured interrogative finding generated for the first distinct interrogative with a second amount of visual prominence, less than the first amount of visual prominence,
displaying one or more additional editable text containers comprising one or more additional respective structured interrogative findings for one or more additional distinct interrogatives,
the first editable text container and the one or more additional editable text containers are positioned above the corpus of unstructured data fragments displayed in association with the respective lexical complexity-controlled structured data fragment generated for each distinct unstructured data fragment of the corpus of unstructured data fragments, and
the interactive explainability artifact further includes a selectable button that, when selected by the user input, exports a digital file comprising textual representations of the first editable text container and the one or more additional editable text containers, wherein the textual representations of the first editable text container and the one or more additional editable text containers are ordered according to a presentation order of the first editable text container and the one or more additional editable text containers in the graphical user interface.

19. The computer-implemented method according to claim 18, wherein after exporting the digital file:
receiving, via the graphical user interface, a second user input adding one or more new tokens to the first respective structured interrogative finding displayed in the content area of the first editable text container,
after receiving the second user input, receiving, via the graphical user interface, a third user input selecting the selectable button displayed in association with the first editable text container and the one or more additional editable text containers, and
in response to receiving the third user input selecting the selectable button, updating the digital file to include a new textual representation of the first editable text container in place of a prior textual representation of the first editable text container,
wherein the new textual representation of the first editable text container includes the one or more new tokens added to the first respective structured interrogative finding.

20. The computer-implemented method according to claim 1, wherein generating the plurality of interrogative prompts includes:
selecting a first distinct interrogative from a corpus of distinct interrogatives;
computing, by an embedding model, an embedding vector corresponding to the first distinct interrogative;
computing, by the embedding model, a corpus of vector embeddings corresponding to the corpus of unstructured data fragments;
executing a first vector similarity search based on the embedding vector corresponding to the first distinct interrogative and the corpus of vector embeddings corresponding to the corpus of unstructured data fragments, wherein the first vector similarity search:
detects that a first subset of vector embeddings included in the corpus of vector embeddings are within a threshold vector distance of the embedding vector corresponding to the first distinct interrogative, and
returns a first subset of unstructured data fragments associated with the first subset of vector embeddings;
generating a first interrogative prompt of the plurality of interrogative prompts, wherein the distinct interrogative of the first interrogative prompt corresponds to the first distinct interrogative and the distinct subset of unstructured data fragments included in the first interrogative prompt corresponds to the first subset of vector embeddings detected with the threshold vector distance of the embedding vector associated with the first distinct interrogative;
selecting a second distinct interrogative from the corpus of distinct interrogatives;
computing, by the embedding model, an embedding vector corresponding to the second distinct interrogative;
computing, by the embedding model, the corpus of vector embeddings corresponding to the corpus of unstructured data fragments;
executing a second vector similarity search based on the embedding vector corresponding to the second distinct interrogative and the corpus of vector embeddings corresponding to the corpus of unstructured data fragments, wherein the second vector similarity search:
detects that a second subset of vector embeddings included in the corpus of vector embeddings are within the threshold vector distance of the embedding vector corresponding to the second distinct interrogative, and
returns a second subset of unstructured data fragments associated with the second subset of vector embeddings; and
generating a second interrogative prompt of the plurality of interrogative prompts, wherein the distinct interrogative of the second interrogative prompt corresponds to the second distinct interrogative and the distinct subset of unstructured data fragments included in the second interrogative prompt corresponds to the second subset of vector embeddings detected with the threshold vector distance of the embedding vector associated with the second distinct interrogative.
